(19) United States
(12) Patent Application Publication
(10) Pub. No.: US 2006/0214556 A1
(43) Pub. Date: Sep. 28, 2006

(54) Light source

(75) Inventors: Iwao Ohwada, Nagoya-City (JP); Natsumi Shimogawa, Nagoya-City (JP); Tetsuyuki Kameji, Ama-Gan (JP); Naoki Goto, Ogaki-City (JP); Isao Shikata, Kasugai-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/384,992

(22) Filed: Mar. 20, 2006

Related U.S. Application Data
(60) Provisional application No. 60/665,166, filed on Mar. 25, 2005.
(60) Provisional application No. 60/693,193, filed on Jun. 23, 2005.
(60) Provisional application No. 60/702,759, filed on Jul. 27, 2005.
(60) Provisional application No. 60/719,331, filed on Sep. 21, 2005.

(30) Foreign Application Priority Data
Feb. 15, 2006 (JP) 2006-037567

(51) Int. Cl. H01J 63/04

(52) U.S. Cl. 313/491; 313/311

(57) ABSTRACT

A light source has a transparent substrate, a fixed substrate disposed in facing relation to the transparent substrate, at least one electron emitter disposed on the fixed substrate, a phosphor layer disposed on a surface of the transparent substrate which confronts the fixed substrate, and a trajectory deflector for deflecting the trajectory of a pulsed electron flow intermittently emitted from the electron emitter. The pulsed electron flow is deflected by the trajectory deflector to two-dimensionally scan a position of the phosphor layer which is irradiated with the pulsed electron flow for thereby spreading the pulsed electron flow.

### BACKGROUND OF THE INVENTION

1. Field of the Invention

The present invention relates to a light source (including a planar light source) comprising electron emitters each for emitting electrons from an emitter by applying a drive voltage to electrodes on the emitter.

2. Description of the Related Art

Recently, electron emitters having a drive electrode and a common electrode have been finding use in various applications such as field emission displays (FEDs) and backlight units. In an FED, a plurality of electron emitters are arranged in a two-dimensional array, and a plurality of phosphors are positioned in association with the respective electron emitters with a predetermined gap left therebetween.

Conventional electron emitters are disclosed in Japanese Laid-Open Patent Publication No. 1-311533, Japanese Laid-Open Patent Publication No. 7-147131, Japanese Laid-Open Patent Publication No. 2000-285801, Japanese Patent Publication No. 46-20944, and Japanese Patent Publication No. 44-26125, for example. All of these disclosed electron emitters are disadvantageous in that since no dielectric body is employed in the emitter, a forming process or a micromachining process is required between facing electrodes, a high voltage needs to be applied to emit electrons, and a panel fabrication process is complex and entails a high panel fabrication cost.

It has been considered to make an emitter of a dielectric material. Various theories about the emission of electrons from a dielectric material have been presented in the documents: Yasuoka and Ishii, “Pulsed Electron Source Using a Ferroelectric Cathode”, OYO BUTURI (A monthly publication of The Japan Society of Applied Physics), Vol. 68, No. 5, p. 546-550 (1999), and Puchkarev, Victor F. and Mesyats, Gannady A., “On the Mechanism of Emission from the Ferroelectric Ceramic Cathode, Journal of Applied Physics, Vol. 78, No. 9, 1 Nov., 1995, p. 5633-5637.

The development of light sources employing carbon nanowalls has also been promoted lately (see, for example, Japanese Laid-Open Patent Publication No. 2004-362960 and Japanese Laid-Open Patent Publication No. 2004-362959).

### SUMMARY OF THE INVENTION

It is an object of the present invention to provide a light source comprising electron emitters for increasing the rate of utilization of phosphorescent light emission based on electrons emitted from the electron emitters to achieve high-luminance light emission.

A light source according to the present invention has a transparent substrate, a fixed substrate disposed in facing relation to the transparent substrate, at least one electron emitter disposed on the fixed substrate, a phosphor layer disposed on a surface of the transparent substrate which confronts the fixed substrate, a metal back layer disposed on a surface of the phosphor layer which confronts the fixed substrate, and a spreading electrode disposed on a portion of the fixed electrode which is free of the electron emitter. An electron flow emitted from the electron emitter is spread by an electric field generated by a voltage signal which is applied to the spreading electrode to reduce a surface density of the electron flow applied to the metal back layer to a peak value of at most 50 μA/cm².

With the above arrangement, the phosphor layer is prevented from being saturated by an excessive amount of electrons impinging locally thereupon. The phosphor layer is capable of emitting phosphorescent light through an increased area for a spread uniform surface emission.

Another light source according to the present invention has a transparent substrate, a fixed substrate disposed in facing relation to the transparent substrate, at least one electron emitter disposed on the transparent substrate, a light reflecting film disposed on a surface of the fixed substrate which confronts the transparent substrate, a phosphor layer disposed on a surface of the light reflecting film which confronts the transparent substrate, and a spreading electrode disposed on a portion of the transparent electrode which is free of the electron emitter. An electron flow emitted from the electron emitter is spread by an electric field generated by a voltage signal which is applied to the spreading electrode to reduce a surface density of the electron flow applied to the phosphor layer to a peak value of at most 50 μA/cm².

With the above arrangement, the phosphor layer is prevented from being saturated by an excessive amount of electrons impinging locally thereupon. The phosphor layer is capable of emitting phosphorescent light from its irradiated surface highly efficiently through an increased area for a spread uniform surface emission.

Still another light source according to the present invention has a transparent substrate, a fixed substrate disposed in facing relation to the transparent substrate, at least one electron emitter disposed on the fixed substrate, a phosphor layer disposed on a surface of the transparent substrate which confronts the fixed substrate, a metal back layer disposed on a surface of the phosphor layer which confronts the fixed substrate, and a spreading electrode disposed on a portion of the fixed electrode which is free of the electron emitter. The electron emitter emits an electron flow intermittently, and a pulsed electron flow (an electron flow pulse) emitted from the electron emitter is spread by an electric field generated by a voltage signal which is applied to the spreading electrode to reduce a surface density of the pulsed electron flow applied to the metal back layer to a peak value of at most 50 μA/cm².

Yet another light source according to the present invention has a transparent substrate, a fixed substrate disposed in facing relation to the transparent substrate, at least one electron emitter disposed on the fixed substrate, a phosphor layer disposed on a surface of the transparent substrate which confronts the fixed substrate, a metal back layer disposed on a surface of the phosphor layer which confronts the fixed substrate, and a spreading electrode disposed on a portion of the fixed electrode which is free of the electron emitter. The electron emitter emits an electron flow intermittently, electron flow pulses emitted from the electron emitter are spread by an electric field generated by a voltage signal which is applied to the spreading electrode, and each of the electron flow pulses which are applied to the metal back layer has an amount of electrons of at most 1 nC/cm².

With the above arrangement, the phosphor layer is prevented from being saturated by an excessive amount of electrons impinging locally thereupon. The phosphor layer is capable of emitting phosphorescent light through an increased area for a spread uniform surface emission. Because the pulsed electron flow is intermittently emitted at certain time intervals, the phosphor layer keeps its persistent phosphor emission even during periods in which the pulsed electron flow is not emitted, and the light source can emit light highly efficiently.

Yet still another light source according to the present invention has a transparent substrate, a fixed substrate disposed in facing relation to the transparent substrate, at least one electron emitter disposed on the transparent substrate, a light reflecting film disposed on a surface of the fixed substrate which confronts the transparent substrate, a phosphor layer disposed on a surface of the light reflecting film which confronts the transparent substrate, and a spreading electrode disposed on a portion of the transparent electrode which is free of the electron emitter. The electron emitter emits an electron flow intermittently, and a pulsed electron flow emitted from the electron emitter is spread by an electric field generated by a voltage signal which is applied to the spreading electrode to reduce a surface density of the pulsed electron flow applied to the phosphor layer to a peak value of at most 50 μA/cm².

A further light source according to the present invention has a transparent substrate, a fixed substrate disposed in facing relation to the transparent substrate, at least one electron emitter disposed on the transparent substrate, a light reflecting film disposed on a surface of the fixed substrate which confronts the transparent substrate, a phosphor layer disposed on a surface of the light reflecting film which confronts the transparent substrate, and a spreading electrode disposed on a portion of the transparent electrode which is free of the electron emitter. The electron emitter emits an electron flow intermittently, electron flow pulses emitted from the electron emitter are spread by an electric field generated by a voltage signal which is applied to the spreading electrode, and each of the electron flow pulses which are applied to the phosphor layer has an amount of electrons of at most 1 nC/cm².

With the above arrangement, the phosphor layer is prevented from being saturated by an excessive amount of electrons impinging locally thereupon. The phosphor layer is capable of emitting phosphorescent light through an increased area for a spread uniform surface emission. Because the pulsed electron flow is intermittently emitted at certain time intervals, the phosphor layer keeps its persistent phosphor emission even during periods in which the pulsed electron flow is not emitted, the light source can emit light highly efficiently.

A still further light source according to the present invention has a transparent substrate, a fixed substrate disposed in facing relation to the transparent substrate, at least two electron emitters disposed on the fixed substrate, a phosphor layer disposed on a surface of the transparent substrate which confronts the fixed substrate, a metal back layer disposed on a surface of the phosphor layer which confronts the fixed substrate, and a spreading electrode disposed on a portion of the fixed electrode which is free of the electron emitters. The electron emitters emit electron flows intermittently, pulsed electron flows emitted from the electron emitters are spread by an electric field generated by a voltage signal which is applied to the spreading electrode to reduce a surface density of the pulsed electron flow applied to the metal back layer to a peak value of at most 50 μA/cm², and the pulsed electron flows emitted from the electron emitters irradiate the same area of the metal back layer and are emitted at different times from the electron emitters.

A yet further light source according to the present invention has a transparent substrate, a fixed substrate disposed in facing relation to the transparent substrate, at least two electron emitters disposed on the fixed substrate, a phosphor layer disposed on a surface of the transparent substrate which confronts the fixed substrate, a metal back layer disposed on a surface of the phosphor layer which confronts the fixed substrate, and a spreading electrode disposed on a portion of the fixed electrode which is free of the electron emitters. The electron emitter emits an electron flow intermittently, electron flow pulses emitted from the electron emitter are spread by an electric field generated by a voltage signal which is applied to the spreading electrode, each of the electron flow pulses which are applied to the metal back layer has an amount of electrons of at most 1 nC/cm², and the electron flow pulses emitted from the electron emitters irradiate the same area of the metal back layer and are emitted at different times from the electron emitters.

With the above arrangement, the phosphor layer is prevented from being saturated by an excessive amount of electrons impinging locally thereupon. The phosphor layer is capable of emitting phosphorescent light through an increased area for a spread uniform surface emission. Since electron flow pulses having small peak values are emitted at different times from the electron emitters, the phosphor layer is prevented from being saturated and an electron flow required for phosphor emission is maintained for higher emission efficiency and higher luminance.

Still another light source according to the present invention has a transparent substrate, a fixed substrate disposed in facing relation to the transparent substrate, at least two electron emitters disposed on the transparent substrate, a light reflecting film disposed on a surface of the fixed substrate which confronts the transparent substrate, a phosphor layer disposed on a surface of the light reflecting film which confronts the transparent substrate, and a spreading electrode disposed on a portion of the transparent electrode which is free of the electron emitters. The electron emitters emit electron flows intermittently, pulsed electron flows emitted from the electron emitters are spread by an electric field generated by a voltage signal which is applied to the spreading electrode to reduce a surface density of the pulsed electron flow applied to the phosphor layer to a peak value of at most 50 μA/cm², and the pulsed electron flows emitted from the electron emitters irradiate the same area of the phosphor layer and are emitted at different times from the electron emitters.

Yet another light source according to the present invention has a transparent substrate, a fixed substrate disposed in facing relation to the transparent substrate, at least two electron emitters disposed on the transparent substrate, a light reflecting film disposed on a surface of the fixed substrate which confronts the transparent substrate, a phosphor layer disposed on a surface of the light reflecting film which confronts the transparent substrate, and a spreading electrode disposed on a portion of the transparent electrode which is free of the electron emitters. The electron emitter emits an electron flow intermittently, electron flow pulses emitted from the electron emitter are spread by an electric field generated by a voltage signal which is applied to the spreading electrode, each of the electron flow pulses which are applied to the phosphor layer has an amount of electrons of at most 1 nC/cm², and the electron flow pulses emitted from the electron emitters irradiate the same area of the phosphor layer and are emitted at different times from the electron emitters.

With the above arrangement, the phosphor layer is prevented from being saturated by an excessive amount of electrons impinging locally thereupon. The phosphor layer is capable of emitting phosphorescent light through an increased area for a spread uniform surface emission. Since electron flow pulses having small peak values are emitted at different times from the electron emitters, the phosphor layer is prevented from being saturated and an electron flow required for phosphor emission is maintained for higher emission efficiency and higher luminance.

Yet still another light source according to the present invention has a transparent substrate, a fixed substrate disposed in facing relation to the transparent substrate, at least one electron emitter disposed on the fixed substrate, a phosphor layer disposed on a surface of the transparent substrate which confronts the fixed substrate, and a trajectory deflector for deflecting the trajectory of a pulsed electron flow intermittently emitted from the electron emitter. The trajectory of the pulsed electron flow is deflected by the trajectory deflector to two-dimensionally scan a position of the phosphor layer which is irradiated with the pulsed electron flow for thereby spreading the pulsed electron flow. The light source is capable of emitting light highly efficiently based on the persistent light emission of the phosphor layer.

The trajectory deflector may comprise a plurality of spreading electrodes disposed around the electron emitter and the trajectory of the pulsed electron flow emitted from the electron emitter may be deflected with an electric field generated by voltage signals which are applied respectively to the spreading electrodes. The electron flow which tends to travel straight can be spread more than if the electron flow is spread under an electrostatic field, allowing the light source to emit light highly efficiently based on the persistent light emission of the phosphor layer.

The trajectory deflector may comprise a magnetic field generator and the trajectory of the pulsed electron flow emitted from the electron emitter may be deflected with a magnetic field generated by the magnetic field generator.

With the above arrangement, since the light source does not require a high voltage for deflecting the electron flow, the light source may have a less costly control circuit. Furthermore, the light source is capable of emitting light highly efficiently based on the persistent light emission of the phosphor layer.

The trajectory deflector may comprise a plurality of spreading electrodes disposed around the electron emitter and the magnetic field generator, and the trajectory of the pulsed electron flow emitted from the electron emitter may be deflected with an electric field generated by voltage signals which are applied respectively to the spreading electrodes and a magnetic field generated by the magnetic field generator.

With the above arrangement, since the light source does not require a high voltage for deflecting the electron flow, the light source may have a less costly control circuit. Furthermore, the light source is capable of emitting light highly efficiently based on the persistent light emission of the phosphor layer. It is also possible to increase the ratio at which the electron flow is spread, more than if the electron flow is deflected under an electric field or a magnetic field only.

If the pulsed electron flow emitted from the electron emitter has a level which changes with time in a single electron emission period, then the trajectory deflector may control a deflecting speed of the pulsed electron flow depending on the level of the pulsed electron flow to make constant an amount of electrons applied to the phosphor layer by the deflected pulsed electron flow when the trajectory deflector deflects the pulsed electron flow emitted from the electron emitter in a single electron emission period.

Consequently, it is possible to produce uniform phosphorescent light emission in a wide area. When an electron flow having a higher level is deflected, the same area of the phosphor layer is irradiated with the electron flow in a shorter period of time. When an electron flow having a lower level is deflected, the same area of the phosphor layer is irradiated with the electron flow in a longer period of time. In this manner, the amount of electrons applied to the same area of the phosphor layer is uniformized.

The trajectory deflector may have an electrode film disposed on a substrate on which the electron emitter is mounted, for applying an electric field, and/or a coil pattern disposed on the substrate on which the electron emitter is mounted, for generating a magnetic field. Alternatively, the trajectory deflector may have an electrode film disposed on the fixed substrate for applying an electric field and/or a coil pattern disposed on the fixed substrate for generating a magnetic field. For deflecting the trajectory of the electron flow, the trajectory deflector and the electron emitter need to be positioned highly accurately with respect to each other. If the electrode films and/or the coil pattern is formed on the fixed substrate based on the same reference positions by screen printing, for example, the electrode films and/or the coil pattern can be positioned highly accurately with respect to the electron emitter inexpensively and highly accurately.

The trajectory deflector may have an electrode film disposed on the fixed substrate for applying an electric field and/or a coil pattern disposed on the fixed substrate for generating a magnetic field, and the electron emitter may be mounted on the fixed substrate using the electrode film and/or the coil pattern as an alignment mark. For deflecting the trajectory of the electron flow, the trajectory deflector and the electron emitter need to be positioned highly accurately with respect to each other. If the electron emitter is mounted using the electrode film and/or the coil pattern as a positional reference, then the electrode film and/or the coil pattern can be positioned highly accurately with respect to the electron emitter inexpensively and highly accurately.

A further light source according to the present invention has a transparent substrate, a fixed substrate disposed in facing relation to the transparent substrate, a plurality of electron emitters disposed on the fixed substrate in the longitudinal direction along a plurality of columns, a phosphor layer disposed on a surface of the transparent substrate which confronts the fixed substrate, and a plurality of spreading electrodes disposed above the fixed substrate in the longitudinal direction along columns adjacent to the columns where the electron emitters are disposed on the fixed substrate. Electron flows emitted from the electron emitters are spread in the transverse direction by an electric field generated by a voltage signal which is applied to the spreading electrodes.

With the above arrangement, the phosphor layer is prevented from being saturated by an excessive amount of electrons impinging locally thereupon. The phosphor layer is capable of emitting phosphorescent light through an increased area for a spread uniform surface emission.

In the above arrangement, the voltage signal applied to the spreading electrodes may have a voltage level of 0 V. This is advantageous in lowering the cost and the height of the light source. Incidentally, the voltage signal applied to the spreading electrodes may have a voltage level of 100 V or less.

In the above arrangement, the spreading electrode may comprise a mesh electrode having a large number of openings, and the electron flows emitted from the electron emitters pass through the openings of the mesh electrode and are spread by an electric field generated by a voltage signal which is applied to the mesh electrode.

The mesh electrode may be rectangular in shape and disposed above the electron emitters. Since this requires only mounting the mesh electrode above the electron emitters, not require the highly accurate positioning, it is advantageous in simplifying the mounting work and reducing the cost of manufacturing.

The spreading electrode may comprise the rectangular mesh electrode which is rounded into a half-cylindrical shape, and may be disposed to cover the electron emitters. With this arrangement, the spreading electrode can easily be positioned with respect to the electron emitters, and the electron flows can substantially symmetrically be spread in the transverse direction. This is advantageous for a spread uniform surface emission.

A still further light source according to the present invention has a transparent substrate, a fixed substrate disposed in facing relation to the transparent substrate, at least one electron emitter disposed on the fixed substrate, a phosphor layer, and a spreading electrode, the transparent substrate having the phosphor layer and the spreading electrode. The transparent substrate comprises an upper plate facing the fixed substrate and at least two side plates interposed between the upper plate and the fixed substrate and is fixedly disposed to cover the electron emitter on the fixed substrate. The transparent substrate has a laminated assembly of the phosphor layer and the spreading electrode formed on internal surfaces of the upper plate and at least two of the side plates. An electron flow emitted from the electron emitter is spread by an electrical field generated by a voltage signal applied to the spreading electrode.

A yet further light source according to the present invention has a large fixed substrate, at least one light emitting tube disposed on the large fixed substrate, and a light reflecting film formed on a portion of the large fixed substrate which is free of the light emitting tube. The light emitting tube has a housing having a transparent substrate and a fixed substrate disposed in facing relation to the transparent substrate, at least one electron emitter disposed on the fixed substrate in the housing, a phosphor layer, and a spreading electrode, the transparent substrate having the phosphor layer and the spreading electrode. The transparent substrate comprises an upper plate facing the fixed substrate, and at least two side plates interposed between the upper plate and the fixed substrate. The transparent substrate is fixedly disposed to cover the electron emitter on the fixed substrate. The transparent substrate has a laminated assembly of the phosphor layer and the spreading electrode on internal surfaces of the upper plate and at least the two side plates. An electron flow emitted from the electron emitter is spread by an electric field generated by a voltage signal applied to the spreading electrode. In this arrangement, the light reflecting film may be formed on lower portions of the two side plates of an outer surface of the housing.

With this arrangement, light emits from the upper plate and the two side plates of each light emitting tube ahead of the light source. Light emits from the two side plates toward the large fixed substrate, and the light is reflected by the light reflecting layers to travel ahead of the light source. As a result, a spread uniform surface emission and a high-luminance light emission can be achieved, thereby easily manufacturing a structure for a spread uniform surface emission.

Additionally, since this does not require mounting a large transparent substrate facing the large fixed substrate and spacers (for supporting the large transparent substrate), reduction in weight, thickness and cost of the light source can be achieved.

In the above arrangement, the transparent substrate may have the phosphor layer formed on internal surfaces of the upper plate and at least two of the side plates, and the spreading electrode functioning as a metal back layer may be formed on the phosphor layer. Or the spreading electrode may have a transparent electrode, the transparent substrate may have the spreading electrode formed on internal surfaces of the upper plate and at least two of the side plates, and the phosphor layer may be formed on the spreading electrode.

Since the metal back layer or the transparent electrode also functions as the spreading electrode, simplified interconnects can be achieved.

With the above arrangement, a light spreading plate may be disposed on a surface of the transparent substrate opposite to the fixed substrate. As a result, the number of the disposed electron emitters on the fixed substrate can be significantly reduced, thereby reducing power consumption.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a light source according to an embodiment of the present invention;

FIG. 2 is a schematic view of electron emitters;

FIG. 3 is an enlarged fragmentary cross-sectional view of an electron emitter;

FIG. 4 is a plan view showing an example of the shape of through regions defined in an upper electrode;

FIG. 5A is a cross-sectional view of another example of the upper electrode;

FIG. 5B is an enlarged fragmentary cross-sectional view of the upper electrode;

FIG. 6A is a cross-sectional view of still another example of the upper electrode;

FIG. 6B is an enlarged fragmentary cross-sectional view of the upper electrode;

FIG. 7 is a diagram showing a voltage waveform of a drive voltage in a first electron emission process;

FIG. 8 is a view illustrative of emission of electrons in a second output period of the first electron emission process;

FIG. 9 is a diagram showing a voltage waveform of a drive voltage in a second electron emission process;

FIG. 10 is a view illustrative of emission of electrons in a second output period of the second electron emission process;

FIG. 11 is an equivalent circuit diagram showing a connected state of various capacitors connected between an upper electrode and a lower electrode;

FIG. 12 is a diagram illustrative of calculations of capacitances of the various capacitors connected between the upper electrode and the lower electrode;

FIG. 13 is a fragmentary plan view of an electron emitter according to a first modification;

FIG. 14 is a fragmentary plan view of an electron emitter according to a second modification;

FIG. 15 is a fragmentary cross-sectional view of an electron emitter according to a third modification;

FIG. 16 is a diagram showing the voltage vs. charge quantity characteristics (voltage vs. polarized quantity characteristics) of an electron emitter;

FIG. 17A is a view illustrative of a state at a point p1 shown in FIG. 16;

FIG. 17B is a view illustrative of a state at a point p2 shown in FIG. 16;

FIG. 17C is a view illustrative of a state from the point p2 to a point p3 shown in FIG. 16;

FIG. 18A is a view illustrative of a state from the point p3 to a point p4 shown in FIG. 16;

FIG. 18B is a view illustrative of a state immediately prior to a point p4 shown in FIG. 16;

FIG. 18C is a view illustrative of a state from the point p4 to a point p6 shown in FIG. 16;

FIGS. 19A through 19C are waveform diagrams illustrative of amplitude modulation of pulse signals by an amplitude modulating circuit;

FIG. 20 is a block diagram of a signal supply circuit according to a modification;

FIGS. 21A through 21C are waveform diagrams illustrative of pulse width modulation of pulse signals by a pulse width modulating circuit;

FIG. 22A is a diagram showing a hysteresis curve plotted when a voltage Vsl shown in FIG. 19A or 21A is applied;

FIG. 22B is a diagram showing a hysteresis curve plotted when a voltage Vsm shown in FIG. 19B or 21B is applied;

FIG. 22C is a diagram showing a hysteresis curve plotted when a voltage Vsh shown in FIG. 19C or 21C is applied;

FIG. 23 is a timing chart illustrative of a drive method for the light source;

FIG. 24 is a diagram showing the relationship of applied voltages according to the drive method shown in FIG. 23;

FIG. 25 is a schematic view of a light source according to a first specific example;

FIG. 26 is a perspective view of an array of electron emission units in the light source according to the first specific example;

FIG. 27 is an enlarged fragmentary perspective view of an encircled portion Lc in FIG. 26;

FIG. 28 is an enlarged fragmentary perspective view of a light source according to a second specific example;

FIG. 29 is a schematic view of a light source according to a third specific example;

FIG. 30 is a schematic view of a light source according to a fourth specific example;

FIG. 31 is a schematic view of a light source according to a fifth specific example;

FIG. 32 is a schematic view of a light source according to a sixth specific example;

FIG. 33 is a schematic view of a light source according to a first embodiment of the present invention;

FIG. 34 is a plan view of an array pattern of electron emitters and phosphors;

FIG. 35 is a plan view of another array pattern of electron emitters and phosphors;

FIG. 36 is a schematic view of a light source according to a second embodiment of the present invention;

FIG. 37 is a schematic view of a light source according to a third embodiment of the present invention;

FIG. 38 is a schematic view of a light source according to a fourth embodiment of the present invention;

FIG. 39 is a schematic view of a light source according to a fifth embodiment of the present invention;

FIG. 40 is a fragmentary plan view showing the manner in which an area of a metal back layer that is irradiated with an electron flow is enlarged in the light source according to the fifth embodiment;

FIG. 41 is a fragmentary plan view of a portion of a light source according to a sixth embodiment of the present invention;

FIG. 42 is a fragmentary plan view showing the manner in which an area of a metal back layer that is irradiated with an electron flow is enlarged in the light source according to the sixth embodiment;

FIG. 43 is a schematic view of a light source according to a seventh embodiment of the present invention;

FIG. 44 is a diagram showing a voltage waveform of a sine wave applied to a second spreading electrode of the light source according to the seventh embodiment;

FIGS. 45A through 45C are fragmentary plan views showing the manner in which an area of a metal back layer that is irradiated with an electron flow is deflected in the light source according to the seventh embodiment;

FIG. 46 is a fragmentary plan view of a portion of a light source according to an eighth embodiment of the present invention;

FIG. 47 is a fragmentary plan view showing the manner in which an area of a metal back layer that is irradiated with an electron flow is deflected in the light source according to the eighth embodiment;

FIG. 48 is a diagram showing voltage waveforms of positive high-frequency signal waves (convex signal waves) that are applied to first through fourth terminals in one cycle in the light source according to the eighth embodiment;

FIG. 49A is a diagram showing a waveform of a voltage applied between the upper electrode and the lower electrode of an electron emitter in an electron emission period;

FIG. 49B is a diagram showing a waveform of an electron flow level as it changes in the electron emission period;

FIG. 49C is a diagram showing voltage waveforms of positive high-frequency signal waves (convex signal waves) that are applied to the first through fourth terminals in the electron emission period;

FIG. 50 is a schematic view of a light source according to a ninth embodiment of the present invention;

FIG. 51 is a timing chart showing a combination of the polarities of a first core and a second core of a magnetic field generator;

FIG. 52 is a fragmentary plan view showing the manner in which an area of a metal back layer that is irradiated with an electron flow is deflected in the light source according to the ninth embodiment;

FIG. 53 is a schematic view of a light source according to a tenth embodiment of the present invention;

FIG. 54 is a fragmentary plan view of a portion of a light source according to an eleventh embodiment of the present invention;

FIG. 55 is a fragmentary plan view showing the manner in which an area of a metal back layer that is irradiated with an electron flow is deflected in the light source according to the eleventh embodiment;

FIG. 56 is a timing chart showing a combination of the polarities of a first core and a second core of a first magnetic field generator and the polarities of a first core and a second core of a second magnetic field generator;

FIG. 57 is a schematic view of a light source according to a twelfth embodiment of the present invention;

FIG. 58 is a perspective view of an electron emitter mounted on a fixed substrate with electrode films and a coil pattern disposed thereon;

FIG. 59 is a perspective view of an array of units each comprising an electron emitter, electrode films, and a coil pattern;

FIG. 60 is a perspective view showing the manner in which electron emitters are mounted using, as an alignment mark, electrode films and coil patterns disposed in advance on a fixed substrate;

FIG. 61 is a schematic view of a light source according to a thirteenth embodiment of the present invention;

FIG. 62 is a perspective view of an electron emitter mounted on a fixed substrate with electrode films and a coil pattern disposed thereon;

FIG. 63 is a perspective view of an array of units each comprising an electron emitter, electrode films, and a coil pattern;

FIG. 64 is a perspective view showing the manner in which electron emitters are mounted using, as an alignment mark, electrode films and coil patterns disposed in advance on a fixed substrate;

FIG. 65 is a schematic view of a light source according to a fourteenth embodiment of the present invention;

FIG. 66 is a diagram showing how the light emission efficiency of a phosphor changes dependent on a peak current density;

FIG. 67 is a diagram showing a time-division drive process for energizing the light source according to the fourteenth embodiment of the present invention;

FIG. 68 is a diagram showing a time-division drive process for energizing the light source according to the fourteenth embodiment of the present invention;

FIG. 69 is a diagram showing how the light emission efficiency of a phosphor changes dependent on the quantity of electrons per electron flow pulse;

FIG. 70 is a fragmentary perspective view of a light source according to a fifteenth embodiment of the present invention;

FIG. 71 is a diagram showing energization of the light source according to the fifteenth embodiment, particularly frequency control of electron flow pulses;

FIG. 72 is a schematic view of a light source according to a sixteenth embodiment of the present invention;

FIG. 73 is a fragmentary plan view of the light source according to the sixteenth embodiment;

FIG. 74 is a fragmentary plan view showing the manner in which an area of a metal back layer that is irradiated with an electron flow is enlarged in the light source according to the sixteenth embodiment;

FIG. 75 is an exploded perspective view showing a light source according to a seventeenth embodiment of the present invention;

FIG. 76 is a schematic view of the light source according to the seventeenth embodiment;

FIG. 77 is a plan view of a light emitting area of an electron emitter and a light emitting region of the light source;

FIG. 78A is a view showing a process to form an interconnect pattern on a fixed substrate;

FIG. 78B is a view showing a process to apply bonding paste to the interconnect pattern;

FIG. 78C is a view showing a process to mount electron emitters to the fixed substrate;

FIG. 79A is a view showing a process to establish electrical connections between the interconnect pattern and the electron emitters;

FIG. 79B is a view showing a process to assemble a spreading electrode;

FIG. 80A is a view showing a process to assemble a first internal spacer;

FIG. 80B is a view showing a process to assemble a circumferential spacer;

FIG. 81A is a view showing a process to form an anode electrode on a transparent substrate;

FIG. 81B is a view showing a process to form a phosphor layer and a metal back layer on the transparent substrate;

FIG. 81C is a view showing a process to assemble a second internal spacer;

FIG. 82 is a fragmentary cross-sectional view of the transparent substrate on which the anode electrode, the phosphor layer and the metal back layer are formed;

FIG. 83A is a view showing a process to thermally bond the transparent substrate to the fixed substrate;

FIG. 83B is a view showing a vacuum sealing process;

FIG. 84 is a fragmentary plan view of an arrangement of electron emitters on the fixed substrate and spreading electrodes in a light source according to an eighteenth embodiment of the present invention;

FIG. 85 is a fragmentary block diagram of the light source according to the eighteenth embodiment;

FIG. 86 is a view illustrative of areas of light emitting regions on a surface of the transparent substrate in the light source according to the eighteenth embodiment;

FIG. 87 is a plan view illustrative of an arrangement of the electron emitters on the fixed substrate and the spreading electrodes, areas of light emitting regions on a surface of the transparent substrate, and areas of light emitting regions enlarged by a light spreading plate;

FIG. 88 is a fragmentary block diagram of a light source according to a nineteenth embodiment of the present invention;

FIG. 89 is a fragmentary block diagram of a light source according to a twentieth embodiment of the present invention;

FIG. 90 is a fragmentary block diagram of a light source according to a twenty-first embodiment of the present invention;

FIG. 91 is a fragmentary block diagram of a light source according to a modification of the twenty-first embodiment;

FIG. 92 is a fragmentary block diagram of a light source according to a twenty-second embodiment of the present invention;

FIG. 93 is a view showing a spreading action where electron flows emitted from electron emitters are spread by a mesh electrode;

FIG. 94 is a fragmentary block diagram of a light source according to a first modification of the twenty-second embodiment;

FIG. 95 is a fragmentary block diagram of a light source according to a second modification of the twenty-second embodiment;

FIG. 96 is a fragmentary block diagram of a light source according to a third modification of the twenty-second embodiment;

FIG. 97 is a fragmentary block diagram of another example of a mesh electrode in the light source according to the third modification of the twenty-second embodiment;

FIG. 98 is a fragmentary block diagram of a light source according to a fourth modification of the twenty-second embodiment;

FIG. 99 is a fragmentary block diagram of a light source according to a fifth modification of the twenty-second embodiment;

FIG. 100 is a fragmentary block diagram of a light source according to a twenty-third embodiment of the present invention;

FIG. 101 is a view illustrative of a planar light source having a plurality of the light sources according to the twenty-third embodiment; and

FIG. 102 is a fragmentary block diagram of a light source according to a modification of the twenty-third embodiment.

### DESCRIPTION OF THE PREFERRED EMBODIMENTS

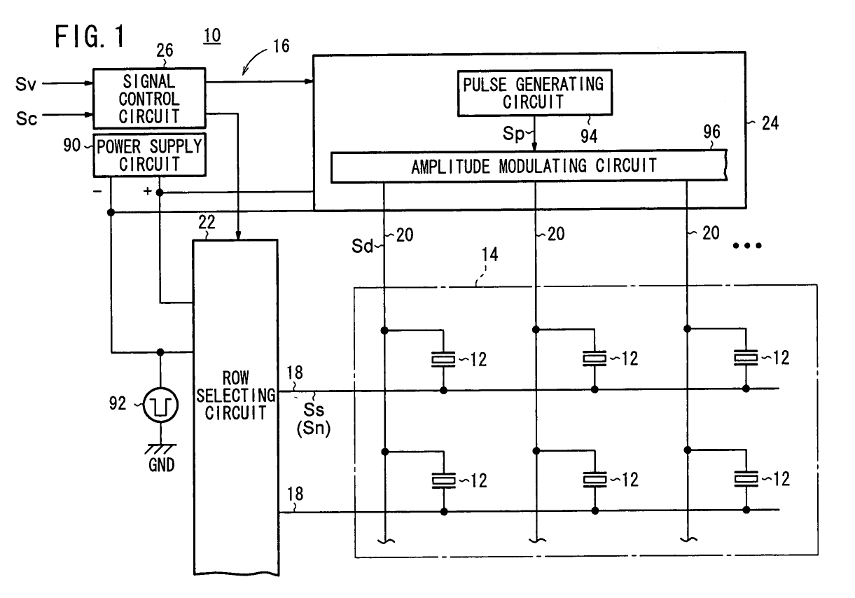

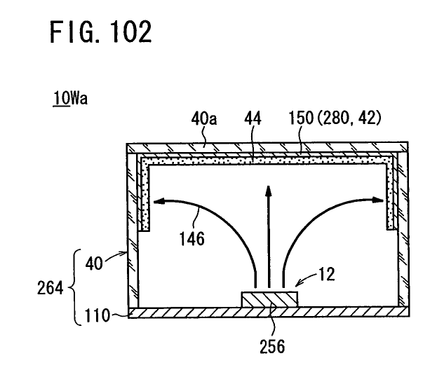

Light sources according to embodiments of the present invention will be described below with reference to FIGS. 1 through 102.

As shown in FIG. 1, a light source 10 according to an embodiment of the present invention is a light source in conformity with a display for displaying an image such as a liquid crystal display backlight or the like. As shown in FIG. 1, the light source 10 has a light emission section 14 comprising a matrix or staggered pattern of electron emitters 12 corresponding to respective light-emitting devices such as pixels, and a drive circuit 16 for driving the light emission section 14.

One electron emitter 12 may be assigned to each pixel, or a plurality of electron emitters 12 may be assigned to each pixel. In the present embodiment, it is assumed for the sake of brevity that one electron emitter 12 is assigned to each pixel.

The drive circuit 16 has a plurality of row selection lines 18 for selecting rows in the light emission section 14 and a plurality of signal lines 20 for supplying data signals Sd to the light emission section 14.

The drive circuit 16 also has a row selecting circuit 22 for supplying a selection signal Ss selectively to the row selection lines 18 to successively select a row of the electron emitters 12, a signal supplying circuit 24 for supplying parallel data signals Sd to the signal lines 20 to supply the data signals Sd to a row (selected row) selected by the row selecting circuit 22, and a signal control circuit 26 for controlling the row selecting circuit 22 and the signal supplying circuit 24 based on a control signal Sv (video signal or the like) and a synchronizing signal Sc that are input to the signal control circuit 26.

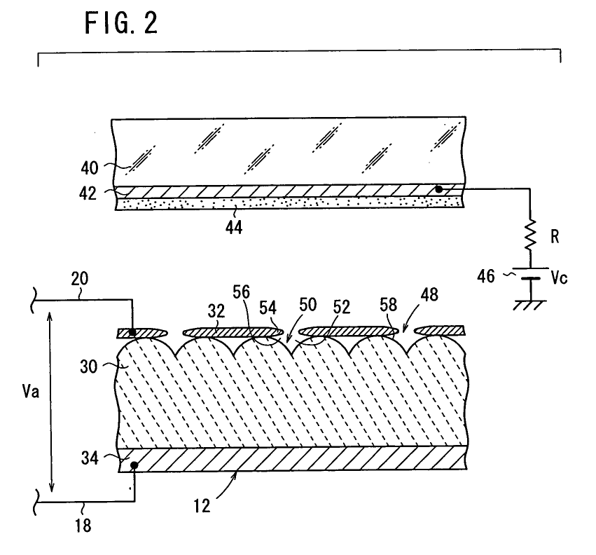

The electron emitters 12 in the light source 10 according to the present embodiment will be described below with reference to FIGS. 2 through 24.

As shown in FIG. 2, each of the electron emitters 12 has an emitter 30, an upper electrode 32 disposed on a face side of the emitter 30, and a lower electrode 34 disposed on a reverse side of the emitter 30. Since the electron emitter 12 is of a structure in which the emitter 30 is sandwiched between the upper electrode 32 and the lower electrode 34, it provides a capacitive load. Therefore, the electron emitter 12 may be regarded as a capacitor.

A drive voltage Va from the drive circuit 16 is applied between the upper electrode 32 and the lower electrode 34.

As shown in FIG. 2, if the electron emitters 12 are used in the light source 10, then a transparent substrate 40 of glass or acrylic resin is placed over the upper electrodes 32, and an anode electrode 42 comprising a transparent electrode, for example, is mounted on the reverse side of the transparent substrate 40, i.e., a surface of the transparent substrate 40 which faces the upper electrodes 32. The anode electrode 42 is coated with a phosphor layer 44. A bias power supply 46 having a bias voltage Vc is connected to the anode electrode 42 through a resistor R.

The electron emitters 12 are placed in a vacuum. The vacuum level in the atmosphere should preferably in the range from 10² to 10⁻⁶ Pa and more preferably in the range from 10⁻³ to 10⁻⁵ Pa.

The reason for the above range is that in a lower vacuum, (1) many gas molecules would be present in the space, and a plasma can easily be generated and, if too intensive plasma were generated, many positive ions thereof would impinge upon the upper electrode 32 and damage the same, and (2) emitted electrons would tend to impinge upon gas molecules prior to arrival at the anode electrode 42, failing to sufficiently excite the phosphor layer 44 with electrons that are sufficiently accelerated under the bias voltage Vc.

In a higher vacuum, structural body supports and vacuum seals would be large in size, posing disadvantages on efforts to make the electron emitter smaller in size.

As shown in FIG. 2, the upper electrode 32 of the electron emitter 12 has a plurality of through regions 48 where the emitter 30 is exposed. The emitter 30 has an uneven pattern 50 of the grain boundary of a dielectric material that the emitter 30 is made of. The through regions 48 of the upper electrode 32 are formed in areas corresponding to concavities 52 of the grain boundary of the dielectric material. In the embodiment shown in FIG. 2, one through region 48 is formed in association with one concavity 52. However, one through region 48 may be formed in association with a plurality of concavities 52. The through regions 48 may be reduced in size by adjusting the material and/or sintering conditions of the upper electrode 32. In this manner, a plurality of through regions 48 may be formed in one concavity 52 or a through region 48 may be formed on a convexity 58 at the grain boundary of the dielectric material. The particle diameter of the dielectric material of the emitter 30 should preferably be in the range from 0.1 μm to 10 μm, and more preferably be in the range from 2 μm to 7 μm. In the embodiment shown in FIG. 2, the particle diameter of the dielectric material is of 3 μm.

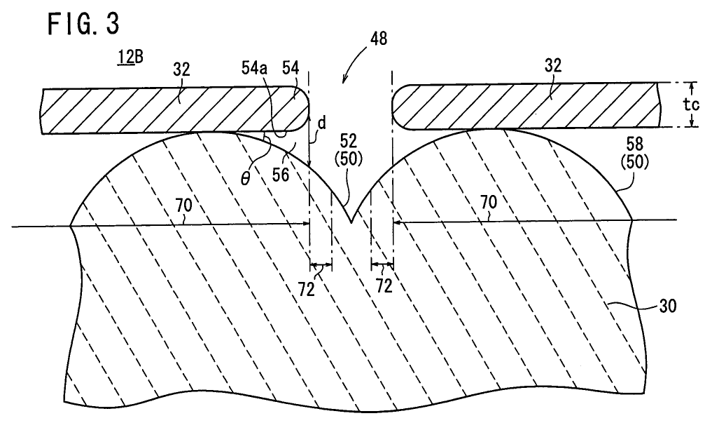

As shown in FIG. 3, each of the through regions 48 of the upper electrode 32 has a peripheral portion 54 having a surface 54a facing the emitter 30, the surface 54a being spaced from the emitter 30. Specifically, a gap 56 is formed between the surface 54a, facing the emitter 30, of the peripheral portion 54 of the through region 48 and the emitter 30, and the peripheral portion 54 of the through region 48 of the upper electrode 32 is formed as an overhanging portion (flange). In the description which follows, “the peripheral portion 54 of the through region 48 of the upper electrode 32” is referred to as “the overhanging portion 54 of the upper electrode 32”. In FIGS. 2, 3, 5A, 5B, 6A, 6B, 8, and 10, convexities 58 of the uneven pattern 50 of the grain boundary of the dielectric material are shown as having a semicircular cross-sectional shape. However, the convexities 58 are not limited to the semicircular cross-sectional shape.

With the electron emitter 12, the upper electrode 32 has a thickness tc in the range of 0.01 μm≦tc≦10 μm, and the maximum angle θ between the upper surface of the emitter 30, i.e., the surface of the convexity 58 (which is also the inner wall surface of the concavity 52) of the grain boundary of the dielectric material, and the lower surface 54a of the overhanging portion 54 of the upper electrode 32 is in the range of 1°≦θ≦60°. The maximum distance d in the vertical direction between the surface of the convexity 58 (the inner wall surface of the concavity 52) of the grain boundary of the dielectric material of the emitter 30 and the lower surface 54a of the overhanging portion 54 of the upper electrode 32 is in the range of 0 μm≦d≦10 μm.

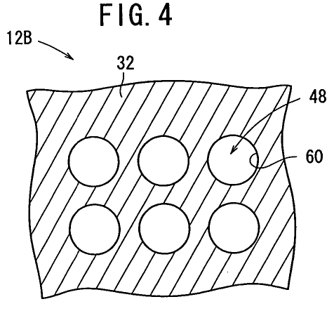

In the electron emitter 12, the shape of the through region 48, particularly the shape as seen from above, as shown in FIG. 4, is the shape of a hole 60, which may be a circular shape, an elliptical shape, a shape including a curve such as a track shape, or a polygonal shape such as a quadrangular shape or a triangular shape. In FIG. 4, the shape of the hole 60 is a circular shape.

The hole 60 has an average diameter ranging from 0.1 μm to 10 μm. The average diameter represents the average of the lengths of a plurality of different line segments passing through the center of the hole 60. If the through regions 48 are reduced in size by adjusting the material and/or sintering conditions of the upper electrode 32, then the average diameter of the hole 60 may be in the range from 0.05 μm to 0.1 μm. If the through regions 48 are reduced in size and highly integrated, then the amount of emitted electrons (the level of an electron flow) and the electron emission efficiency are increased.

The emitter 30 is made of a dielectric material. The dielectric material may preferably be a dielectric material having a relatively high dielectric constant, e.g., a dielectric constant of 1000 or higher. Dielectric materials of such a nature may be ceramics including barium titanate, lead zirconate, lead magnesium niobate, lead nickel niobate, lead zinc niobate, lead manganese niobate, lead magnesium tantalate, lead nickel tantalate, lead antimony stannate, lead titanate, lead magnesium tungstate, lead cobalt niobate, etc. or a combination of any of these materials, a material which chiefly contains 50 weight % or more of any of these materials, or such ceramics to which there is added an oxide of such as lanthanum, calcium, strontium, molybdenum, tungsten, barium, niobium, zinc, nickel, manganese, or the like, or a combination of these materials, or any of other compounds.

For example, a two-component material nPMN-mPT (n, m represent molar ratios) of lead magnesium niobate (PMN) and lead titanate (PT) has its Curie point lowered for a larger specific dielectric constant at room temperature if the molar ratio of PMN is increased.

Particularly, a dielectric material where n=0.85-1.0 and m=1.0-n is preferable because its specific dielectric constant is 3000 or higher. For example, a dielectric material where n=0.91 and m=0.09 has a specific dielectric constant of 15000 at room temperature, and a dielectric material where n=0.95 and m=0.05 has a specific dielectric constant of 20000 at room temperature.

For increasing the specific dielectric constant of a three-component dielectric material of lead magnesium niobate (PMN), lead titanate (PT), and lead zirconate (PZ), it is preferable to achieve a composition close to a morphotropic phase boundary (MPB) between a tetragonal system and a quasi-cubic system or a tetragonal system and a rhombohedral system, as well as to increase the molar ratio of PMN. For example, a dielectric material where PMN:PT:PZ=0.375:0.375:0.25 has a specific dielectric constant of 5500, and a dielectric material where PMN:PT:PZ=0.5:0.375:0.125 has a specific dielectric constant of 4500, which is particularly preferable. Furthermore, it is preferable to increase the dielectric constant by introducing a metal such as platinum into these dielectric materials within a range to keep them insulative. For example, a dielectric material may be mixed with 20 weight % of platinum.

The emitter 30 may be in the form of a piezoelectric/electrostrictive layer or an anti-ferroelectric layer. If the emitter 30 comprises a piezoelectric/electrostrictive layer, then it may be made of ceramics such as lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstate, lead cobalt niobate, or the like, or a combination of any of these materials.

The emitter 30 may be made of chief components including 50 wt % or more of any of the above compounds. Of the above ceramics, the ceramics including lead zirconate is mostly frequently used as a constituent of the piezoelectric/electrostrictive layer of the emitter 30.

If the piezoelectric/electrostrictive layer is made of ceramics, then lanthanum, calcium, strontium, molybdenum, tungsten, barium, niobium, zinc, nickel, manganese, or the like, or a combination of these materials, or any of other compounds may be added to the ceramics. Alternatively, ceramics produced by adding SiO₂, CeO₂, Pb₅Ge₃O₁₁, or a combination of any of these compounds to the above ceramics may be used. Specifically, a material produced by adding 0.2 wt % of SiO₂, 0.1 wt % of CeO₂, or 1 to 2 wt % of Pb₅Ge₃O₁₁ to a PT-PZ-PMN piezoelectric material is preferable.

For example, the piezoelectric/electrostrictive layer should preferably be made of ceramics including as chief components lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the emitter 30 is in the form of an anti-ferroelectric layer, then the anti-ferroelectric layer may be made of lead zirconate as a chief component, lead zirconate and lead tin as chief components, lead zirconate with lanthanum oxide added thereto, or lead zirconate and lead tin as components with lead zirconate or lead niobate added thereto.

The anti-ferroelectric layer may be porous. If the anti-ferroelectric layer is porous, then it should preferably have a porosity of 30% or less.

If the emitter 30 is made of strontium tantalate bismuthate (SrBi₂Ta₂O₉), then its polarization inversion fatigue is small. Materials whose polarization inversion fatigue is small are laminar ferroelectric compounds and expressed by the general formula of (BiO₂)²⁺(Aₘ₋₁BₘO₃ₘ₊₁)²⁻. Ions of the metal A are Ca²⁺, Sr²⁺, Ba²⁺, Pb²⁺, Bi³⁺, La³⁺, etc., and ions of the metal B are Ti⁴⁺, Ta⁵⁺, Nb⁵⁺, etc. An additive may be added to piezoelectric ceramics of barium titanate, lead zirconate, and PZT to convert them into a semiconductor. In this case, it is possible to provide an irregular electric field distribution in the emitter 30 to concentrate an electric field in the vicinity of the interface with the upper electrode 32 which contributes to the emission of electrons.

The sintering temperature can be lowered by adding glass such as lead borosilicate glass or the like or other compounds of low melting point (e.g., bismuth oxide or the like) to the piezoelectric/electrostrictive/anti-ferroelectric ceramics.

If the emitter 30 is made of piezoelectric/electrostrictive/anti-ferroelectric ceramics, then it may be a sheet-like molded body, a sheet-like laminated body, or either one of such bodies stacked or bonded to another support substrate.

If the emitter 30 is made of a non-lead-based material, then it may be a material having a high melting point or a high evaporation temperature so as to be less liable to be damaged by the impingement of electrons or ions.

The emitter 30 may be made by any of various thick-film forming processes including screen printing, dipping, coating, electrophoresis, aerosol deposition, powder jet deposition (film growth based on high-speed ejection of fine particles under the atmospheric pressure), etc., or any of various thin-film forming processes including an ion beam process, sputtering, vacuum evaporation, ion plating, chemical vapor deposition (CVD), plating, etc. Particularly, it is preferable to form a powdery piezoelectric/electrostrictive material as the emitter 30 and impregnate the emitter 30 thus formed with glass of a low melting point or sol particles. According to this process, it is possible to form a film at a low temperature of 700° C. or lower or 600° C. or lower.

The upper electrode 32 should preferably be made of an organic metal paste which can produce a thin film after being baked. For example, a platinum resinate paste or the like should preferably be used. An oxide electrode for suppressing a polarization inversion fatigue, which is made of ruthenium oxide (RuO₂), iridium oxide (IrO₂), strontium ruthenate (SrRuO₃), La₁₋ₓSrₓCoO₃ (e.g., x=0.3 or 0.5), La₁₋ₓCaₓMnO₃ (e.g., x=0.2), La₁₋ₓCaₓMn_{1-y}Co_{y}O₃ (e.g., x=0.2, y=0.05), or a mixture of any one of these compounds and a platinum resinate paste, for example, is preferable. A mixture of a platinum resinate paste and a gold resinate paste or an iridium resinate paste is also preferable as it allows small through regions 48 to be easily formed.

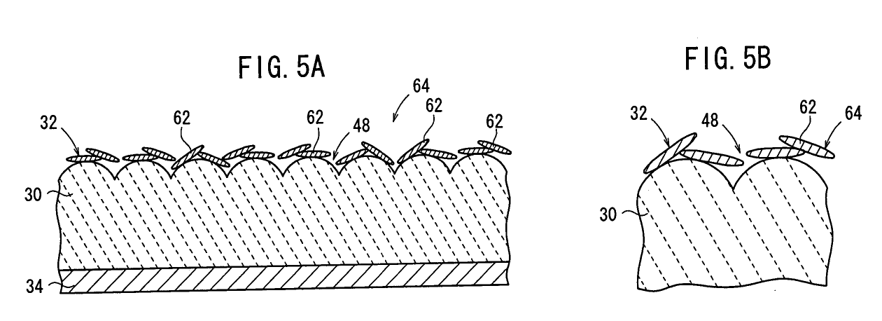

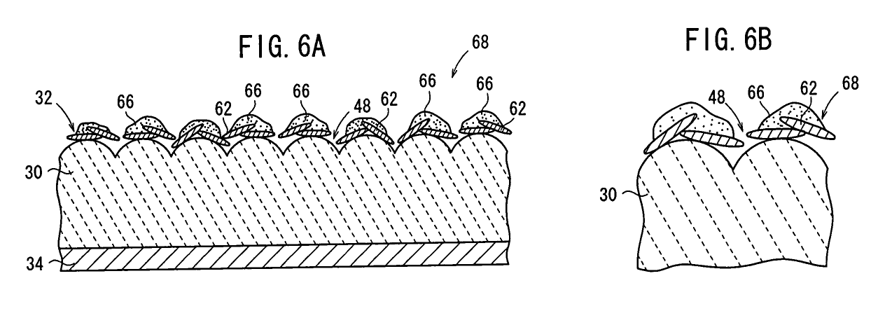

As shown in FIGS. 5A and 5B, the upper electrode 32 may preferably be in the form of a first cluster 64 of a plurality of scale-like members 62 (e.g., of graphite). Alternatively, as shown in FIGS. 6A and 6B, the upper electrode 32 may preferably be in the form of a second cluster 68 of electrically conductive members 66 including scale-like members 62. The first cluster 64 or the second cluster 68 does not fully cover the surface of the emitter 30, but a plurality of through regions 48 are provided through which the emitter 30 is partly exposed, and those portions of the emitter 30 which face the through regions 48 serve as electron emission regions.

The upper electrode 32 may be made of any of the above materials by any of thick-film forming processes including screen printing, spray coating, coating, dipping, electrophoresis, etc., or any of various thin-film forming processes including sputtering, an ion beam process, vacuum evaporation, ion plating, chemical vapor deposition (CVD), plating, etc. Preferably, the upper electrode 32 is made by any of the above thick-film forming processes.

The lower electrode 34 is made of an electrically conductive material, e.g., a metal such as platinum, molybdenum, tungsten, or the like. Alternatively, the lower electrode 34 is made of an electric conductor which is resistant to a high-temperature oxidizing atmosphere, e.g., a metal, an alloy, a mixture of insulative ceramics and a metal, a mixture of insulative ceramics and an alloy, or the like. Preferably, the lower electrode 34 should be made of a precious metal having a high melting point such as platinum, iridium, palladium, rhodium, molybdenum, or the like, or a material chiefly composed of an alloy of silver and palladium, silver and platinum, platinum and palladium, or the like, or a cermet of platinum and ceramics. Further preferably, the lower electrode 34 should be made of platinum only or a material chiefly composed of a platinum-base alloy.

The lower electrode 34 may be made of carbon or a graphite-base material. Ceramics to be added to the electrode material should preferably have a proportion ranging from 5 to 30 volume %. The lower electrode 34 may be made of the same material as the upper electrode 32, as described above.

The lower electrode 34 should preferably be formed by any of the various thick-film forming processes described above. The lower electrode 34 has a thickness of 20 μm or less or preferably a thickness of 5 μm or less.

Each time the emitter 30, the upper electrode 32, or the lower electrode 34 is formed, the assembly is heated (sintered) into an integral structure.

The sintering process for integrally combining the emitter 30, the upper electrode 32, and the lower electrode 34 may be carried out at a temperature ranging from 500 to 1400° C., preferably from 1000 to 1400° C. For heating the emitter 30 which is in the form of a film, the emitter 30 should be sintered together with its evaporation source while their atmosphere is being controlled so that the composition of the emitter 30 will not become unstable at high temperatures.

By performing the sintering process, the film which will serve as the upper electrode 32 is shrunk from the thickness of 10 μm to the thickness of 0.1 μm, and simultaneously a plurality of holes are formed therein. As a result, as shown in FIG. 2, a plurality of through regions 48 are formed in the upper electrode 32, and the peripheral portions 54 of the through regions 48 are turned into overhanging portions. In advance (of the sintering process), the film which will serve as the upper electrode 32 may be patterned by etching (wet etching or dry etching) or lift-off, and then may be sintered. In this case, recesses or slits may easily be formed as the through regions 48.

The emitter 30 may be covered with a suitable member, and then sintered such that the surface of the emitter 30 will not be exposed directly to the sintering atmosphere.

The principles of electron emission of the electron emitter 12 will be described below. First, a drive voltage Va is applied between the upper electrode 32 and the lower electrode 34. The drive voltage Va is defined as a voltage, such as a pulse voltage or an alternating-current voltage, which abruptly changes with time from a voltage level that is higher or lower than a reference voltage (e.g., 0 V) to a voltage level that is lower or higher than the reference voltage.

A triple junction is formed in a region of contact between the upper surface of the emitter 30, the upper electrode 32, and a medium (e.g., a vacuum) around the electron emitter 12. The triple junction is defined as an electric field concentration region formed by a contact between the upper electrode 32, the emitter 30, and the vacuum. The triple junction includes a triple point where the upper electrode 32, the emitter 30, and the vacuum exist as one point. The vacuum level in the atmosphere should preferably be in the range from 10² to 10⁻⁶ Pa and more preferably in the range from 10⁻³ to 10⁻⁵ Pa.

With the electron emitter 12, the triple junction is formed on the overhanging portion 54 of the upper electrode 32 and the peripheral area of the upper electrode 32. Therefore, when the above drive voltage Va is applied between the upper electrode 32 and the lower electrode 34, an electric field concentration occurs at the triple junction.

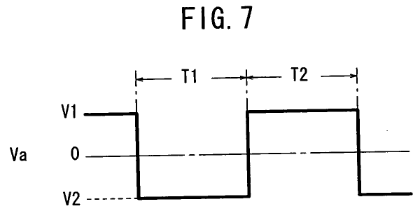

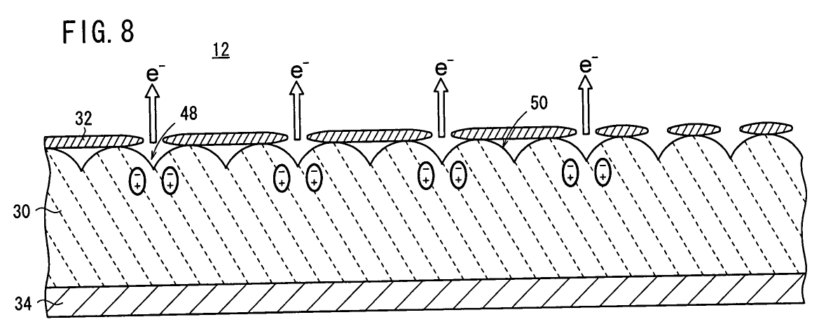

A first electron emission process for the electron emitter 12 will be described below with reference to FIGS. 7 and 8. In a first output period T1 (first stage) shown in FIG. 7, a voltage V2 lower than a reference voltage (e.g., 0 V) is applied to the upper electrode 32, and a voltage V1 higher than the reference voltage is applied to the lower electrode 34. In the first output period T1, an electric field concentration occurs at the triple junction referred to above, causing the upper electrode 32 to emit primary electrons toward the emitter 30. The emitted electrons are accumulated in the portions of the emitter 30 which are exposed through the through region 48 of the upper electrode 32 and the regions near the outer peripheral portion of the upper electrode 32, thus charging the emitter 30. At this time, the upper electrode 32 functions as an electron supply source.

In a second output period T2 (second stage), the voltage level of the drive voltage Va abruptly changes, i.e., the voltage V1 higher than the reference voltage is applied to the upper electrode 32, and the voltage V2 lower than the reference voltage is applied to the lower electrode 34. The electrons that have been accumulated in the portions of the emitter 30 which are exposed through the through region 48 of the upper electrode 32 and the regions near the outer peripheral portion of the upper electrode 32 are expelled from the emitter 30 by dipoles (whose negative poles appear on the surface of the emitter 30) in the emitter 30 whose polarization has been inverted in the opposite direction. As shown in FIG. 8, the electrons are emitted from the portions of the emitter 30 where the electrons have been accumulated, through the through regions 48. The electrons are also emitted from the regions near the outer peripheral portion of the upper electrode 32 to form an electron flow as a whole.

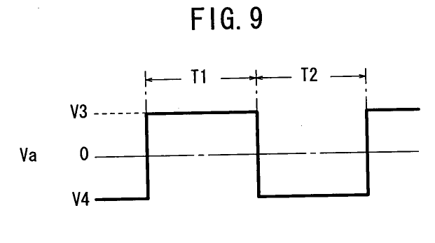

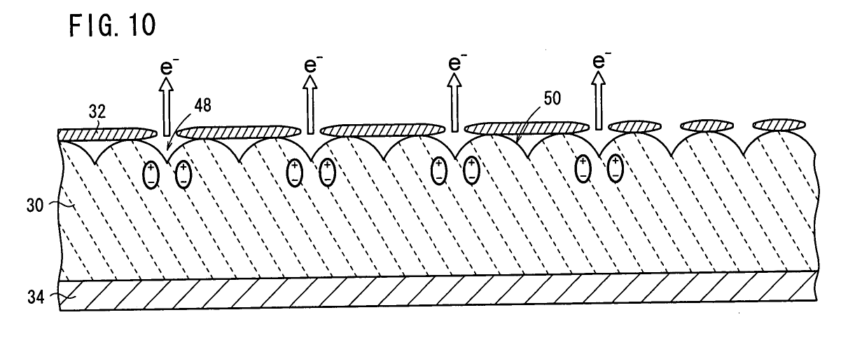

A second electron emission process will be described below. In a first output period T1 (first stage) shown in FIG. 9, a voltage V3 higher than the reference voltage is applied to the upper electrode 32, and a voltage V4 lower than the reference voltage is applied to the lower electrode 34. In the first output period T1, the electron emitter 12 is prepared for electron emission (e.g., the emitter 30 is polarized in one direction). In a second output period T2 (second stage), the voltage level of the drive voltage Va abruptly changes, i.e., the voltage V4 lower than the reference voltage is applied to the upper electrode 32, and the voltage V3 higher than the reference voltage is applied to the lower electrode 34. An electric field concentration occurs at the triple junction referred to above, causing the upper electrode 32 to emit primary electrons, which impinge upon the portions of the emitter 30 which are exposed through the through region 48 and the regions near the outer peripheral portion of the upper electrode 32. As shown in FIG. 10, secondary electrons (including reflected primary electrons) are emitted from the portions hit by the primary electrons. Thus, secondary electrons are emitted from the through region 48 and the regions near the outer peripheral portion of the upper electrode 32 in an initial stage of the second output period T2.

The electron emitter 12 offers the following advantages: Since the upper electrode 32 has the plural through regions 48, electrons are uniformly emitted from each of the through regions 48 and the outer peripheral portions of the upper electrode 32. Thus, any variations in the overall electron emission characteristics of the electron emitter 12 are reduced, making it possible to facilitate the control of the electron emission and increase the electron emission efficiency.

Because the gap 56 is formed between the overhanging portion 54 of the upper electrode 32 and the emitter 30, when the drive voltage Va is applied, an electric field concentration tends to be produced in the region of the gap 56. This leads to a higher efficiency of the electron emission, making the drive voltage lower (emitting electrons at a lower voltage level).

As described above, since the upper electrode 32 has the overhanging portion 54 on the peripheral portion of the through region 48, together with the increased electric field concentration in the region of the gap 56, electrons are easily emitted from the overhanging portion 54 of the upper electrode 32. This leads to a larger output and higher efficiency of the electron emission, making the drive voltage Va lower. The light source 10, which has a number of arrayed electron emitters 12, has a higher level of luminance.

According to either the first electron emission process (which emits electrons accumulated in the emitter 30) or the second electron emission process (which emits secondary electrons by forcing primary electrons from the upper electrode 32 into impingement upon the emitter 30), as the overhanging portion 54 of the upper electrode 32 functions as a gate electrode (a control electrode, a focusing electronic lens, or the like), the tendency of the emitted electrons to travel straight can be increased. This is effective in reducing crosstalk if a number of electron emitters 12 are arrayed for use as an electron source of displays.

The electron emitter 12 is capable of easily developing a high electric field concentration, provides many electron emission regions, has a larger output and higher efficiency of the electron emission, and can be driven at a lower voltage (lower power consumption).

In particular, at least the upper surface of the emitter 30 has the uneven pattern 50 of the grain boundary of the dielectric material. As the upper electrode 32 has the through regions 48 in portions corresponding to the concavities 52 of the grain boundary of the dielectric material, the overhanging portions 54 of the upper electrode 32 can easily be realized.

The maximum angle θ between the upper surface of the emitter 30, i.e., the surface of the convexity 58 (which is also the inner wall surface of the concavity 52) of the grain boundary of the dielectric material, and the lower surface 54a of the overhanging portion 54 of the upper electrode 32 is in the range of 1°≦θ≦60°. The maximum distance d in the vertical direction between the surface of the convexity 58 (the inner wall surface of the concavity 52) of the grain boundary of the dielectric material of the emitter 30 and the lower surface 54a of the overhanging portion 54 of the upper electrode 32 is in the range of 0 μm<d≦10 μm. These arrangements make it possible to increase the degree of the electric field concentration in the region of the gap 56, resulting in a larger output and higher efficiency of the electron emission and making the drive voltage lower efficiently.

The through region 48 is in the shape of the hole 60. As shown in FIG. 3, the portions of the emitter 30 where the polarization is inverted or changed depending on the drive voltage Va applied between the upper electrode 32 and the lower electrode 34 (see FIG. 2) include a portion (first portion 70) directly below the upper electrode 32 and a portion (second portion 72) corresponding to a region extending from the inner peripheral edge of the through region 48 to the inward of the through region 48. Particularly, the second portion 72 changes depending on the level of the drive voltage Va and the degree of the electric field concentration. With the electron emitter 12, the average diameter of the hole 60 is in the range from 0.1 μm to 10 μm. Insofar as the average diameter of the hole 60 is in this range, the distribution of electrons emitted through the through region 48 is almost free of any variations, allowing electrons to be emitted efficiently.

If the upper electrode 32 comprises an alloy electrode chiefly made of a Pt resinate paste and the sintering conditions are adjusted, then the average diameter of the hole 60 may be less than 0.1 μm. Particularly, if the temperature is quickly increased in the sintering process, then it is possible to form holes 60 having an average diameter less than 0.1 μm at a high density. If the average diameter of the hole 60 is in excess of 10 μm, then the proportion (share) of the portion (second portion) 72 which contributes to the emission of electrons in the portion of the emitter 30 that is exposed through the through region 48 is reduced, resulting in a reduction in the electron emission efficiency.

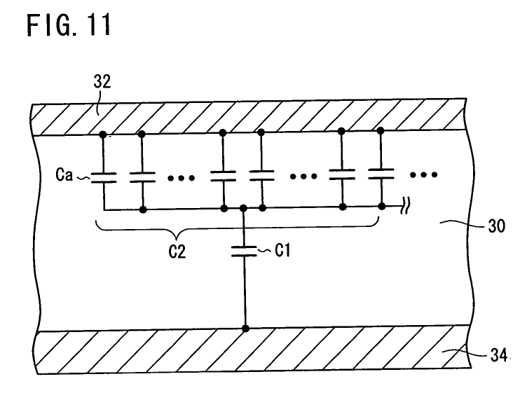

As shown in FIG. 11, the electron emitter 12 has in its electrical operation a capacitor C1 due to the emitter 30 and a cluster of capacitors Ca due to respective gaps 56, disposed between the upper electrode 32 and the lower electrode 34. The capacitors Ca due to the respective gaps 56 are connected parallel to each other into a single capacitor C2. In terms of an equivalent circuit, the capacitor C1 due to the emitter 30 is connected in series to the capacitor C2 which comprises the cluster of capacitors Ca.

Actually, the capacitor C1 due to the emitter 30 is not directly connected in series to the capacitor C2 which comprises the cluster of capacitors Ca, but the capacitive component that is connected in series varies depending on the number of the through regions 48 formed in the upper electrode 32 and the overall area of the through regions 48.

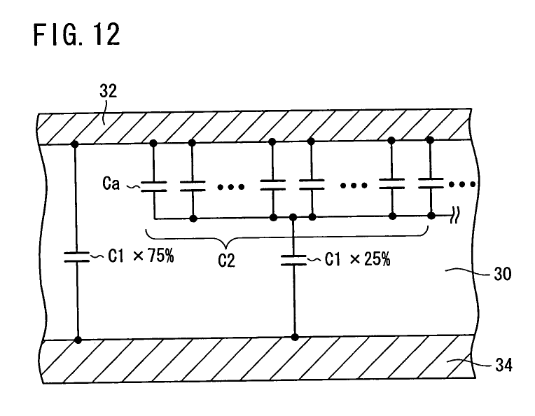

Capacitance calculations will be performed on the assumption that 25% of the capacitor C1 due to the emitter 30 is connected in series to the capacitor C2 which comprises the cluster of capacitors Ca, as shown in FIG. 12. Since the gaps 56 are in vacuum, the relative dielectric constant thereof is 1. It is assumed that the maximum distance d across the gaps 56 is 0.1 μm, the area S of each gap 56 is S=1 μm×1 μm, and the number of the gaps 56 is 10,000. It is also assumed that the emitter 30 has a relative dielectric constant of 2000, the emitter 30 has a thickness of 20 μm, and the confronting area of the upper and lower electrodes 32, 34 is 200 μm×200 μm. The capacitor C2 which comprises the cluster of capacitors Ca has a capacitance of 0.885 pF, and the capacitor C1 due to the emitter 30 has a capacitance of 35.4 pF. If the portion of the capacitor C1 due to the emitter 30 which is connected in series to the capacitor C2 which comprises the cluster of capacitors Ca is 25% of the entire capacitor C1, then that series-connected portion has a capacitance (including the capacitance of capacitor C2 which comprises the cluster of capacitors Ca) of 0.805 pF, and the remaining portion has a capacitance of 26.6 pF.

Because the series-connected portion and the remaining portion are connected parallel to each other, the overall capacitance is 27.5 pF. This capacitance is 78% of the capacitance 35.4 pF of the capacitor C1 due to the emitter 30. Therefore, the overall capacitance is smaller than the capacitance of the capacitor C1 due to the emitter 30.

Consequently, the capacitance of the cluster of capacitors Ca due to the gaps 56 is relatively small. Because of the voltage division between the cluster of capacitors Ca and the capacitor C1 due to the emitter 30, almost the entire applied voltage Va is applied across the gaps 56, which are effective to produce a larger output of the electron emission.

Since the capacitor C2 which comprises the cluster of capacitors Ca is connected in series to the capacitor C1 due to the emitter 30, the overall capacitance is smaller than the capacitance of the capacitor C1 due to the emitter 30. This is effective to provide such preferred characteristics that the electron emission is performed for a larger output and the overall power consumption is lower.

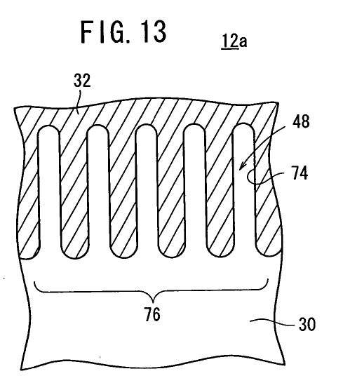

Three modifications of the electron emitter 12 will be described below with reference to FIGS. 13 through 15.

As shown in FIG. 13, an electron emitter 12a according to a first modification differs from the above electron emitter 12 in that the through region 48 has a shape, particularly a shape viewed from above, in the form of a recess 74. As shown in FIG. 13, the recess 74 should preferably be shaped such that a number of recesses 74 are successively formed into a saw-toothed recess 76. The saw-toothed recess 76 is effective to reduce variations in the distribution of electrons emitted through the through region 48 for efficient electron emission. Particularly, it is preferable to have the average width of the recesses 76 in the range from 0.05 μm to 10 μm. The average width represents the average of the lengths of a plurality of different line segments extending perpendicularly across the central line of the recess 74.

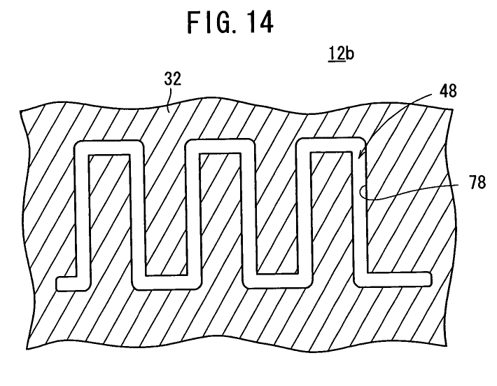

As shown in FIG. 14, an electron emitter 12b according to a second modification differs from the above electron emitter 12 in that the through region 48 has a shape, particularly a shape viewed from above, in the form of a slit 78. The slit 78 is defined as something having a major axis (extending in a longitudinal direction) whose length is 10 times or more the length of the minor axis (extending in a transverse direction) thereof. Those having a major axis (extending in a longitudinal direction) whose length is less than 10 times the length of the minor axis (extending in a transverse direction) thereof are defined as holes 60 (see FIG. 4). The slit 78 includes a succession of holes 60 in communication with each other. The slit 78 should preferably have an average width ranging from 0.05 μm to 10 μm for reducing variations in the distribution of electrons emitted through the through region 48 for efficient electron emission. The average width represents the average of the lengths of a plurality of different line segments extending perpendicularly across the central line of the slit 78.

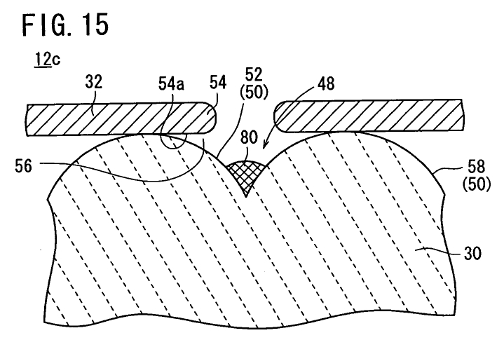

As shown in FIG. 15, an electron emitter 12c according to a third modification differs from the above electron emitter 12 in that a floating electrode 80 exists on the portion of the upper surface of the emitter 30 which corresponds to the through region 48, e.g., in the concavity 52 of the grain boundary of the dielectric material. With this arrangement, as the floating electrode 80 functions as an electron supply source, the electron emitter 12c can emit many electrons through the through region 48 in an electron emission stage (the second output period T2 (see FIG. 7) according to the first electron emission process described above). The electron emission from the floating electrode 80 may be attributed to an electric field concentration at the triple junction of the floating electrode 80, the dielectric material, and the vacuum.

The characteristics of the electron emitter 12, particularly, the voltage vs. charge quantity characteristics (the voltage vs. polarization quantity characteristics) thereof will be described below.

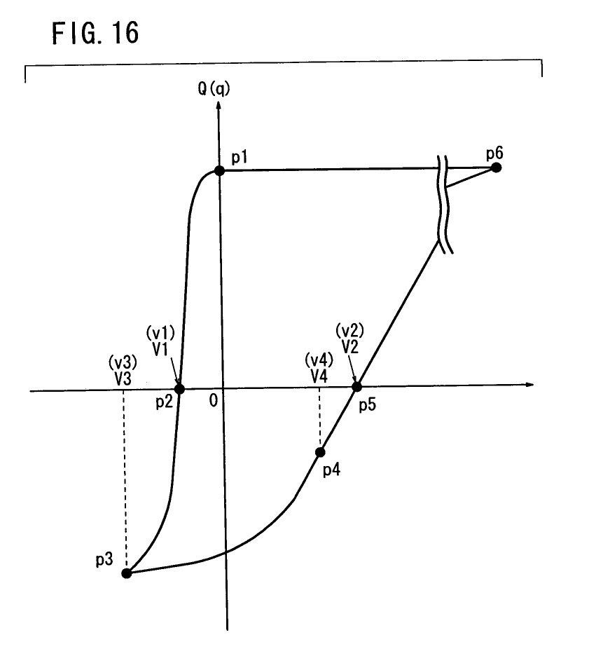

The electron emitter 12 is characterized by an asymmetric hysteresis curve based on the reference voltage=0 (V) in vacuum, as indicated by the characteristics shown in FIG. 16.

The voltage vs. charge quantity characteristics will be described below. If a region of the emitter 30 from which electrons are emitted is defined as an electron emission region, then at a point p1 (initial state) where the reference voltage is applied, almost no electrons are stored in the electron emission region. Thereafter, when a negative voltage is applied, the amount of positive charges of dipoles whose polarization is inverted in the emitter 30 in the electron emission region increases, and electrons are emitted from the upper electrode 32 toward the electron emission region in the first stage, so that electrons are stored. When the absolute value of the negative voltage increases, electrons are progressively stored in the electron emission region until the amount of positive charges and the amount of electrons are held in equilibrium with each other at a point p2 of the negative voltage. As the absolute value of the negative voltage further increases, the stored amount of electrons increases, making the amount of negative charges greater than the amount of positive charges. The accumulation of electrons is saturated at a point P3. The amount of negative charges is the sum of the amount of electrons remaining to be stored and the amount of negative charges of the dipoles whose polarization is inverted in the emitter 30.

When the absolute value of the negative voltage subsequently decreases, and a positive voltage is applied in excess of the reference voltage, electrons start being emitted at a point p4 in the second stage. When the positive voltage increases in a positive direction, the amount of emitted electrons increases until the amount of positive charges and the amount of electrons are held in equilibrium with each other at a point p5. At a point p6, almost all the stored electrons are emitted, bringing the difference between the amount of positive charges and the amount of negative charges into substantial conformity with a value in the initial state. That is, almost all stored electrons are eliminated, and only the negative charges of dipoles whose polarization is inverted in the emitter 30 appear in the electron emission region.

The voltage vs. charge quantity characteristics have the following features:

(1) If the negative voltage at the point p2 where the amount of positive charges and the amount of electrons are held in equilibrium with each other is represented by V1 and the positive voltage at the point p5 is represented by V2, then these voltages satisfy the following relationship:
|V1|<|V2|

(2) More specifically, the relationship is expressed as
1.5×|V1|<|V2|

(3) If the rate of change of the amount of positive charges and the amount of electrons at the point p2 is represented by ΔQ1/ΔV1 and the rate of change of the amount of positive charges and the amount of electrons at the point p5 by ΔQ2/ΔV2, then these rates satisfy the following relationship:
(ΔQ1/ΔV1)>(ΔQ2/ΔV2)

(4) If the voltage at which the accumulation of electrons is saturated is represented by V3 and the voltage at which electrons start being emitted is represented by V4, then these voltages satisfy the following relationship:
1≦|V4|/|V3|≦1.5

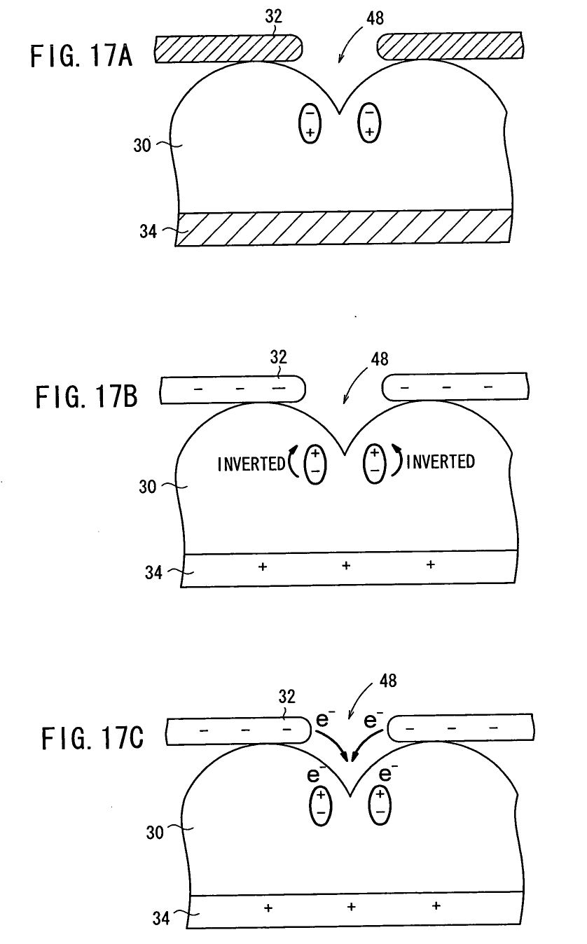

The characteristics shown in FIG. 16 will be described below in terms of the voltage vs. polarization quantity characteristics. It is assumed that the emitter 30 is polarized in one direction, with dipoles having negative poles facing toward the upper surface of the emitter 30 (see FIG. 17A).

At the point p1 (initial state) where the reference voltage (e.g., 0 V) is applied as shown in FIG. 16, since the negative poles of the dipole moments face toward the upper surface of the emitter 30, as shown in FIG. 17A, almost no electrons are accumulated on the upper surface of the emitter 30.

Thereafter, when a negative voltage is applied and the absolute value of the negative voltage is increased, the polarization starts being inverted substantially at the time the negative voltage exceeds a negative coercive voltage (see the point p2 in FIG. 16). All the polarization is inverted at the point p3 shown in FIG. 16 (see FIG. 17B). Because of the polarization inversion, an electric field concentration occurs at the triple junction, and the upper electrode 32 emits electrons toward the emitter 30 in the first stage, causing electrons to be accumulated in the portion of the emitter 30 which is exposed through the through region 48 of the upper electrode 32 and the portion of the emitter 30 which is near the peripheral portion of the upper electrode 32 (see FIG. 17C). In particular, electrons are emitted (emitted inwardly) from the upper electrode 32 toward the portion of the emitter 30 which is exposed through the through region 48 of the upper electrode 32. At the point p3 shown in FIG. 16, the accumulation of electrons is saturated.

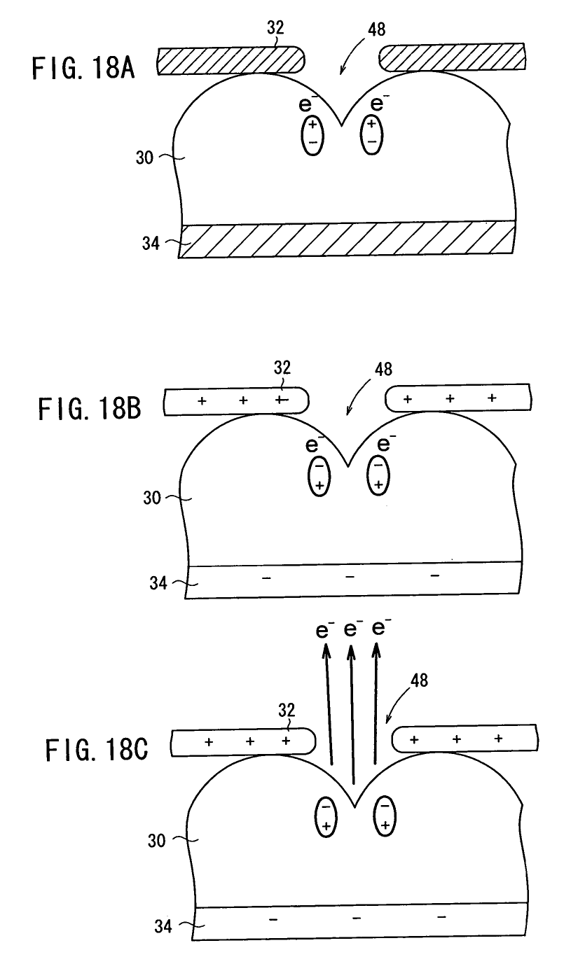

Thereafter, when the absolute value of the negative voltage is reduced and a positive voltage is applied in excess of the reference voltage, the upper surface of the emitter 30 is kept charged up to a certain voltage level (see FIG. 18A). As the level of the positive voltage is increased, there is produced a region where the negative poles of dipoles start facing the upper surface of the emitter 30 (see FIG. 18B) immediately prior to the point p4 in FIG. 16. When the level is further increased, electrons start being emitted due to coulomb repulsive forces posed by the negative poles of the dipoles after the point p4 in FIG. 16 (see FIG. 18C). When the positive voltage is increased in the positive direction, the amount of emitted electrons is increased. Substantially at the time the positive voltage exceeds the positive coercive voltage (the point p5), a region where the polarization is inverted again is increased. At the point p6, almost all the accumulated electrons are emitted, and the amount of polarization at this time is essentially the same as the amount of polarization in the initial state.

The characteristics of the electron emitter 12 have the following features:

(A) If the negative coercive voltage is represented by v1 and the positive coercive voltage by v2, then
|v1|<|v2|

(B) More specifically, 1.5×|v1|<|v2|

(C) If the rate of change of the polarization at the time the negative coercive voltage v1 is applied is represented by Δq1/Δv1 and the rate of change of the polarization at the time the positive coercive voltage v2 is applied is represented by Δq2/Δv2, then
(Δq1/Δv1)>(Δq2/Δv2)

(D) If the voltage at which the accumulation of electrons is saturated is represented by v3 and the voltage at which electrons start being emitted is represented by v4, then
1≦|v4|/|v3|≦1.5

Since the electron emitter 12 has the above characteristics, it can easily be applied to the light source 10 which has a plurality of electron emitters 12 arrayed in association with a plurality of pixels, for emitting light due to the emission of electrons from the electron emitters 12.

The drive circuit 16 shown in FIG. 1 will be described below. A power supply circuit 90 (which supplies 50 V and 0 V, for example) is connected to the row selecting circuit 22 and the signal supplying circuit 24. A pulse power supply 92 is connected between a negative line and GND (ground), the negative line being provided between the row selecting circuit 22 and the power supply circuit 90. The pulse power supply 92 outputs a pulsed voltage waveform having a reference voltage (e.g., 0 V) during a charge accumulation period Td, to be described later, and a certain voltage (e.g., −400 V) during an electron emission period Th.

During the charge accumulation period Td, the row selecting circuit 22 outputs the selection signal Ss to the selected row and outputs a non-selection signal Sn to the unselected rows. During the electron emission period Th, the row selecting circuit 22 outputs a constant voltage (e.g., −350 V) which is the sum of a power supply voltage (e.g., 50 V) from the power supply circuit 90 and a voltage (e.g., −400 V) from the pulse power supply 92.

The signal supplying circuit 24 has a pulse generating circuit 94 and an amplitude modulating circuit 96. The pulse generating circuit 94 generates and outputs a pulse signal Sp having a constant pulse period and a constant amplitude (e.g., 50 V) during the charge accumulation period Td, and outputs a reference voltage (e.g., 0 V) during the electron emission period Th.

During the charge accumulation period Td, the amplitude modulating circuit 96 amplitude-modulates the pulse signal Sp from the pulse generating circuit 94 depending on the luminance levels of the light-emitting devices of the selected row, and outputs the amplitude-modulated pulse signal Sp as the data signal Sd for the light-emitting devices of the selected row. During the electron emission period Th, the amplitude modulating circuit 96 outputs the reference voltage from the pulse generating circuit 94 as it is. The timing control in the amplitude modulating circuit 96 and the supply of the luminance levels of the selected light-emitting devices to the amplitude modulating circuit 96 are performed through the signal supplying circuit 24.

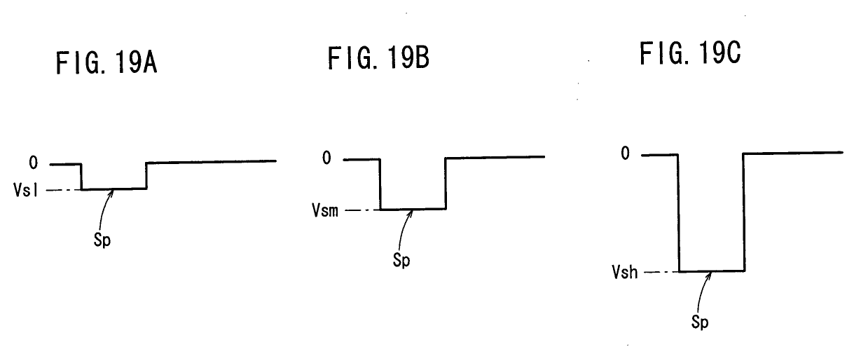

For example, as indicated by three examples shown in FIGS. 19A through 19C, if the luminance level is low, then the amplitude of the pulse signal Sp is set to a low level Vsl (see FIG. 19A), if the luminance level is medium, then the amplitude of the pulse signal Sp is set to a medium level Vsm (see FIG. 19B), and if the luminance level is high, then the amplitude of the pulse signal Sp is set to a high level Vsh (see FIG. 19C). Though the amplitude of the pulse signal Sp is modulated into three levels in the above examples, if the amplitude modulation is applied to the light source 10, then the pulse signal Sp is amplitude-modulated to 128 levels or 256 levels depending on the luminance levels of the light-emitting devices.

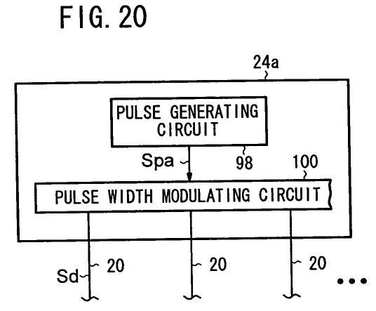

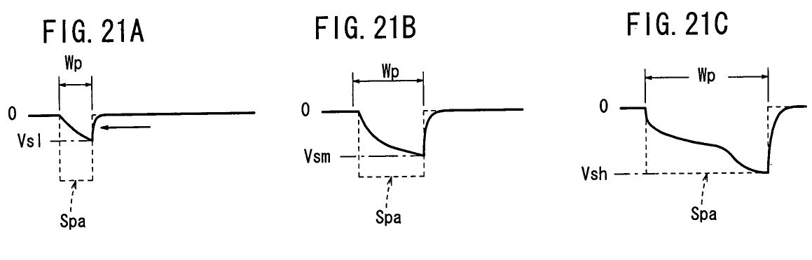

A modification of the signal supplying circuit 24 will be described below with reference to FIGS. 20 through 21C.

As shown in FIG. 20, a modified signal supplying circuit 24a has a pulse generating circuit 98 and a pulse width modulating circuit 100. The pulse generating circuit 98 generates and outputs a pulse signal Spa (indicated by the broken lines in FIGS. 21A through 21C) where the positive-going edge of a voltage waveform (indicated by the solid lines in FIGS. 21A through 21C) applied to the electron emitter 12 is continuously changed in level, during the charge accumulation period Td. The pulse generating circuit 98 outputs a reference voltage during the electron emission period Th. During the charge accumulation period Td, the pulse width modulating circuit 100 modulates a pulse width Wp (see FIGS. 21A through 21C) of the pulse signal Spa from the pulse generating circuit 98 depending on the luminance levels of the light-emitting devices of the selected row, and outputs the pulse signal Spa as the data signal Sd for the light-emitting devices of the selected row. During the electron emission period Th, the pulse width modulating circuit 100 outputs the reference voltage from the pulse generating circuit 98 as it is. The timing control in the pulse width modulating circuit 100 and the supply of the luminance levels of the selected pixels to the pulse width modulating circuit 100 are also performed through the signal supplying circuit 24a.

For example, as indicated by three examples shown in FIGS. 21A through 21C, if the luminance level is low, then the pulse width Wp of the pulse signal Spa is set to a short width, setting the substantial amplitude to a low level Vsl (see FIG. 21A), if the luminance level is medium, then the pulse width Wp of the pulse signal Spa is set to a medium width, setting the substantial amplitude to a medium level Vsm (see FIG. 21B), and if the luminance level is high, then the pulse width Wp of the pulse signal Spa is set to a long width, setting the substantial amplitude to a high level Vsh (see FIG. 21C). Though the pulse width Wp of the pulse signal Spa is modulated into three levels in the above examples, if the amplitude modulation is applied to the light source 10, then the pulse signal Spa is pulse-width-modulated to 128 levels or 256 levels depending on the luminance levels of the light-emitting devices.

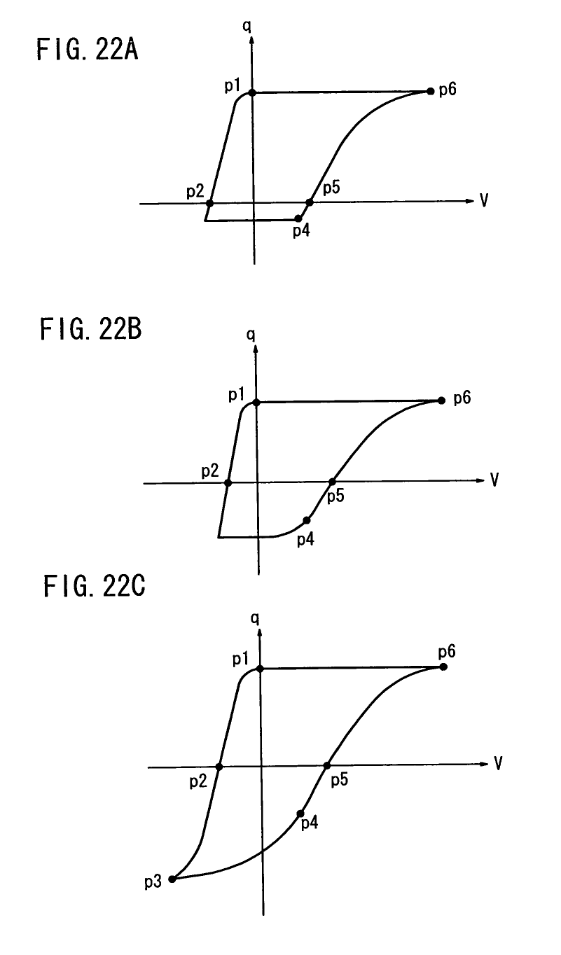

Changes of the characteristics at the time when the level of the negative voltage for the accumulation of electrons is changed will be reviewed in relation to the three examples of amplitude modulation on the pulse signal Sp shown in FIGS. 19A through 19C and the three examples of pulse width modulation on the pulse signal Spa shown in FIGS. 21A through 21C. At the level Vsl of the negative voltage shown in FIGS. 19A and 21A, the amount of electrons accumulated in the electron emitter 12 is small as shown in FIG. 22A. At the level Vsm of the negative voltage shown in FIGS. 19B and 21B, the amount of electrons accumulated in the electron emitter 12 is medium as shown in FIG. 22B. At the level Vsh of the negative voltage shown in FIGS. 19C and 21C, the amount of electrons accumulated in the electron emitter 12 is large and is substantially saturated as shown in FIG. 22C.

However, as shown in FIGS. 22A through 22C, the voltage levels at the point p4 where electrons start being emitted are substantially the same as each other. That is, even if the applied voltage changes to the voltage level indicated at the point p4 after electrons are accumulated, the amount of accumulated electrons does not change essentially. It can thus be seen that a memory effect has been caused.

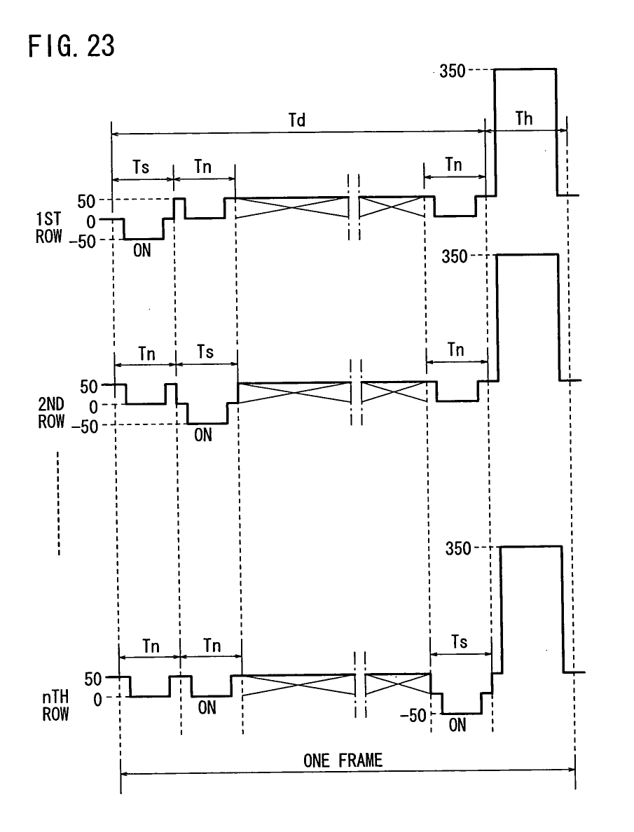

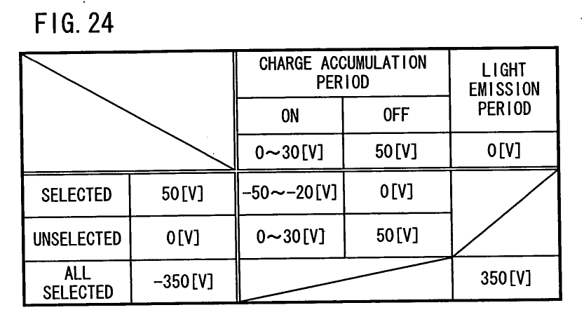

A drive method for the light source 10 according to the present embodiment will be described below with reference to FIGS. 23 and 24. FIG. 23 shows operation of pixels in the first row and the first column, the second row and the first column, and the nth row and the first column. An electron emitter 12 used in the drive method has such characteristics that the coercive voltage v1 at the point p2 shown in FIG. 16 is −20 V, the coercive voltage v2 at the point p5 is +70 V, the voltage v3 at the point p3 is −50 V, and the voltage v4 at the point p4 is +50 V, for example.

As shown in FIG. 23, if the period in which to select all the rows is defined as one frame, then one charge accumulation period Td and one electron emission period Th are included in one frame, and n selection periods Ts are included in one charge accumulation period Td. Since each selection period Ts becomes a selection period Ts for a corresponding row, the period for non-corresponding n−1 rows becomes a non-selection period Tn.

According to the drive method, all the electron emitters 12 are scanned in the charge accumulation period Td, and voltages depending on the luminance levels of corresponding light-emitting devices are applied to a plurality of electron emitters 12 which correspond to pixels to be turned on (to emit light), thereby accumulating charges (electrons) in amounts depending on the luminance levels of the corresponding light-emitting devices in the electron emitters 12 which correspond to the light-emitting devices to be turned on. Then, in the electron emission period Th, a constant voltage is applied to all the electron emitters 12 to cause the electron emitters 12 which correspond to the light-emitting devices to be turned on to emit electrons in amounts depending on the luminance levels of the corresponding light-emitting devices, thereby emitting light from the light-emitting devices to be turned on.

More specifically, as also shown in FIG. 24, in the selection period Ts for the first row, a selection signal Ss of 50 V, for example, is supplied to the row selection line 18 of the first row, and a non-selection signal Sn of 0 V, for example, is applied to the row selection lines 18 of the other rows. A data signal Sd supplied to the signal lines 20 of the light-emitting devices to be turned on (to emit light) of the light-emitting devices of the first row has a voltage in the range from 0 V to 30 V, depending on the luminance levels of the corresponding light-emitting devices. If the luminance level is maximum, then the voltage of the data signal Sd is 0 V. The data signal Sd is modulated depending on the luminance level by the amplitude modulating circuit 96 shown in FIG. 1 or the pulse width modulating circuit 100 shown in FIG. 20.

Thus, a voltage ranging from −50 V to −20 V depending on the luminance level is applied between the upper and lower electrodes 32, 34 of the electron emitter 12 which corresponds to each of the light-emitting devices to be turned on in the first row. As a result, each electron emitter 12 accumulates electrons depending on the applied voltage. For example, the electron emitter 12 corresponding to the light-emitting device in the first row and the first column is in a state at the point p3 shown in FIG. 16 as the luminance level of the pixel is maximum, and the portion of the emitter 30 which is exposed through the through region 48 of the upper electrode 32 accumulates a maximum amount of electrons.

A data signal Sd supplied to the electron emitters 12 which correspond to light-emitting devices to be turned off (to extinguish light) has a voltage of 50 V, for example. Therefore, a voltage of 0 V is applied to the electron emitters 12 which correspond to light-emitting devices to be turned off, bringing those electron emitters 12 into a state at the point p1 shown in FIG. 16, so that no electrons are accumulated in those electron emitters 12.

After the supply of the data signal Sd to the first row is finished, in the selection period Ts for the second row, a selection signal Ss of 50 V is supplied to the row selection line 18 of the second row, and a non-selection signal Sn of 0 V is applied to the row selection lines 18 of the other rows. In this case, a voltage ranging from −50 V to −20 V depending on the luminance level is also applied between the upper and lower electrodes 32, 34 of the electron emitter 12 which corresponds to each of the light-emitting devices to be turned on. At this time, a voltage ranging from 0 V to 50 V is applied between the upper and lower electrodes 32, 34 of the electron emitter 12 which corresponds to each of unselected light-emitting devices in the first row, for example. Since this voltage is of a level not reaching the point 4 in FIG. 16, no electrons are emitted from the electron emitters 12 which correspond to the light-emitting devices to be turned on in the first row. That is, the unselected light-emitting devices in the first row are not affected by the data signal Sd that is supplied to the selected light-emitting devices in the second row.

Similarly, in the selection period Ts for the nth row, a selection signal Ss of 50 V is supplied to the row selection line 18 of the nth row, and a non-selection signal Sn of 0 V is applied to the row selection lines 18 of the other rows. In this case, a voltage ranging from −50 V to −20 V depending on the luminance level is also applied between the upper and lower electrodes 32, 34 of the electron emitter 12 which corresponds to each of the light-emitting devices to be turned on. At this time, a voltage ranging from 0 V to 50 V is applied between the upper and lower electrodes 32, 34 of the electron emitter 12 which corresponds to each of unselected light-emitting devices in the first through (n−1)th rows. However, no electrons are emitted from the electron emitters 12 which correspond to the light-emitting devices to be turned on, of those unselected light-emitting devices.

After elapse of the selection period Ts for the nth row, it is followed by the electron emission period Th. In the electron emission period Th, a reference voltage (e.g., 0 V) is applied from the signal supplying circuit 24 to the upper electrodes 32 of all the electron emitters 12, and a voltage of −350 V (the sum of the voltage of −400 V from the pulse power supply 92 and the power supply voltage 50 V from the row selecting circuit 22) is applied to the lower electrodes 34 of all the electron emitters 12. Thus, a high voltage (+350 V) is applied between the upper and lower electrodes 32, 34 of all the electron emitters 12. All the electron emitters 12 are now brought into a state at the point p6 shown in FIG. 16. As shown in FIG. 18, electrons are emitted from the portion of the emitter 30 where the electrons have been accumulated, through the through region 48. Electrons are also emitted from near the outer peripheral portion of the upper electrode 32.

Electrons are thus emitted from the electron emitters 12 which correspond to the light-emitting devices to be turned on (to emit light), and the emitted electrons are led to the anode electrodes 42 which correspond to those electron emitters 12, exciting the corresponding phosphor layers 44 which emit light. The emitted light is radiated out through the surface of the transparent substrate 40.

Subsequently, electrons are accumulated in the electron emitters 12 which correspond to the light-emitting devices to be turned on (to emit light) in the charge accumulation period Td, and the accumulated electrons are emitted for phosphorescent light emission in the electron emission period Th, for thereby radiating emitted light through the surface of the transparent substrate 40.

According to the present embodiment, as described above, an electron flow is not emitted throughout one frame, but an electron flow is emitted in the electron emission period Th of one frame. Therefore, an electron flow is emitted in a pulsed fashion. Specifically, an electron flow that is emitted from the electron emitter 12 can be defined as a pulsed electron flow or electron flow pulses.

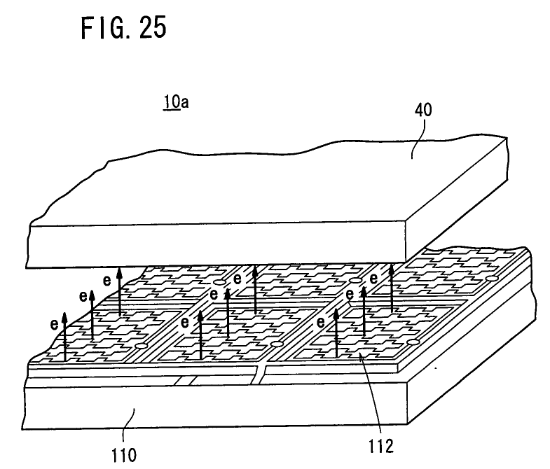

Preferred structures of the light source 10 according to the present embodiment which employs electron emitters 12 described above will be described below with reference to FIGS. 25 through 35.

As shown in FIG. 25, a light source 10a according to a first specific example has the transparent substrate 40 described above and a fixed substrate 110 having a plate surface disposed in facing relation to the reverse side of the transparent substrate 40. The anode electrode 42 in the form of a transparent electrode and the phosphor layer 44 as described above are disposed on the reverse side of the transparent substrate 40. A two-dimensional array of electron emitters 12 as shown in FIG. 2, for example, is disposed on the principal surface of the fixed substrate 110. A vacuum is developed between the transparent substrate 40 and the fixed substrate 110.

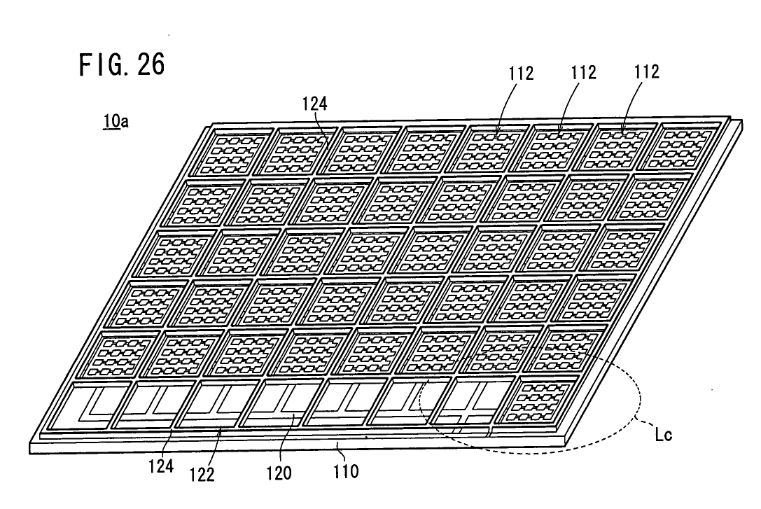

As shown in FIG. 26, the two-dimensional array of the electron emitters 12 may be in the form of a two-dimensional array of rectangular electron emission units 112 (described later).

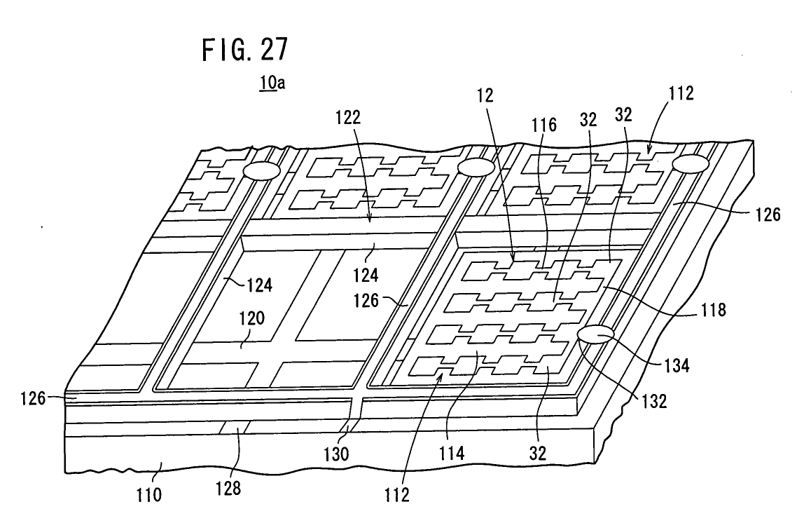

As shown in FIG. 27, each of the electron emission units 112 comprises a single ferroelectric sheet 114 (emitter 30), a matrix of 16 upper electrodes 32, for example, disposed on an upper surface of the ferroelectric sheet 114, and a matrix of lower electrodes 34 (not shown) disposed on a lower surface of the ferroelectric sheet 114 at respective positions aligned with the upper electrodes 32. Specifically, each of the electron emission units 112 comprises a matrix of 16 electron emitters 12.

In the arrangement shown in FIG. 27, in each of the electron emission units 112, the 16 upper electrodes 32 are arranged in four rows and four columns. The four upper electrodes 32 in each row are electrically connected to each other by leads 116, and the four upper electrodes 32 in the rightmost column are electrically connected to each other by leads 118. The lower electrodes 34 are similarly arranged and electrically connected.

A plurality of lower electrode interconnects 120 are disposed on the principal surface of the fixed substrate 110. A frame 122 is mounted on the principal surface of the fixed substrate 110 where the lower electrode interconnects 120 are disposed. The frame 122 has a plurality of rectangular cribs, arranged a matrix, for example, which are defined by a plurality of walls 124 arranged in rows and columns. The electron emission units 112 are inserted respectively in the rectangular cribs. Each of the rectangular cribs as viewed in plan is slightly greater than a single electron emission unit 112, allowing the electron emission units 112 to be easily inserted respectively in the rectangular cribs. In FIGS. 26 and 27, some of the electron emission units 112 are omitted from illustration for making some of the lower electrode interconnects 120 visible.

As shown in FIG. 27, upper electrode interconnects 126 are disposed on the walls 124 of the frame 122. The lower electrode interconnects 120 have a common lead 128, and the upper electrode interconnects 126 have a common lead 130, the common leads 128, 130 extending to one side edge of the fixed substrate 110.

The upper electrode interconnects 126 and the upper electrodes 32 of the electron emission units 112 are electrically connected to each other by leads 132 extending from the upper electrodes 32 in the fourth columns and electrically connected to the upper electrode interconnects 126 disposed on the walls 124 near the upper electrodes 32 in the fourth columns, by an electrically conductive paste 134.

The lower electrode interconnects 120 and the lower electrodes 34 (not shown) in each of the electron emission units 112 are electrically connected to each other by an electrically conductive paste (not shown) applied to the lower electrode interconnects 120 disposed on the principal surface of the fixed substrate 110 and the lower electrodes 34.

As shown in FIG. 25, electrons are emitted from the electron emitters 12 in each of the electron emission units 112 to impinge upon the phosphor layer (not shown) on the reverse side of the transparent substrate 40, exciting the phosphor layer to emit phosphorescent light.

The light source 10a according to the first specific example is capable of emitting phosphorescent light due to electron excitation in each of the electron emission units 112 at an emission efficiency higher than the emission efficiency of LED light emission. The light source 10a is also advantageous in that it has a reduced burden on the environment because it does not employ mercury.

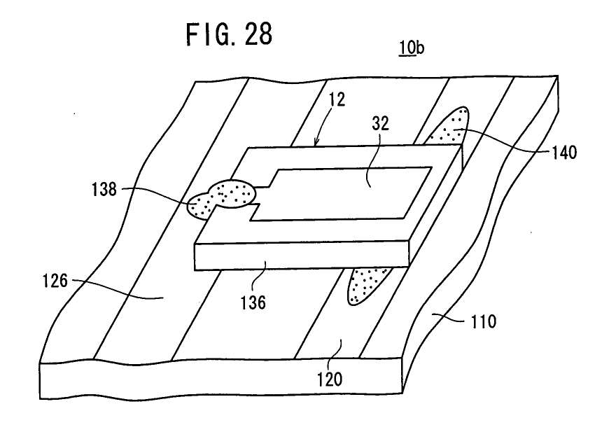

In the above example, the electron emission unit 112 has 16 electron emitters 12. A light source 10b according to a second specific example shown in FIG. 28 has a matrix of electron emitters 12 each comprising a ferroelectric chip 136.

Specifically, the light source 10b according to the second specific example has a lower electrode interconnect 120 and an upper electrode interconnect 126 provided on a fixed substrate 110 and spaced from and disposed adjacent to each other, and a plurality of electron emitters 12 disposed between and over the lower electrode interconnect 120 and the upper electrode interconnect 126. Each of the electron emitters 12 has an upper electrode 32 disposed on an upper surface of the ferroelectric chip 136 (emitter 30), and a lower electrode 34 (not shown) disposed on a lower surface of the ferroelectric chip 136. The upper electrode 32 and the upper electrode interconnect 126 are electrically connected to each other by an electrically conductive paste 138, and the lower electrode 34 (not shown) and the lower electrode interconnect 120 are electrically connected to each other by an electrically conductive paste 140.

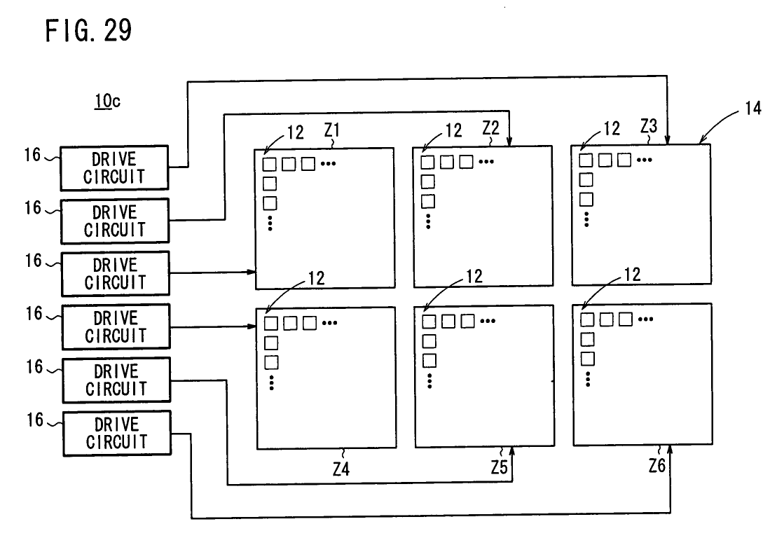

In the above embodiment, the light source has a single light emission section 14 including all the electron emitters 12, and a single drive circuit 16 connected to the light emission section 14. A light source 10c according to a third specific example shown in FIG. 29 has two or more planar light source sections Z1 through Z6. In the example shown in FIG. 29, the light source 10c has six planar light source sections Z1 through Z6. Each of the planar light source sections Z1 through Z6 has a two-dimensional array of electron emitters 12, and drive circuits 16 are independently connected to the respective planar light source sections Z1 through Z6.

Each of the planar light source sections Z1 through Z6 can be controlled for energization/de-energization to perform stepwise light control (digital light control). Particularly, if the drive circuits 16 independently connected respectively to the planar light source sections Z1 through Z6 have modulation circuits, then the light emission distributions of the planar light source sections Z1 through Z6 can independently be controlled. That is, the light source 10c can perform analog light control as well as digital light control for fine light control applications.

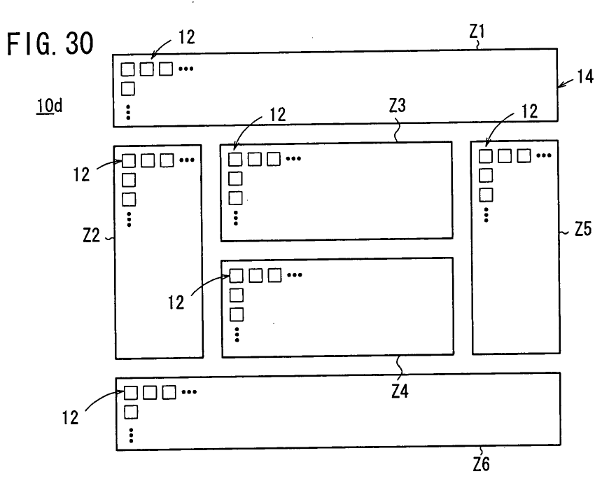

In the example shown in FIG. 29, the planar light source sections Z1 through Z6 have equal areas. However, the planar light source sections Z1 through Z6 may have different areas. For example, FIG. 30 shows a light source 10d according to a fourth specific example which includes first and sixth planar light source sections Z1, Z6 which are of a horizontally long rectangular shape with long sides, second and fifth planar light source sections Z2, Z5 which are of a vertically long rectangular shape with long sides shorter than the long sides of the first and sixth planar light source sections Z1, Z6, and third and fourth planar light source sections Z3, Z4 which are of a horizontally long rectangular shape with long sides shorter than the long sides of the first and sixth planar light source sections Z1, Z6.

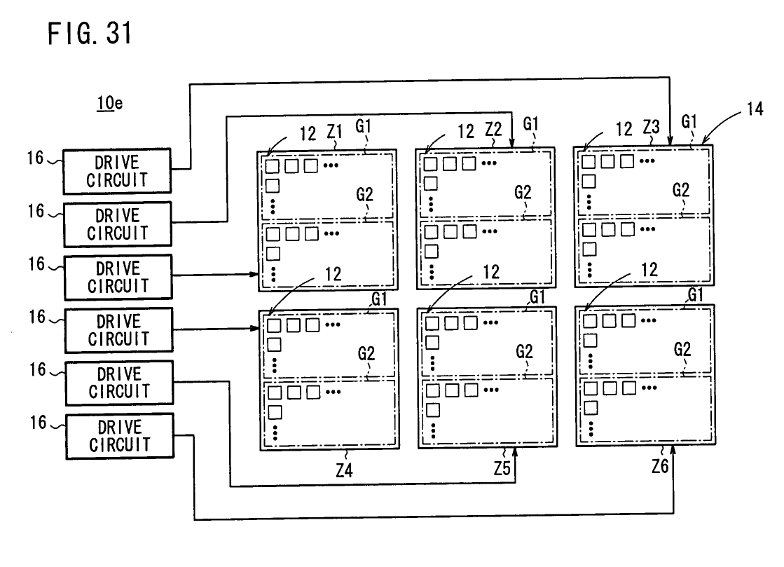

FIG. 31 shows a light source 10e according to a fifth specific example. The light source 10e has first through sixth planar light source sections Z1 through Z6. The electron emitters 12 in each of the first through sixth planar light source sections Z1 through Z6 are divided into two groups (first and second groups G1, G2). In each of the first through sixth planar light source sections Z1 through Z6, when the electron emitters 12 in the first group G1 emit light, the electron emitters 12 in the second group G2 retrieve electric power of the electron emitters 12 in the first group G1, and when the electron emitters 12 in the second group G2 emit light, the electron emitters 12 in the first group G1 retrieve electric power of the electron emitters 12 in the second group G2.

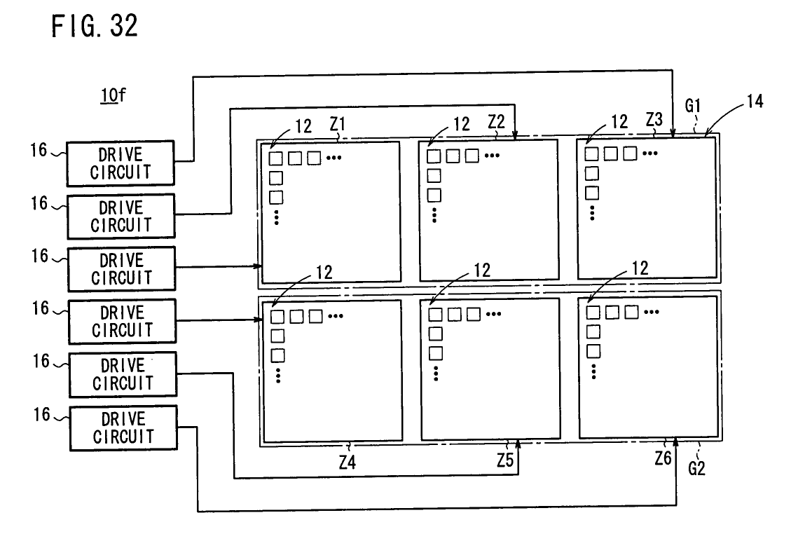

FIG. 32 shows a light source 10f according to a sixth specific example. The light source 10f has first through sixth planar light source sections Z1 through Z6. The first through sixth planar light source sections Z1 through Z6 are divided into two groups (first and second groups G1, G2). When the electron emitters 12 in the planar light source sections Z1 through Z3 in the first group G1 emit light, the electron emitters 12 in the planar light source sections Z4 through Z6 in the second group G2 retrieve electric power of the electron emitters 12 in the first group G1, and when the electron emitters 12 in the planar light source sections Z4 through Z6 in the second group G2 emit light, the electron emitters 12 in the planar light source sections Z1 through Z3 in the first group G1 retrieve electric power of the electron emitters 12 in the second group G2.

With the light sources 10c through 10f according to the third through sixth specific examples, the light emission section 14 is divided into the six planar light source sections Z1 through Z6. However, the number of planar light source sections is optional.

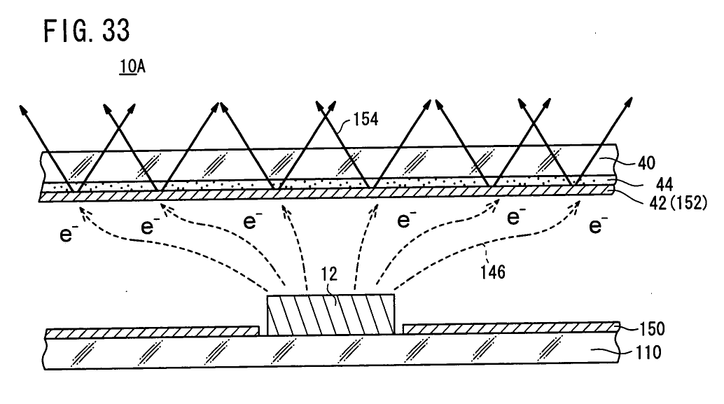

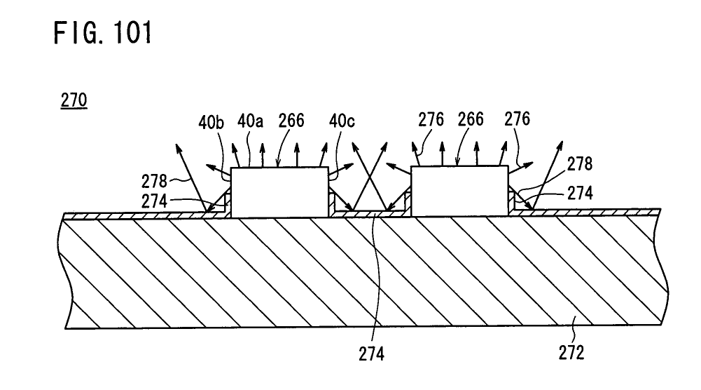

Light sources 10 according to various embodiments of the present invention will be described below with reference to FIGS. 33 through 101.

As shown in FIG. 33, a light source 10A according to a first embodiment of the present invention has a transparent substrate 40, a fixed substrate 110 disposed in facing relation to the transparent substrate 40, and a plurality of electron emitters 12 disposed on a principal surface of the fixed substrate 110 which confronts the transparent substrate 40.

A spreading electrode 150 is disposed on a portion of the principal surface of the fixed substrate 110 which is free of the electron emitters 12. A phosphor layer 44 is disposed substantially entirely on the reverse side of the transparent substrate 40 which confronts the fixed substrate 110, and an anode electrode 42 which comprises a metal film is disposed on the lower end face of the phosphor layer 44. The anode electrode 42 also functions as a metal back layer 152. The anode electrode 42 may be formed by sputtering or vacuum evaporation, or may be in the form of a metal foil applied to the phosphor layer 44. The metal film serving as the anode electrode 42 should preferably be made of Ag or Al as it has a high reflectance and is suitably flexible.

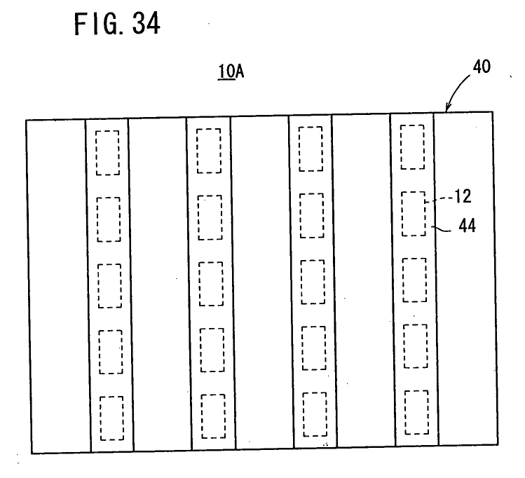

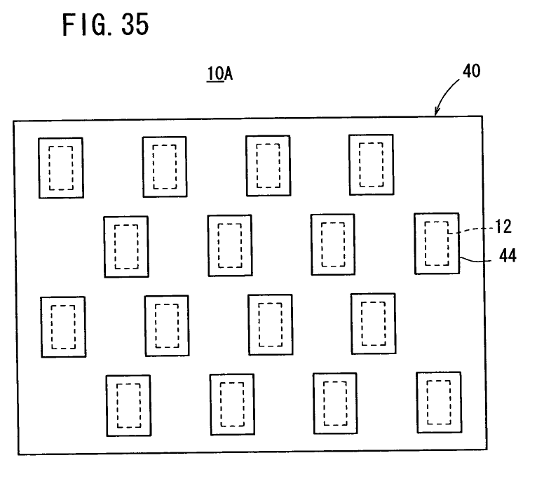

The electron emitters 12 and the phosphor layer 44 may be arrayed in a pattern as shown in FIG. 34 in which the electron emitters 12 are arranged in a matrix and the phosphor layer 44 is provided in the form of a plurality of strips extending along the columns of the matrix of the electron emitters 12. Alternatively, as shown in FIG. 35, the electron emitters 12 may be arranged in a staggered pattern, and the phosphor layer 44 may be provided in the form of a plurality of independent pads aligned respectively with the electron emitters 12. Further alternatively, the phosphor layer 44 may be arranged in a desired light-emission pattern on the reverse side of the transparent substrate 40 regardless of the matrix of the electron emitters 12.

As shown in FIG. 33, an electron flow 146 emitted from the electron emitters 12 on the fixed substrate 110 is accelerated by the anode electrode 42, and impinges upon the phosphor layer 44, causing the phosphor layer 44 to generate a phosphor emission 154. Almost 100% of the phosphor emission 154 is emitted as a surface emission by the metal back layer 152, i.e., the anode electrode 42.

The electron flow 146 is spread by an electric field generated by the spreading electrode 150 to excite the phosphor layer 44 on the transparent substrate 40. Therefore, the phosphor layer 44 is prevented from being saturated by an excessive amount of electrons impinging locally thereupon. The phosphor layer 44 is capable of emitting phosphorescent light from its irradiated surface highly efficiently through an increased area for a spread uniform surface emission.

In the present embodiment, if an acceleration voltage of 10 kV is applied to the anode electrode 42, then the pulsed electron flow (electron flow pulses) 146 that is applied to the phosphor layer 44 is spread to reduce its peak surface density to 50 μA/cm² or lower. Consequently, the light-emission efficiency of the phosphor layer 44 is prevented from being lowered by its saturation due to an excessive amount of electrons impinging locally thereupon.

The voltage applied to the spreading electrode 150 can control the spreading of electrons emitted from the electron emitter 12. Therefore, the light source 10A can be desired for optimally spreading electrons emitted from the electron emitter 12. Furthermore, the surface of the spreading electrode 150 may be polished to a mirror finish, allowing the spreading electrode 150 to function as a light reflecting layer.

When the pulsed electron flow 146 is intermittently emitted at certain time intervals, since the phosphor layer 44 keeps its persistent phosphor emission even during periods in which the pulsed electron flow 146 is not emitted, the light source 10A can emit light highly efficiently.

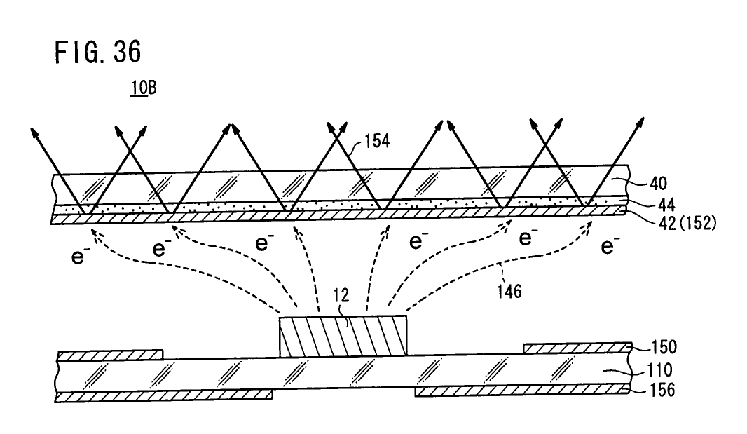

As shown in FIG. 36, a light source 10B according to a second embodiment of the present invention is of essentially the same structure as the light source 10A according to the first embodiment described above, except that the light source 10B includes, in addition to the spreading electrode 150 disposed on the surface of the fixed substrate 110 which faces the transparent substrate 40, a spreading electrode 156 disposed on the surface of the fixed substrate 110 which is remote from the spreading electrode 150 disposed on the principal surface of the fixed substrate 110. The fixed substrate 110 may be in the form of a transparent substrate.

According to the second embodiment, the light source 10B can be designed with increased freedom for generating an electric field for spreading the electron flow 146 while keeping a desired insulating distance between the spreading electrode 156 and the drive electrodes and interconnects of the electron emitters 12. The insulating distance may also be maintained by a separate insulating substrate such as of glass or the like disposed between the electron emitters 12 and the fixed substrate 110.

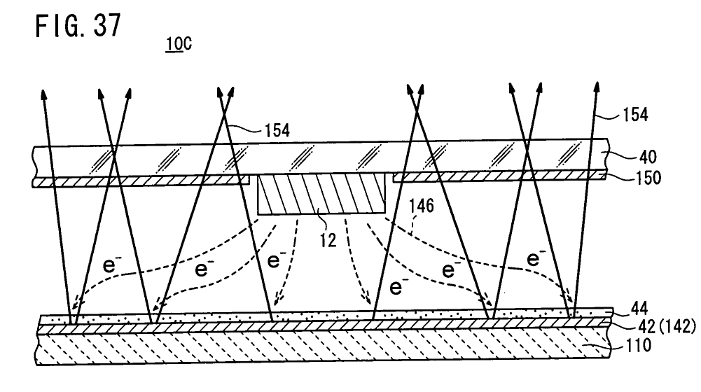

As shown in FIG. 37, a light source 10C according to a third embodiment of the present invention has a transparent substrate 40, a fixed substrate 110 disposed in facing relation to the transparent substrate 40, and a plurality of electron emitters 12 disposed on the reverse side of the transparent substrate 40 which confronts the fixed substrate 110. A spreading electrode 150 in the form of a transparent electrode is disposed on a portion of the reverse side of the transparent substrate 40 which is free of the electron emitters 12.

An anode electrode 42 which comprises a light reflecting film 142, for example, is disposed substantially entirely on the principal surface of the fixed substrate 110 which confronts the transparent substrate 40, and a phosphor layer 44 is disposed on the upper end face of the anode electrode 42.

When electrons emitted from the electron emitters 12 impinge upon the phosphor layer 44 on the principal surface of the fixed substrate 110, the phosphor layer 44 is excited to generate a phosphor emission 154. The phosphor emission 154 is reflected by the anode electrode 42 as the light reflecting film 142, travels toward the transparent substrate 40, and passes through the transparent substrate 40.

Since the phosphor emission 154 passes through the portion of the transparent substrate 40 which is free of the electron emitters 12, the phosphor emission 154 is effectively and highly efficiently utilized as display light from the surface of the transparent substrate 40. Accordingly, the portion of the transparent substrate 40 which is free of the electron emitters 12 is effectively utilized.

The electron flow 146 from the electron emitters 12 on the transparent substrate 40 is spread by an electric field that is generated by the spreading electrode 150, which comprises a transparent electrode, disposed on the transparent substrate 40, such that the surface density of the pulsed electron flow 146 that is applied to the phosphor layer 44 has a peak value of 50 μA/cm². Therefore, the phosphor layer 44 is prevented from being saturated by an excessive amount of electrons impinging locally thereupon, and is capable of emitting phosphorescent light from its irradiated surface highly efficiently through an increased area for a spread uniform surface emission.

When the pulsed electron flow 146 is intermittently emitted at certain time intervals, since the phosphor layer 44 keeps its persistent phosphor emission even during periods in which the pulsed electron flow 146 is not emitted, the light source 10C can emit light highly efficiently.

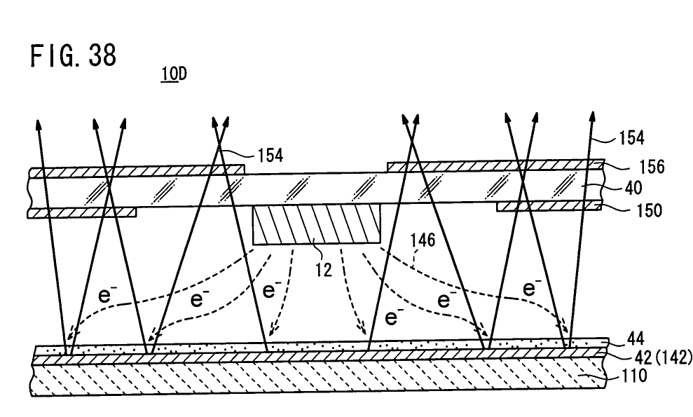

As shown in FIG. 38, a light source 10D according to a fourth embodiment of the present invention is of essentially the same structure as the light source 10C according to the third embodiment described above, except that the light source 10D includes, in addition to the spreading electrode 150 disposed on the surface of the transparent substrate 40 which faces the fixed substrate 110, a spreading electrode 156 disposed on the surface of the transparent substrate 40 which is remote from the fixed substrate 110.

According to the fourth embodiment, the light source 10D can be designed with increased freedom for generating an electric field for spreading the electron flow 146 while keeping a desired insulating distance between the spreading electrode 156 and the drive electrodes and interconnects of the electron emitters 12.

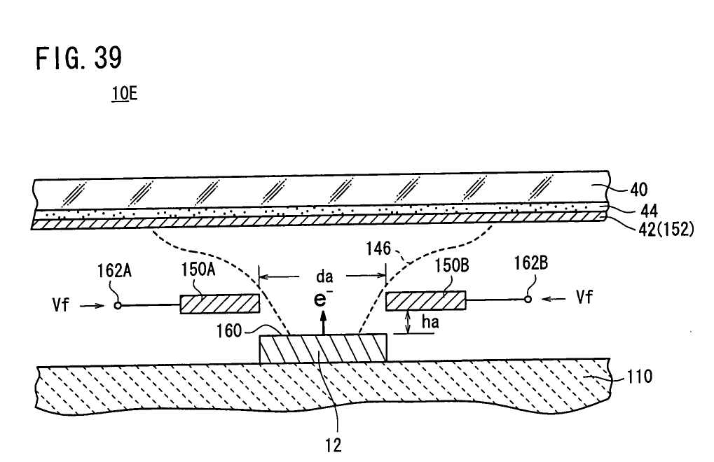

Preferred embodiments which employ the spreading electrode 150, etc. will be described below with reference to FIGS. 39 through 57.

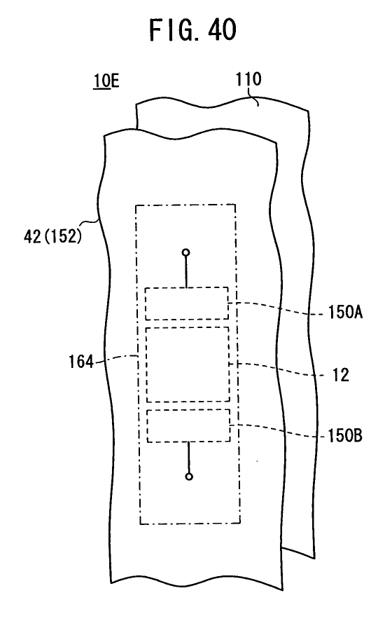

As shown in FIGS. 39 and 40, a light source 10E according to a fifth embodiment of the present invention is of essentially the same structure as the light source 10A according to the first embodiment described above, except that the light source 10E has two spreading electrodes, i.e., a first spreading electrode 150A and a second spreading electrode 150B, disposed around each electron emitter 12, and the first spreading electrode 150A and the second spreading electrode 150B are positioned upwardly of the upper surface, i.e., an electron emission surface 160, of the electron emitter 12.

When a positive control voltage Vf is applied to the first spreading electrode 150A and the second spreading electrode 150B through a first terminal 162A and a second terminal 162B thereof respectively, they generate an electrostatic lens in the emission path of the electron flow 146 for spreading the electron flow 146 from the electron emitter 12. The electron flow 146 emitted from the electron emitter 12 toward the metal back layer 152 is abruptly spread by the electrostatic lens disposed in the emission path of the electron flow 146, and then gradually spread as the electron flow 146 approaches the metal back layer 152. As a result, as shown in FIG. 40, an area 164 of the metal back layer 152 which is irradiated with the electron flow 146 is enlarged in the directions along which the first spreading electrode 150A and the second spreading electrode 150B are spaced from each other. The ratio at which the irradiated area 164 is enlarged, i.e., the enlargement ratio, is controlled as follows:

(1) The enlargement ratio is greater as the distance between the first and second spreading electrodes 150A, 150B, i.e., the size of the electron emitter 12, is smaller.

(2) The enlargement ratio is greater as the distance between the first and second spreading electrodes 150A, 150B and the electron emitter 12 is smaller.

(3) The voltage applied to the first and second spreading electrodes 150A, 150B should preferably be equal to or lower than the accelerating voltage applied to the anode electrode 42. The voltage which is equal to the accelerating voltage should more preferably be applied to the first and second spreading electrodes 150A, 150B from the standpoint of the enlargement ratio.

(4) The enlargement ratio is greater as the distance between the first and second spreading electrodes 150A, 150B and the anode electrode 42 is greater.

If the accelerating voltage applied to the anode electrode 42 is 10 kV, then the electron flow 146 can be spread such that the surface density of the pulsed electron flow 146 applied to the phosphor layer 44 has a peak value of 50 μA/cm² or lower. Therefore, the efficiency of the phosphor layer 44 is prevented from being lowered by being saturated by an excessive amount of electrons impinging locally thereupon. The enlarged irradiated area 164 is effective to prevent the phosphor layer 44 from being saturated, and the phosphor layer 44 is capable of emitting phosphorescent light from its irradiated surface highly efficiently through an increased area for a spread uniform surface emission.

The size of the irradiated area 164 can be changed by controlling the height ha of the first and second spreading electrodes 150A, 150B, i.e., the vertical distance from the horizontal position of the electron emission surface 160 of the electron emitter 12 to the horizontal position of the first and second spreading electrodes 150A, 150B, the horizontal distance da between the first and second spreading electrodes 150A, 150B, and the value of the control voltage Vf.

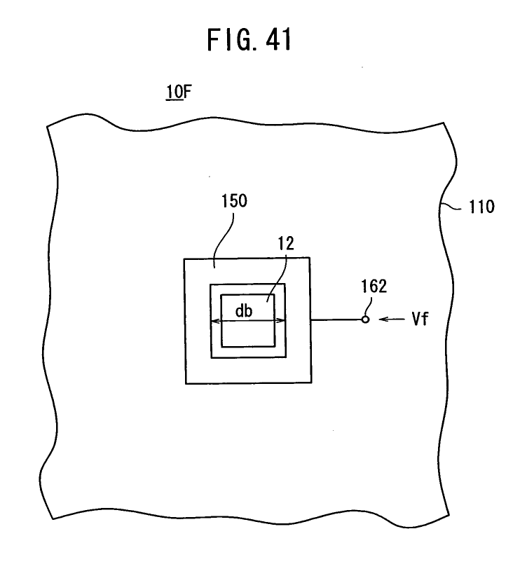

As shown in FIG. 41, a light source 10F according to a sixth embodiment of the present invention is of essentially the same structure as the light source 10E according to the fifth embodiment described above, except that the light source 10F has an annular spreading electrode 150.

The annular spreading electrode 150 has inner and outer profiles substantially similar to the outer profile of the electron emitter 12. In FIG. 41, if the electron emitter 12 has a square outer profile, then the annular spreading electrode 150 has square inner and outer profiles. The annular spreading electrode 150 has an inner opening width db greater than the length of each side of the electron emitter 12.

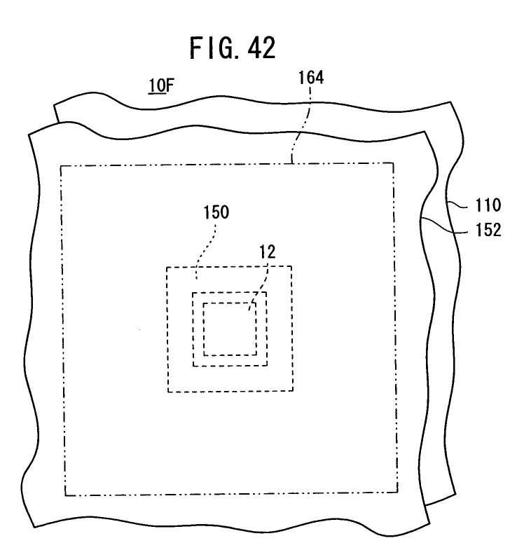

When a positive control voltage Vf is applied to the spreading electrode 150 through a terminal 162 thereof, it generates an electrostatic lens in the emission path of the electron flow 146 (see FIG. 39) for spreading the electron flow 146 from the electron emitter 12. The electron flow 146 emitted from the electron emitter 12 toward the metal back layer 152 is abruptly spread by the electrostatic lens disposed in the emission path of the electron flow 146, and then gradually spread as the electron flow 146 approaches the metal back layer 152. As a result, as shown in FIG. 42, an irradiated area 164 of the metal back layer 152 is enlarged in excess of a surface area including the spreading electrode 150. The enlarged irradiated area 164 is effective to prevent the phosphor layer 44 from being saturated, and the phosphor layer 44 is capable of emitting phosphorescent light highly efficiently from its irradiated surface through an increased area for a spread uniform surface emission.

The size of the irradiated area 164 can be changed by controlling the height of the spreading electrode 150, the opening width db of the spreading electrode 150, and the value of the control voltage Vf.

As shown in FIG. 42, the ratio at which the irradiated area 164 is enlarged, i.e., the enlargement ratio, is controlled as follows:

(1) The enlargement ratio is greater as the opening width db of the spreading electrode 150, i.e., the size of the electron emitter 12, is smaller.

(2) The enlargement ratio is greater as the distance between the spreading electrode 150 and the electron emitter 12 is smaller.

(3) The voltage applied to the spreading electrode 150 should preferably be equal to or lower than the accelerating voltage applied to the anode electrode 42. The voltage which is equal to the accelerating voltage should more preferably be applied to the spreading electrode 150 from the standpoint of the enlargement ratio.

(4) The enlargement ratio is greater as the distance between the spreading electrode 150 and the anode electrode 42 is greater.

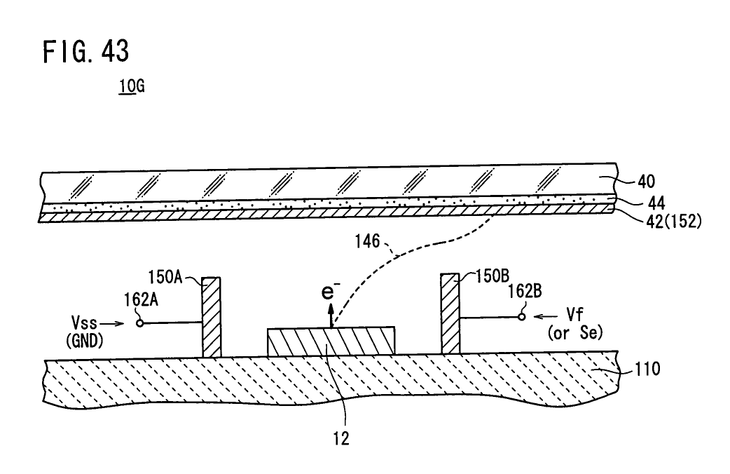

As shown in FIG. 43, a light source 10G according to a seventh embodiment of the present invention is of essentially the same structure as the light source 10E according to the fifth embodiment described above, except that the height of the first and second spreading electrodes 150A, 150B is greater than the height of the electron emitter 12, a ground potential Vss (GND: ground) is applied to the first spreading electrode 150A through a first terminal 162A thereof, and a constant voltage Vf or an alternating-current signal Se (such as sine-wave and triangular-wave signal) is applied to the second spreading electrode 150B through a second terminal 162B thereof.

When a positive constant voltage +Vf is applied to the second spreading electrode 150B, the trajectory of the electron flow 146 emitted from the electron emitter 12 is deflected toward the second spreading electrode 150B. Conversely, when a negative constant voltage −Vf is applied to the second spreading electrode 150B, the trajectory of the electron flow 146 emitted from the electron emitter 12 is deflected toward the first spreading electrode 150A.

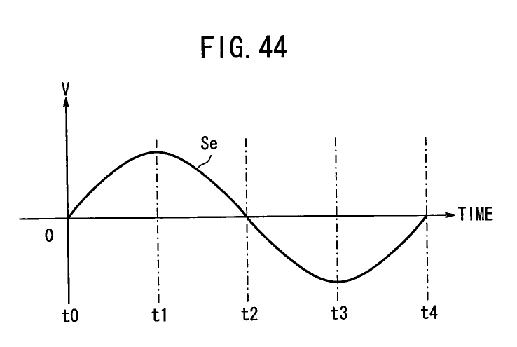

As shown in FIG. 44, when a sine wave Se (a positive sine wave and a negative sine wave) is continuously applied to the second spreading electrode 150B, the trajectory of the electron flow 146 emitted from the electron emitter 12 is continuously deflected depending on the voltage level of the sine wave Se. Thus, the first and second spreading electrodes 150A, 150B function as electrodes (deflecting electrodes) for deflecting the trajectory of the electron flow 146.

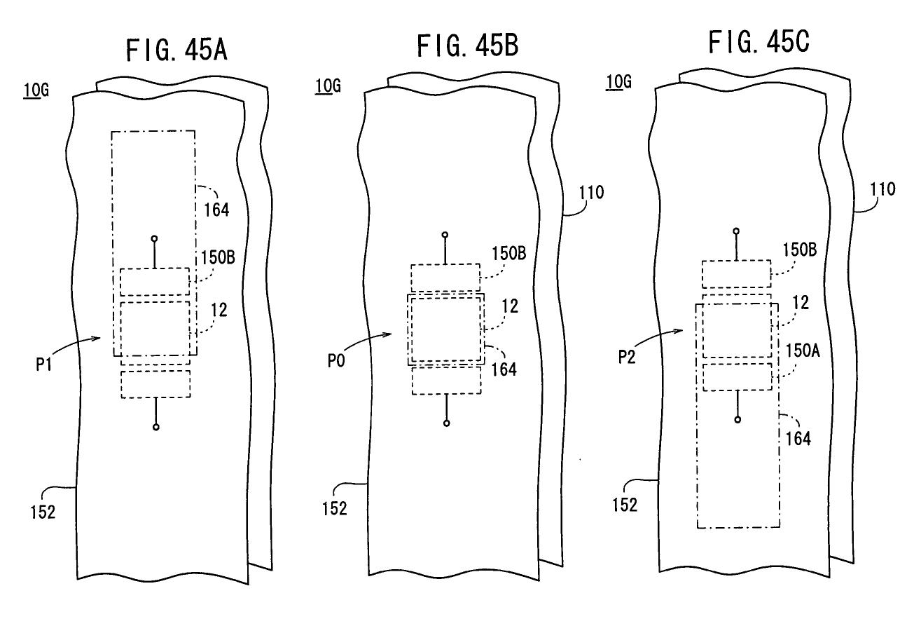

At a time t0 in FIG. 44, for example, since the voltage level of the sine wave Se is 0 (V), the electron flow 146 is not deflected and travels straight toward the metal back layer 152, irradiating a position P0 on the metal back layer 152, as shown in FIG. 45B. As the absolute value of the positive voltage level of the sine wave Se gradually increases, the electron flow 146 is progressively deflected toward the second spreading electrode 150B. At a time t1 when the absolute value of the positive voltage level is maximum, the electron flow 146 is deflected a maximum distance toward the second spreading electrode 150B, irradiating a position P1 on the metal back layer 152, as shown in FIG. 45A. Thereafter, as the absolute value of the positive voltage level gradually decreases, the electron flow 146 is progressively deflected away from the second spreading electrode 150B. At a time t2 when the voltage level of the sine wave Se is 0 (V), the electron flow 146 is not deflected and travels straight toward the metal back layer 152, irradiating the position P0 on the metal back layer 152, as shown in FIG. 45B.

Thereafter, as the absolute value of the negative voltage level of the sine wave Se gradually increases, the electron flow 146 is progressively deflected toward the first spreading electrode 150A. At a time t3 when the absolute value of the negative voltage level is maximum, the electron flow 146 is deflected a maximum distance toward the first spreading electrode 150A, irradiating a position P2 on the metal back layer 152, as shown in FIG. 45C. Thereafter, as the absolute value of the negative voltage level gradually decreases, the electron flow 146 is progressively deflected away from the first spreading electrode 150A. At a time t4 when the voltage level of the sine wave Se is 0 (V), the electron flow 146 is not deflected and travels straight toward the metal back layer 152, irradiating the position P0 on the metal back layer 152, as shown in FIG. 45B.

When the sine wave Se is continuously applied, the position on the metal back layer 152 which is irradiated with the electron flow 146 reciprocates between the position P1 and the position P2 across the position P0.

If only the positive sine wave Se is applied to the second spreading electrode 150B, then the position on the metal back layer 152 which is irradiated with the electron flow 146 reciprocates between the position P0 and the position P1. Conversely, if only the negative sine wave Se is applied to the second spreading electrode 150B, then the position on the metal back layer 152 which is irradiated with the electron flow 146 reciprocates between the position P0 and the position P2.

With the light source 10G according to the seventh embodiment, as described above, inasmuch as the trajectory of the electron flow 146 is deflected by the electric field, the area 164 of the metal back layer 152 which is irradiated with the electron flow 146 is two-dimensionally scanned. The area that is irradiated with the electron flow 146 which tends to travel straight can be made greater than if the electron flow 146 is spread under the electrostatic field, allowing the light source 10G to produce a persistent phosphor emission highly efficiently.

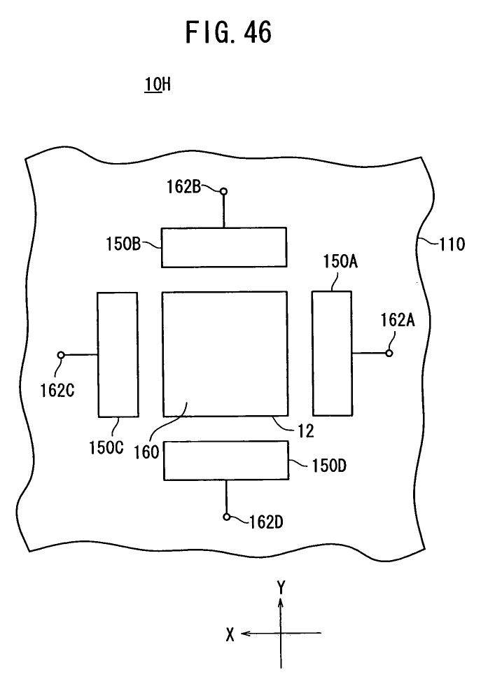

As shown in FIG. 46, a light source 10H according to an eighth embodiment of the present invention, which is of essentially the same structure as the light source 10E according to the fifth embodiment described above, differs in that the light source 10H has four spreading electrodes, i.e., first, second, third, and fourth spreading electrodes 150A through 150D, disposed around the electron emitter 12. In FIG. 46, the electron emission surface 160 of the electron emitter 12 has a substantially square outer profile, and the first, second, third, and fourth spreading electrodes 150A through 150D are spaced outwardly from and disposed in facing relation to the respective four sides of the electron emitter 12.

When voltages are applied to the respective first, second, third, and fourth spreading electrodes 150A through 150D through respective terminals, i.e., first, second, third, and fourth terminals 162A through 162D thereof, the electron flow 146 (see FIG. 43) can be deflected in any desired directions for thereby controlling the irradiated area 164 of the metal back layer 152 in any directions on an XY plane.

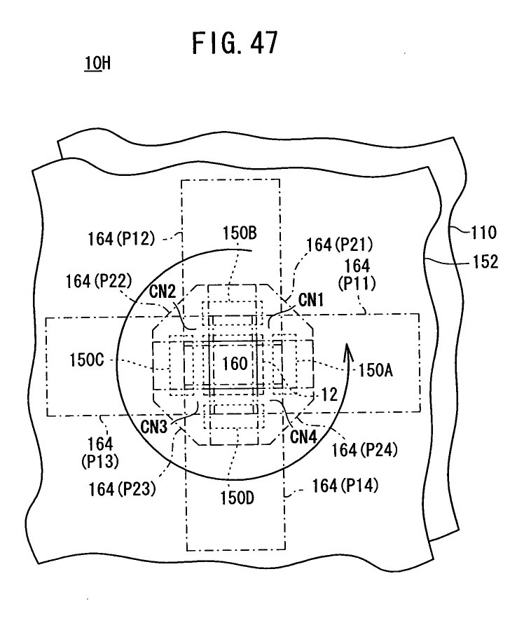

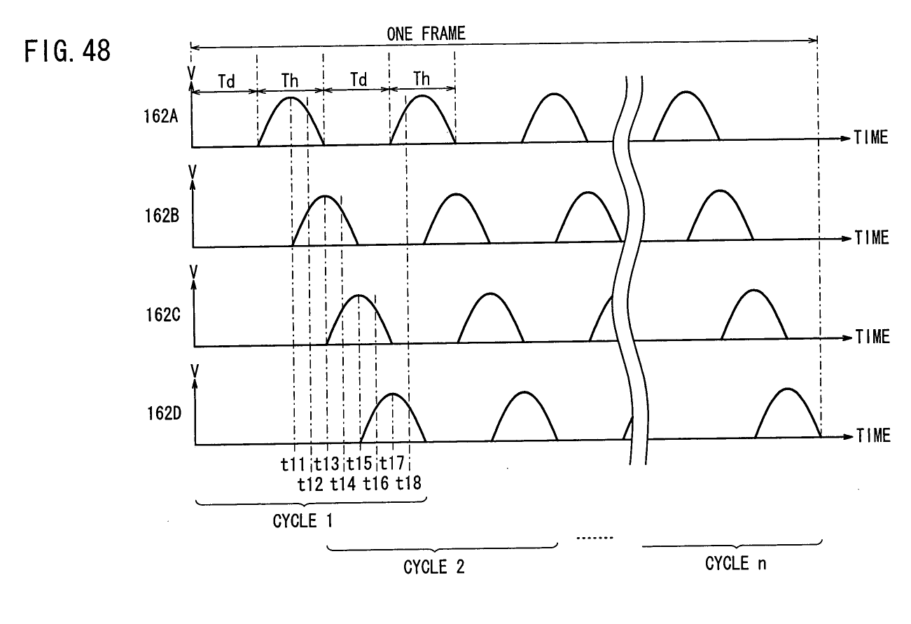

A process (first process) for deflecting the electron flow 146 with voltages applied to the first, second, third, and fourth spreading electrodes 150A through 150D will be described below with reference to FIGS. 47 and 48.

According to this process, one cycle is established, and one deflective scanning sequence is finished in the cycle. For example, as shown in FIG. 47, the deflective scanning sequence is an annular deflective scanning sequence for controlling the irradiated area 164 on the metal back layer 152 to successively scan a position P11 close to the first spreading electrode 150A, a position P12 close to the second spreading electrode 150B, a position P13 close to the third spreading electrode 150C, and a position P14 close to the fourth spreading electrode 150D, after which the position P11 close to the first spreading electrode 150A is scanned.

The above annular deflective scanning sequence is achieved by applying positive high-frequency signal waves (convex signal waves) Seh with respective time delays to the respective first, second, third, and fourth terminals 162A through 162D, as shown in FIG. 48. For example, at a time t11 when the positive signal wave Seh applied to the first terminal 162A is of a maximum level, the positive signal wave Seh starts being applied to the second terminal 162B. At a time t13 when the positive signal wave Seh applied to the second terminal 162B is of a maximum level, the positive signal wave Seh starts being applied to the third terminal 162C. At a time t15 when the positive signal wave Seh applied to the third terminal 162C is of a maximum level, the positive signal wave Seh starts being applied to the fourth terminal 162D.

As a result, as shown in FIG. 47, at the time t11, the irradiated area 164 is in the position P11 closest to the first spreading electrode 150A. At a time t12 when the voltage applied to the first terminal 162A is substantially the same as the voltage applied to the second terminal 162B, the irradiated area 164 is in a position P21 between the first spreading electrode 150A and the second spreading electrode 150B, i.e., a position corresponding to a corner CN1 of the electron emission surface 160.

Similarly, at the time t13, the irradiated area 164 is in the position P12 closest to the second spreading electrode 150B. At a time t14 when the voltage applied to the second terminal 162B is substantially the same as the voltage applied to the third terminal 162C, the irradiated area 164 is in a position P22 between the second spreading electrode 150B and the third spreading electrode 150C, i.e., a position corresponding to a corner CN2 of the electron emission surface 160.

At the time t15, the irradiated area 164 is in the position P13 closest to the third spreading electrode 150C. At a time t16, the irradiated area 164 is in a position P23 between the third spreading electrode 150C and the fourth spreading electrode 150D, i.e., a position corresponding to a corner CN3 of the electron emission surface 160. At a time t17, the irradiated area 164 is in the position P14 closest to the fourth spreading electrode 150D. At a time t18, the irradiated area 164 is in a position P24 between the fourth spreading electrode 150D and the first spreading electrode 150A, i.e., a position corresponding to a corner CN4 of the electron emission surface 160.

As shown in FIG. 23, the electron flow 146 is emitted from the electron emitter 12 in electron emission periods Th in one frame. As shown in FIG. 48, one frame is divided into a plurality cycles, i.e., cycle 1, cycle 2, . . . , and cycle n (adjacent cycles overlap each other to effectively use time in FIG. 48), and the above annular deflective scanning sequence is performed in each of the cycles. Therefore, a plurality of annular deflective scanning sequences are carried out in one frame for making substantially constant the amount of electrons applied to the phosphor layer 44.

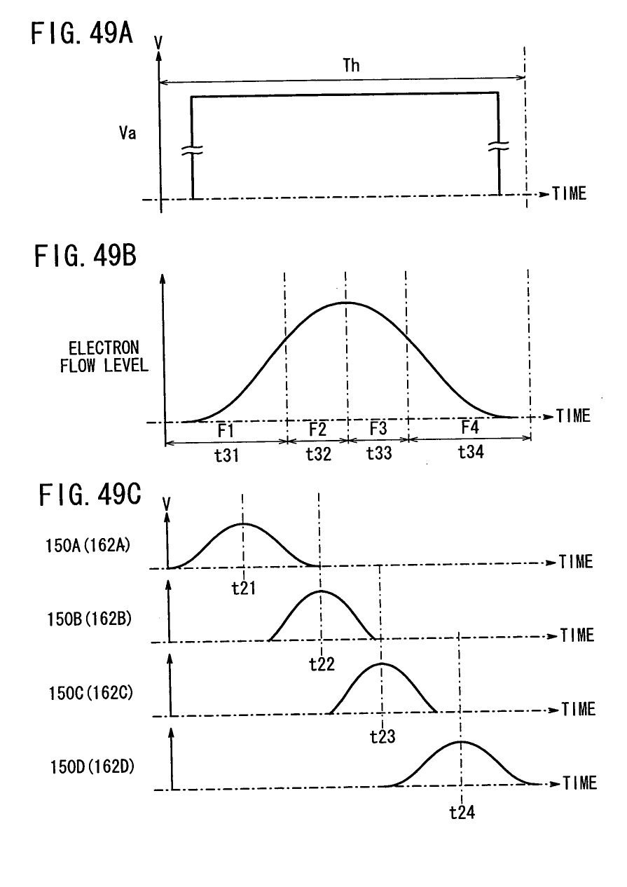

Another process (second process) for deflecting the electron flow 146 with voltages applied to the first, second, third, and fourth spreading electrodes 150A through 150D will be described below with reference to FIGS. 47 and 49A through 49C.

As shown in FIGS. 49A and 49B, the level of the electron flow emitted from the electron emitter 12 changes with time in one electron emission period Th. In FIG. 49B, the level of the electron flow gradually increases with time, and then gradually decreases with time after it has reached a peak level.

According to the second process, the speed at which the electron flow 146 is deflected is controlled depending on the level of the electron flow so that the amount of electrons applied to the phosphor layer 44 by the deflected electron flow 146 is made constant.

For example, the distribution waveform of the level of the electron flow shown in FIG. 49B is divided into as many waveform regions F1 through F4 (four regions in FIG. 49B) as the number of the first, second, third, and fourth spreading electrodes 150A through 150D. The first waveform region F1 is assigned to the first spreading electrode 150A, the second waveform region F2 to the second spreading electrode 150B, the third waveform region F3 to the third spreading electrode 150C, and the fourth waveform region F4 to the fourth spreading electrode 150D. The times at which the distribution waveform is divided are determined so that the waveform regions F1 through F4 have substantially the same integration value.

As shown in FIGS. 49B and 49C, the high-frequency signal Seh applied to the first spreading electrode 150A has a maximum level at a time t21 corresponding to a time t31 at the center of the first waveform region F1. The high-frequency signal Seh applied to the second spreading electrode 150B has a maximum level at a time t22 corresponding to a time t32 at the center of the second waveform region F2. The high-frequency signal Seh applied to the third spreading electrode 150C has a maximum level at a time t23 corresponding to a time t33 at the center of the third waveform region F3. The high-frequency signal Seh applied to the fourth spreading electrode 150D has a maximum level at a time t24 corresponding to a time t34 at the center of the fourth waveform region F4.

The timing for applying the high-frequency signal Seh to the first through fourth spreading electrodes 150A through 150D is thus controlled depending on the level of the electron flow for thereby making constant the amount of electrons applied from the deflected electron flow 146 to the phosphor layer 44.

According to the above second process, one electron emission period Th is divided into four regions. However, as with the first process, one electron emission period Th may be divided into a plurality of cycles, and the timing for applying the high-frequency signal Seh to the first through fourth spreading electrodes 150A through 150D in each of the cycles may be controlled depending on the level of the electron flow for thereby making constant the amount of electrons applied from the deflected electron flow 146 to the phosphor layer 44.

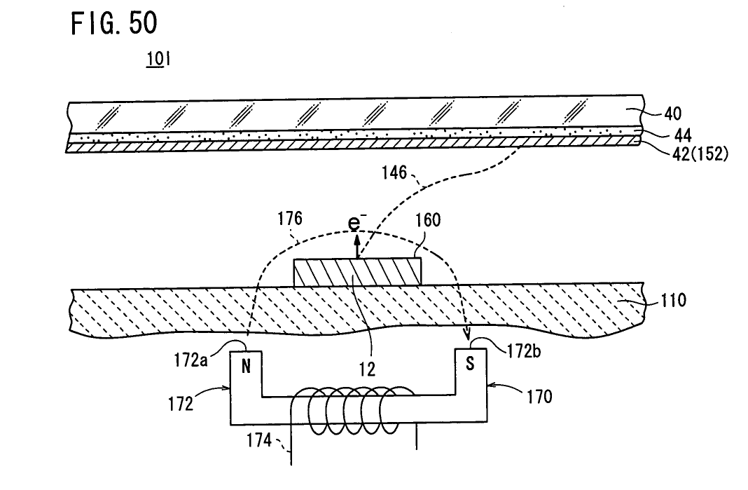

As shown in FIG. 50, a light source 10I according to a ninth embodiment of the present invention is of essentially the same structure as the light source 10E according to the fifth embodiment described above, except that the light source 10I has a magnetic field generator 170 disposed underneath the electron emitter 12, instead of the first and second spreading electrodes 150A, 150B.

The magnetic field generator 170 comprises a coil 174 wound around a substantially C-shaped core 172. The polarities appearing at the ends of the core 172 are changed depending on the direction in which a current flows through the coil 174. In FIG. 50, a current flows in one direction through the coil 174 to produce an N pole at the left end, i.e., a first core portion 172a, of the core 172 and an S pole at the right end, i.e., a second core portion 172b, of the core 172. The electron flow 146 emitted from the electron emitter 12 is deflected under the Lorentz force by a line 176 of magnetic forces extending from the N pole to the S pole. At this time, electrons immediately after they are emitted from the electron emission surface 160 are deflected most strongly as they tend to travel in a direction substantially perpendicular to the line 176 of magnetic forces. Specifically, since the Lorentz force is generated depending on the velocity component of electrons that are oriented in a direction (hereinafter referred to as “vertical direction”) from the electron emission surface 160 toward the metal back layer 152, the Lorentz force acts most strongly on the electrons when the electrons tend to travel in the direction perpendicular to the line 176 of magnetic forces. Therefore, those electrons are deflected greatly.

Consequently, when the direction of the magnetic field generated by the magnetic field generator 170 is changed with time, the trajectory of the electron flow 146 emitted from the electron emitter 12 can continuously be changed. The magnetic field generator 170 thus functions as a means for deflecting the trajectory of the electron flow 146, i.e., a deflector.

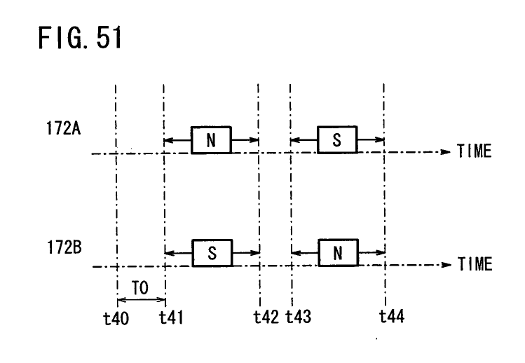

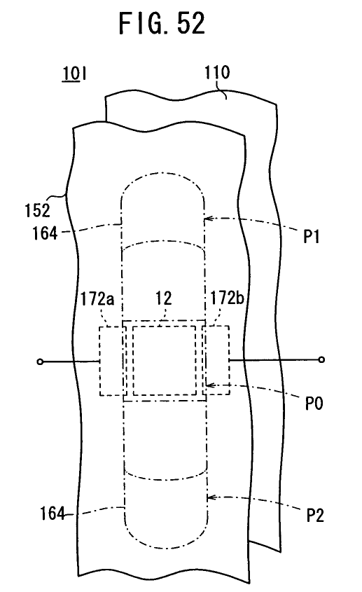

An example in which the electron flow 146 is deflected will be described below with reference to FIGS. 51 and 52. In an interval from a time t40 to a time t41 shown in FIG. 51, the magnetic field generator 170 generates no magnetic field, and the electron flow 146 is not deflected and travels straight toward the metal back layer 152, irradiating the position P0 on the metal back layer 152, as shown in FIG. 52. Thereafter, in an interval from the time t41 to a time t42 shown in FIG. 51, the coil 174 is supplied with a current flowing in one direction, developing the N pole at the first core portion 172a and the S pole at the second core portion 172b. The electron flow 146 is deflected in one direction, irradiating the position P1 on the metal back layer 152, as shown in FIG. 52. Then, in an interval from the time t42 to a time t43, the coil 174 is supplied with no current, and the electron flow 146 is not deflected and travels straight toward the metal back layer 152, irradiating the position P0 on the metal back layer 152, as shown in FIG. 52. Thereafter, in an interval from the time t43 to a time t44, the coil 174 is supplied with a current flowing in the opposite direction, developing the S pole at the first core portion 172a and the N pole at the second core portion 172b. The electron flow 146 is deflected in the opposite direction, irradiating the position P2 on the metal back layer 152, as shown in FIG. 52.

The above process is repeated to cause the position on the metal back layer 152 which is irradiated with the electron flow 146 to reciprocate between the position P1 and the position P2 across the position P0.

The size of the irradiated area 164 can be changed depending on the gap of the core 172, i.e., the distance between the first core portion 172a and the second core portion 172b, the intensity of the magnetic field, the configuration of the space in which the magnetic field is applied, etc. The amount of deflection of the electron flow 146 can be controlled depending on whether the magnetic field generator 170 generates a magnetic field or not, the orientation of the generated magnetic field, and the intensity of the magnetic field.

With the light source 10I according to the ninth embodiment, since the trajectory of the electron flow 146 is deflected by the magnetic field, the irradiated area 164 on the metal back layer 152 can be two-dimensionally scanned. Since the light source 10I does not require a high voltage for deflecting the electron flow 146 unlike the arrangement for deflecting the electron flow 146 under an electric field, the light source 10I may have a less costly control circuit. Furthermore, the area that is irradiated with the electron flow 146 which tends to travel straight can be made greater than if the electron flow 146 is spread under the electrostatic field, allowing the light source 10I to produce a persistent phosphor emission highly efficiently.

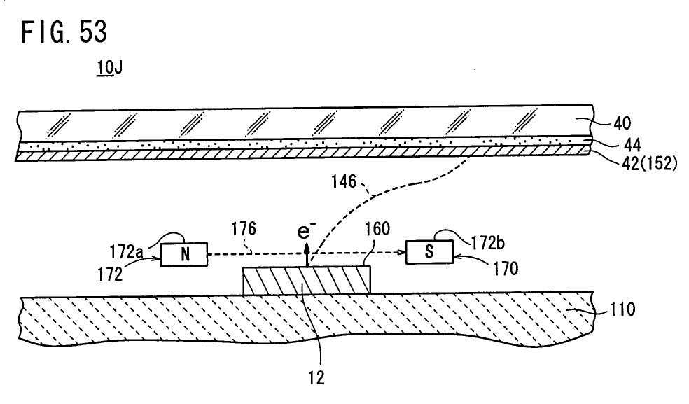

As shown in FIG. 53, a light source 10J according to a tenth embodiment of the present invention is of essentially the same structure as the light source 10I according to the ninth embodiment described above, except that the magnetic field generator 170 is disposed between the fixed substrate 110 and the transparent substrate 40 and closely to the electron emitter 12.

With the light source 10J, the magnetic field generated by the magnetic field generator 170 is not interrupted by the fixed substrate 110 or the like, but acts directly on the electron flow 146 for easily controlling the amount of deflection of the electron flow 146.

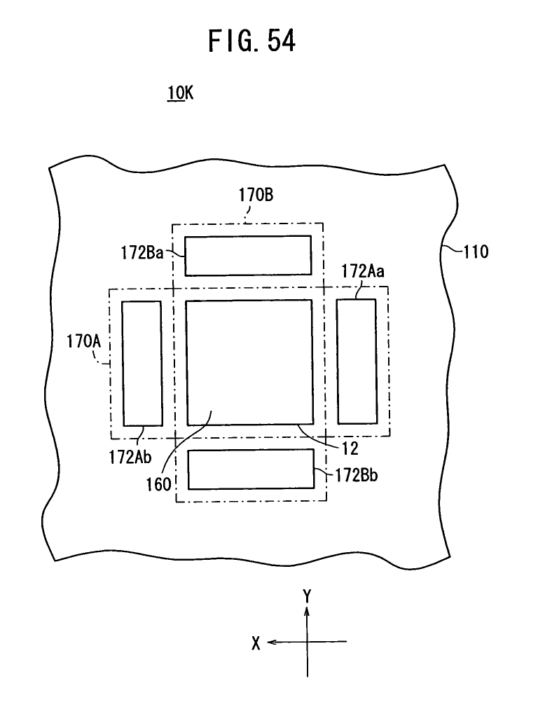

As shown in FIG. 54, a light source 10K according to an eleventh embodiment of the present invention is of essentially the same structure as the light source 10I according to the ninth embodiment described above, except that the light source 10K has two magnetic field generators, i.e., a first magnetic field generator 170A and a second magnetic field generator 170B, arranged such that their gaps are oriented perpendicularly to each other. In FIG. 54, the first magnetic field generator 170A has a first core portion 172Aa and a second core portion 172Ab which are arrayed in the direction indicated by the arrow X, and the second magnetic field generator 170B has a first core portion 172Ba and a second core portion 172Bb which are arrayed in the direction indicated by the arrow Y. The electron emitter 12 is disposed in an area surrounded by the core portions 172Aa, 172Ab, 172Ba, 172Bb.

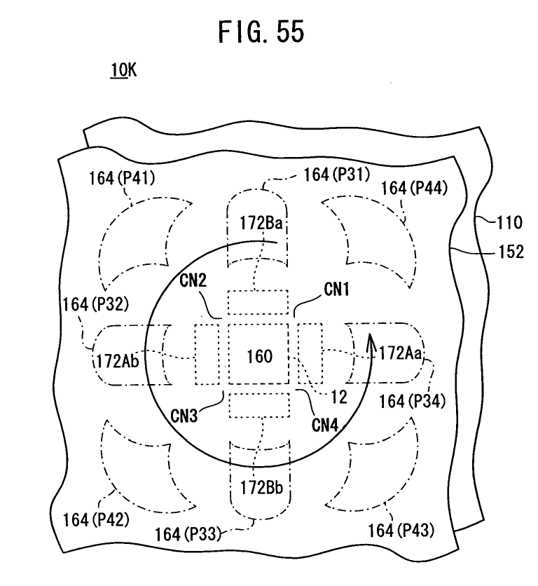

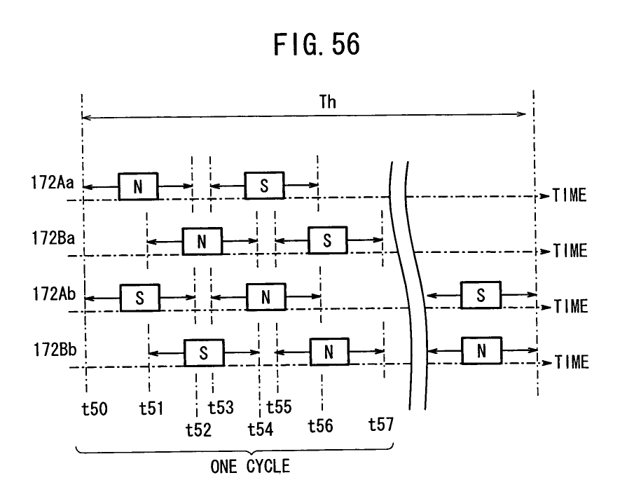

A process of deflecting the electron flow 146 with a combination of the polarities of the core portions 172Aa, 172Ab, 172Ba, 172Bb will be described below with reference to FIGS. 55 and 56.

According to this process, one cycle is established, and one deflective scanning sequence is finished in the cycle. For example, as shown in FIG. 55, the deflective scanning sequence is an annular deflective scanning sequence for controlling the irradiated area 164 on the metal back layer 152 to successively scan a position P31 close to the first core portion 172Ba of the second magnetic field generator 170B, a position P32 close to the second core portion 172Ab of the first magnetic field generator 170A, a position P33 close to the second core portion 172Bb of the second magnetic field generator 170B, and a position P34 close to the first core portion 172Aa of the first magnetic field generator 170A, after which the position P31 close to the first core portion 172Ba of the second magnetic field generator 170B is scanned.

As shown in FIG., 56, the above annular deflective scanning sequence is achieved by developing polarities (e.g., N poles) with respective time delays at the first core portion 172Aa of the first magnetic field generator 170A, the first core portion 172Ba of the second magnetic field generator 170B, the second core portion 172Ab of the first magnetic field generator 170A, and the second core portion 172Bb of the second magnetic field generator 170B.

For example, in an interval from a time t50 to a time t52, the N pole is developed at the first core portion 172Aa of the first magnetic field generator 170A and the S pole is developed at the second core portion 172Ab of the first magnetic field generator 170A. In an interval from a time t51, which occurs between the time t50 and the time t52, to a time t54, the N pole is developed at the first core portion 172Ba of the second magnetic field generator 170B, and the S pole is developed at the second core portion 172Bb of the second magnetic field generator 170B. In an interval from the time t52 to a time t53, the coil of the first magnetic field generator 170A is de-energized. Thereafter, in an interval from the time t53 to a time t56, the S pole is developed at the first core portion 172Aa of the first magnetic field generator 170A and the N pole is developed at the second core portion 172Ab of the first magnetic field generator 170A. Similarly, in an interval from the time t54 to a time t55, the coil of the second magnetic field generator 170B is de-energized. Thereafter, in an interval from the time t55 to a time t57, the S pole is developed at the first core portion 172Ba of the second magnetic field generator 170B, and the N pole is developed at the second core portion 172Bb of the second magnetic field generator 170B.

As a result, as shown in FIG. 55, in the interval from the time t50 to the time t51, the irradiated area 164 is in the position P31 closest to the first core portion 172Ba. In the interval from the time t51 to the time t52, the irradiated area 164 is in a position P41 between the first core portion 172Ba and the second core portion 172Ab, i.e., a position corresponding to the corner CN2 of the electron emission surface 160. In the interval from the time t52 to the time t53, the irradiated area 164 is in the position P32 closest to the second core portion 172Ab. In the interval from the time t53 to the time t54, the irradiated area 164 is in a position P42 between the second core portion 172Ab and the second core portion 172Bb, i.e., a position corresponding to the corner CN3 of the electron emission surface 160.

Similarly, in the interval from the time t54 to the time t55, the irradiated area 164 is in the position P33 closest to the second core portion 172Bb. In the interval from the time t55 to the time t56, the irradiated area 164 is in a position P43 between the second core portion 172Bb and the first core portion 172Aa, i.e., a position corresponding to the corner CN4 of the electron emission surface 160. In the interval from the time t56 to the time t57, the irradiated area 164 is in the position P34 closest to the first core portion 172Aa.

As shown in FIG. 23, the electron flow 146 is emitted from the electron emitter 12 in an electron emission period Th in one frame. The electron emission period Th is divided into a plurality cycles, and the above annular deflective scanning sequence is performed in each of the cycles. Therefore, a plurality of annular deflective scanning sequences are carried out in one electron emission period Th for making substantially constant the amount of electrons applied to the phosphor layer 44.

In the eleventh embodiment, the polarities may be combined according to a process similar to the second process described above (see FIGS. 49A through 49C).

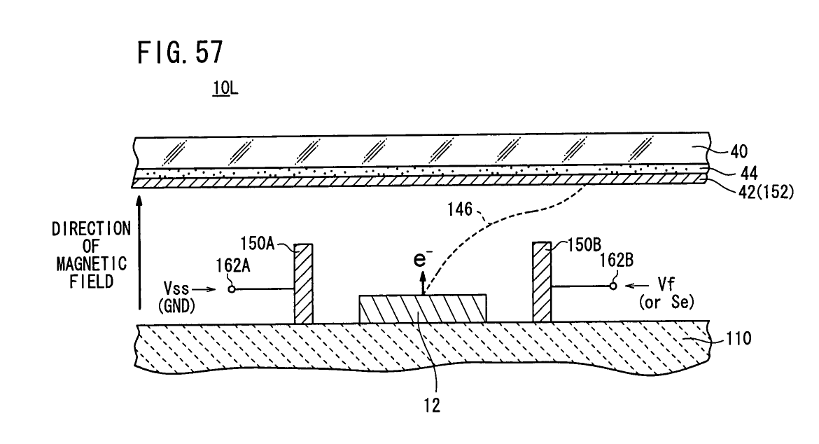

As shown in FIG. 57, a light source 10L according to a twelfth embodiment of the present invention is of essentially the same structure as the light source 10G according to the seventh embodiment described above, except that a magnetic field generator (not shown in FIG. 57) generates a magnetic field oriented from the fixed substrate 110 toward the transparent substrate 40.

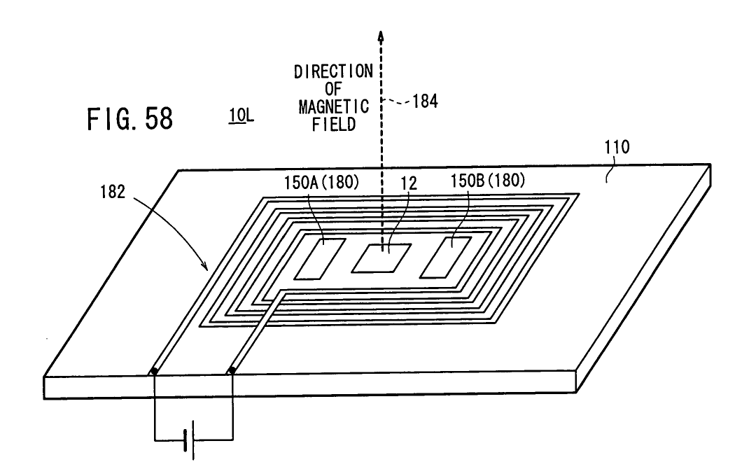

As shown in FIG. 58, the electron emitter 12 is mounted on the fixed substrate 110 and surrounded by electrode films 180 serving as the first spreading electrode 150A and the second spreading electrode 150B for deflecting the electron flow 146. The electron emitter 12 and the electrode films 180 are surrounded by a coil pattern 182 for generating a magnetic field. The coil pattern 182 is formed on the fixed substrate 110 by printing, for example.

When a current flows through the coil pattern 182, it generates an upward magnetic field 184 extending through the electron emitter 12 and the electrode films 180, i.e., extending from the fixed substrate 110 toward the transparent substrate 40.

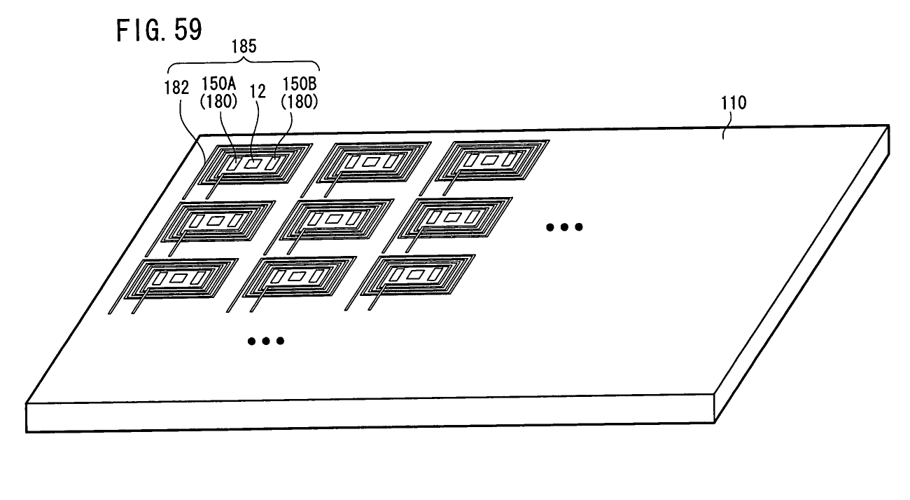

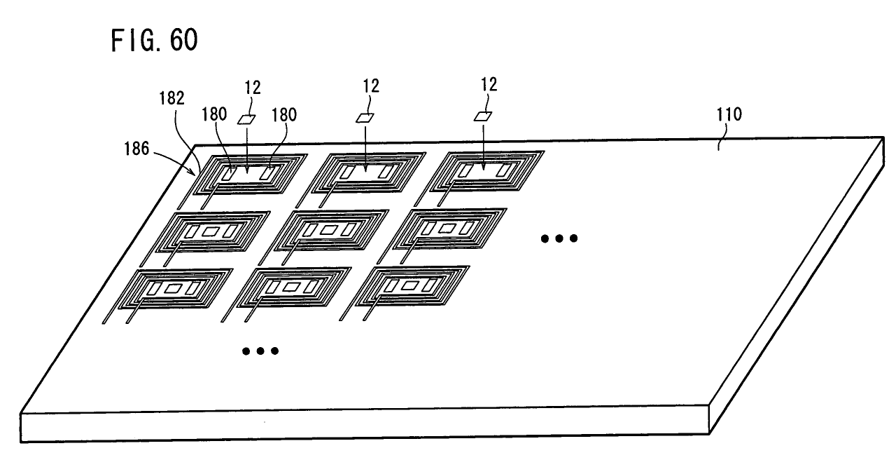

FIG. 59 shows an array of units 185 each comprising the electron emitter 12, the electrode films 180, and the coil pattern 182. The electron emitters 12, the electrode films 180, and the coil patterns 182 of the units 185 are preferably formed on one ceramic substrate by thick-film printing. Alternatively, as shown in FIG. 60, the electrode films 180 and the coil patterns 182 may first be formed on the fixed substrate 110, and then the electron emitters 12 may be mounted on the fixed substrate 110, using the electrode films 180 and the coil patterns 182 as an alignment mark 186.

The light source 10L according to the twelfth embodiment is capable of deflecting the electron flow 146 with a combination of an electric field that is generated by the first spreading electrode 150A and the second spreading electrode 150B and an upward magnetic field that is generated by the unillustrated magnetic field generator, i.e., the coil pattern 182 shown in FIG. 58.

For example, a ground potential Vss is applied to the first spreading electrode 150A, and a constant positive voltage Vf is applied to the second spreading electrode 150B to give a horizontal velocity component to the electron flow 146. The electron flow 146 is deflected under a force due to a magnetic field depending on the horizontal velocity component, and travels toward the metal back layer 152 while in spiral motion. In this manner, the electron flow 146 is applied to a wide area of the metal back layer 152 to enable the phosphor layer 44 to emit light highly efficiently based on its persistent phosphor emission. Since no high voltage is required to spread the electron flow 146, the light source 10L may have a less costly control circuit.

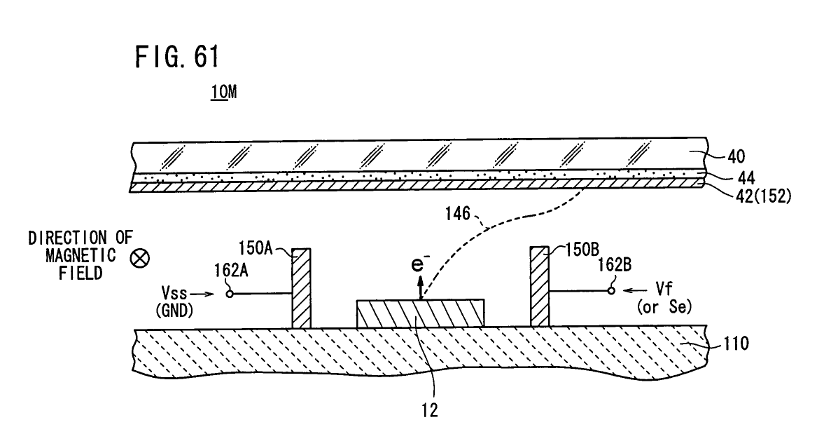

As shown in FIG. 61, a light source 10M according to a thirteenth embodiment of the present invention is of essentially the same structure as the light source 10L according to the twelfth embodiment described above, except that a magnetic field generator (not shown in FIG. 61) generates a horizontal magnetic field.

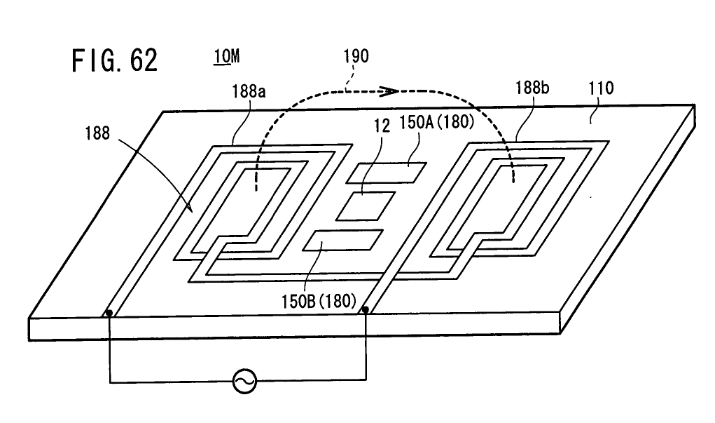

Specifically, as shown in FIG. 62, the electron emitter 12 is mounted on the fixed substrate 110 and surrounded by electrode films 180 serving as the first spreading electrode 150A and the second spreading electrode 150B for deflecting the electron flow 146. The electron emitter 12 and the electrode films 180 are surrounded by a coil pattern 188 for generating a magnetic field. The coil pattern 188 is formed on the fixed substrate 110 by printing, for example. The coil pattern 188 has a first coil pattern portion 188a disposed on the left side of the electron emitter 12 and the electrode films 180 and wound in one direction, and a second coil pattern portion 188b disposed on the right side of the electron emitter 12 and the electrode films 180 and wound in the opposite direction.

When a current flows through the coil pattern 188, it generates a magnetic field 190 extending from the first coil pattern portion 188a toward the second coil pattern portion 188b, for example. The magnetic field 190 is applied as a horizontal magnetic field to the electron emitter 12 and the electrode films 180.

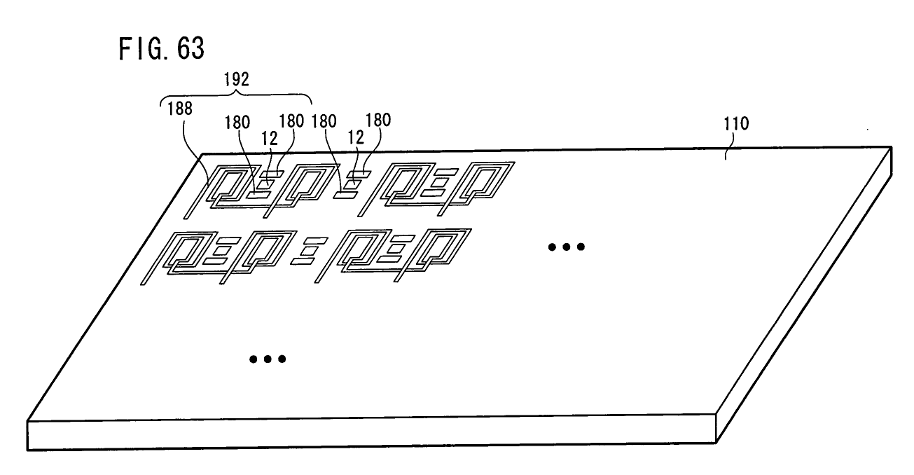

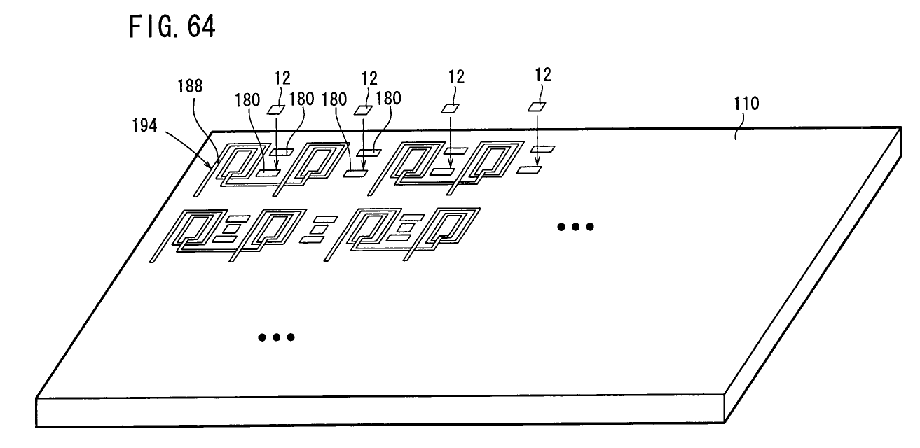

FIG. 63 shows an array of units 192 each comprising the electron emitter 12, the electrode films 180, and the coil pattern 188. The electron emitters 12, the electrode films 180, and the coil patterns 188 of the units 192 are preferably formed on one ceramic substrate by thick-film printing. In FIG. 63, the electron emitters 12 and the electrode films 180 are highly integrated on the fixed substrate 110 because sets of electron emitters 12 and electrode films 180 are also disposed between the units 192. Alternatively, as shown in FIG. 64, the electrode films 180 and the coil patterns 188 may first be formed on the fixed substrate 110, and then the electron emitters 12 may be mounted on the fixed substrate 110, using the electrode films 180 and the coil patterns 188 as an alignment mark 194.

The light source 10M according to the thirteenth embodiment is capable of deflecting the electron flow 146 with a combination of an electric field that is generated by the first spreading electrode 150A and the second spreading electrode 150B and a horizontal magnetic field 190 that is generated by the unillustrated magnetic field generator, i.e., the coil pattern 188 shown in FIG. 62.

For example, a ground potential Vss is applied to the first spreading electrode 150A, and a constant positive voltage Vf is applied to the second spreading electrode 150B to give a horizontal velocity component to the electron flow 146. The electron flow 146 is accelerated by the vertical electric field and is deflected under a force proportional to the vertical velocity component. Inasmuch as the advantages of the deflection under the electric field and the deflection under the magnetic field are combined, the amount of deflection of the electron flow 146 is increased.

As shown in FIGS. 58 and 62, the electrode films 180 and the coil pattern 182 or 188 that are disposed on the fixed substrate offer the following advantages:

For deflecting the trajectory of the electron flow 146 emitted from the electron emitter 12, it is necessary that the generator for generating an electric field and/or a magnetic field and the electron emitter 12 be positioned highly accurately with respect to each other. Since the electrode films 180 and the coil pattern 182 or 188 can be formed on the fixed substrate 110 based on the same reference positions by screen printing, for example, they can be positioned highly accurately with respect to the electron emitter 12 inexpensively and highly accurately, as shown in FIGS. 58 and 62.

Furthermore, as shown in FIGS. 60 and 64, the electron emitters 12 are mounted on the fixed substrate 110, using the electrode films 180 and the coil pattern 182 or 188 on the fixed substrate 110 as the alignment mark 186 or 194. Consequently, the electrode films 180 and the coil pattern 182 or 188 can be positioned with respect to the electron emitter 12 more highly accurately.

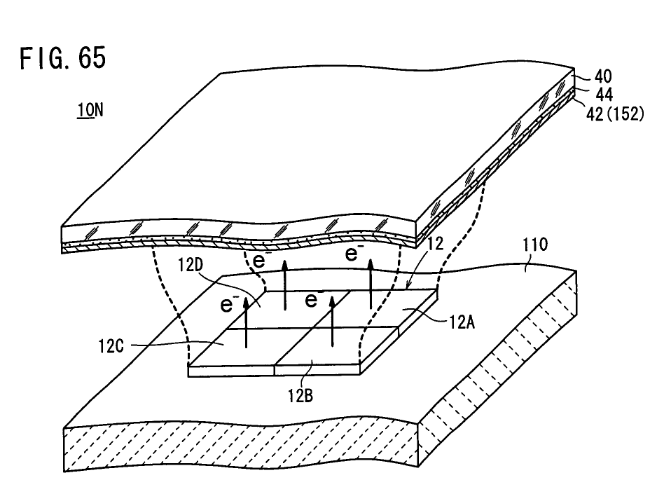

As shown in FIG. 65, a light source 10N according to a fourteenth embodiment of the present invention has a plurality of electron emitters 12A through 12D which are energized according to a time-division drive process so as to operate as a single electron emitter 12.

In the light source 10N, pulsed electron flows 146 from the respective electron emitters 12A through 12D are applied to the same area of the metal back layer 152. However, the pulsed electron flows 146 for irradiating the same area of the metal back layer 152 are emitted at different times from the respective electron emitters 12A through 12D.

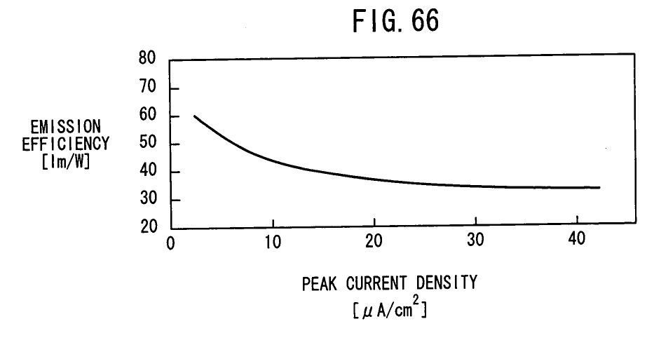

A study of the emission efficiency of a phosphor has indicated that, as shown in FIG. 66, the emission efficiency is higher as the amount of electrons applied to the phosphor, i.e., a peak current density, is smaller.

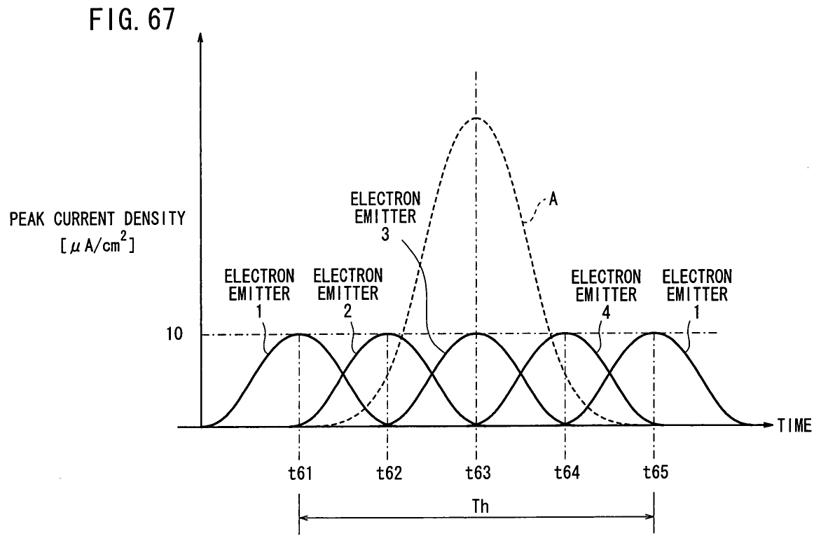

For increasing the emission luminance, it is customary to increase the amount of electrons emitted from each electron emitter 12, and to apply a single pulsed electron flow 146 to the phosphor within a constant electron emission period Th, as indicated by the broken-line curve A in FIG. 67.

However, the peak current density of the pulsed electron flow 146 as represented by the broken-line curve A is so high that the emission efficiency is low as shown in FIG. 66. Furthermore, because the phosphor layer 44 is irradiated with the electron flow 146 throughout the electron emission period Th, the persistent phosphor emission of the phosphor layer 44 is not effectively utilized.

In view of this, in FIG. 65, four electron emitters, i.e., first, second, third, and fourth electron emitters 12A through 12D, are arranged in a matrix of two rows and two columns and combined into one unit, i.e., an electron emitter 12, and these first, second, third, and fourth electron emitters 12A through 12D are energized according to a time-division drive process. Specifically, the first electron emitter 12A outputs a peak current density at a time t61, and the second electron emitter 12B outputs a peak current density at a time t62 upon elapse of a quarter (Th/4) of the electron emission period Th. Thereafter, the third electron emitter 12C outputs a peak current density at a time t63 upon elapse of another quarter (Th/4) of the electron emission period Th. The fourth electron emitter 12D outputs a peak current density at a time t64 upon elapse of still another quarter (Th/4) of the electron emission period Th.

In this manner, the peak current densities of the first, second, third, and fourth electron emitters 12A through 12D are reduced to one quarter of the peak current density indicated by the broken-line curve A of the single electron emitter 12. For example, the peak current densities of the first, second, third, and fourth electron emitters 12A through 12D may be reduced to 10 μA/cm² or less, or 5 μA/cm² or less, for achieving an emission efficiency of 50 lm/W or higher.

By thus successively superposing the pulsed electron flows 146 of the low peak current densities emitted from the respective electron emitters 12, it is possible to obtain a necessary electron flow level for achieving both higher luminance and higher efficiency.

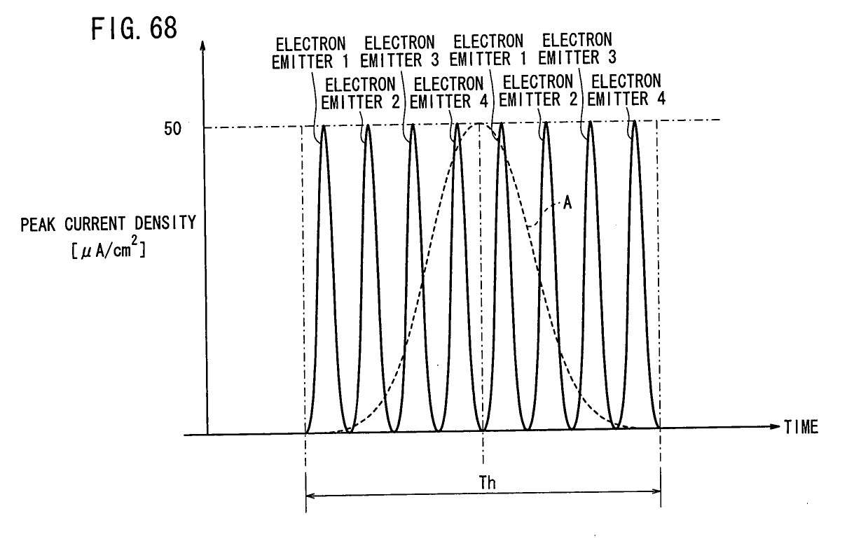

As shown in FIG. 68, it is also preferable to energize the first, second, third, and fourth electron emitters 12A through 12D to emit respective electron flow pulses 146 having a high peak current density of 50 μA/cm² in very short time durations at a high frequency.

According to the drive process shown in FIG. 68, a period in which the peak current density is essentially zero is introduced between two adjacent electron flow pulses 146 for effectively utilizing the persistent phosphor emission produced by each electron flow pulse 146. The light source is then capable of emitting light highly efficiently based on the persistent phosphor emission.

Because the electron flow pulses 146 are produced in a time-division fashion from the respective electron emitters 12, the drive frequency of each of the electron emitters is not unnecessarily increased. Consequently, the service life of each of the electron emitters 12 is not unduly reduced.

Since the same area of the phosphor layer 44 is excited by the electron flow pulses 146 that are emitted in a time-division fashion from the respective electron emitters 12, a necessary electron flow level can be achieved for both higher luminance and higher efficiency.

The principles of the light source 10N according to the fourteenth embodiment are also applicable to the light sources 10A through 10M according to the first through thirteenth embodiments described above.

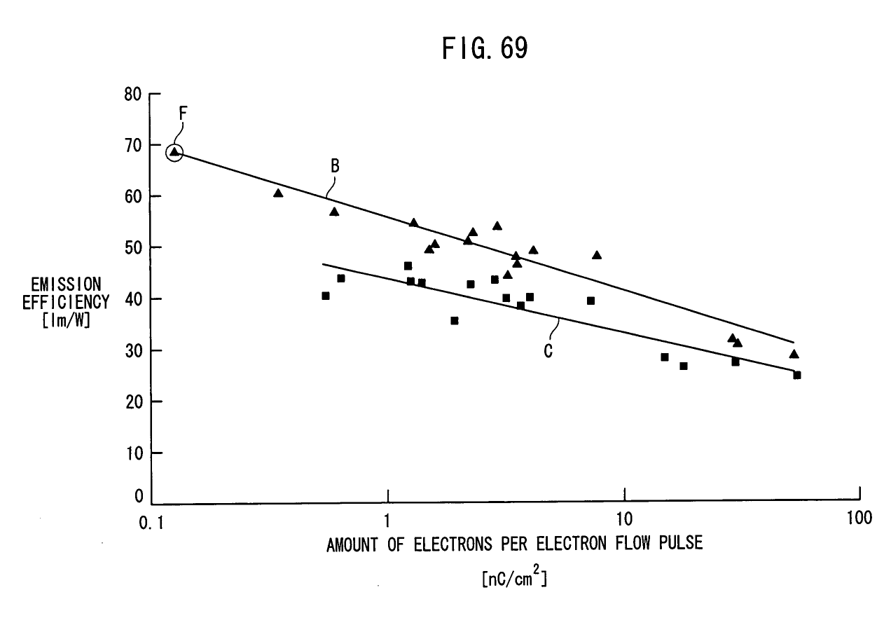

Other embodiments of the present invention which are effective to increase the emission efficiency of a phosphor will be described below with reference to FIGS. 69 through 74.

A study of the emission efficiency of a phosphor has indicated that, as shown in FIG. 69, the emission efficiency is higher as the amount of electrons by a single electron flow pulse applied to the phosphor is smaller, and the bias voltage Vc applied to the anode electrode 42 is higher. In FIG. 69, a straight line B plotted by triangular marks represents a characteristic line when the bias voltage Vc applied to the anode electrode 42 is 14 kV, and a straight line C plotted by square marks represents a characteristic line when the bias voltage Vc applied to the anode electrode 42 is 14 kV.

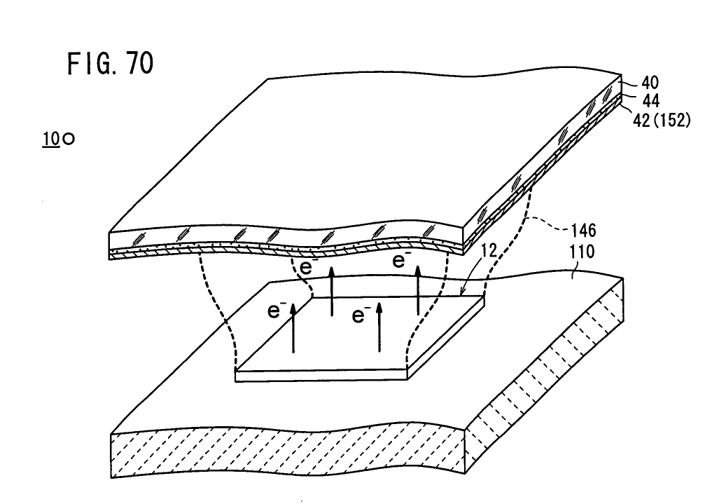

As shown in FIG. 70, a light source 10O according to a fifteenth embodiment of the present invention is of essentially the same structure as the light source 10N according to the fourteenth embodiment described above, except that a single electron emitter 12 is disposed in place of the four electron emitters 12A through 12D. According to the fifteenth embodiment, the electron emitter 12 is energized to emit electron flow pulses 146 at a high frequency of 14 kHz, for example.

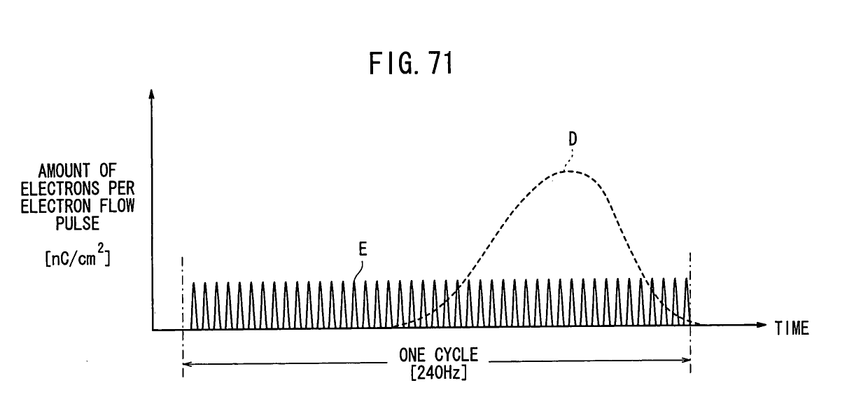

One frame is divided into four cycles, and operation of the light source 10O in one of the cycles (240 Hz, 4.1 msec.) will be described below with reference to FIG. 71. When a single electron flow pulse 146 is applied to the phosphor layer 44 in one cycle as indicated by the broken-line curve D in FIG. 71, the phosphor layer 44 has an emission efficiency of about 30 lm/w. When electron flow pulses 146 are applied at a frequency of 14 kHz to the phosphor layer 44 in one cycle as indicated by the solid-line curve E in FIG. 71, the phosphor layer 44 has an increased emission efficiency of about 70 lm/w, as indicated by a triangular mark F in FIG. 69. The increased emission efficiency is achieved because the amount of electrons of each electron flow pulse 146 is reduced to about 0.1 nC/cm². With the emission efficiency indicated by the triangular mark F, the light source 10O can achieve a luminance of 5000 cd/m² and can suitably be used as a light source for the back light of liquid crystal display units. A charge accumulation period Td is present between two adjacent output periods (electron emission periods Th) of electron flow pulses 146.

Therefore, the frequency of electron flow pulses 146 emitted from the single electron emitter 12 may be controlled to reduce the amount of electrons of each electron flow pulse 146 applied to the phosphor layer 44 to about 0.1 nC/cm² for thereby increasing the emission efficiency of the phosphor layer 44.

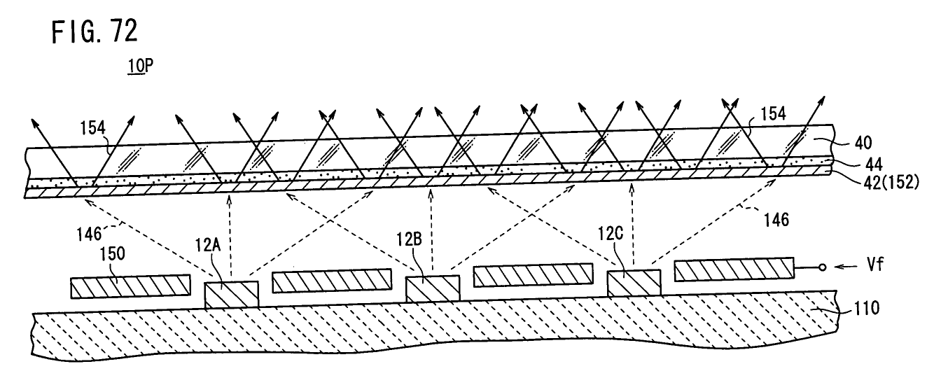

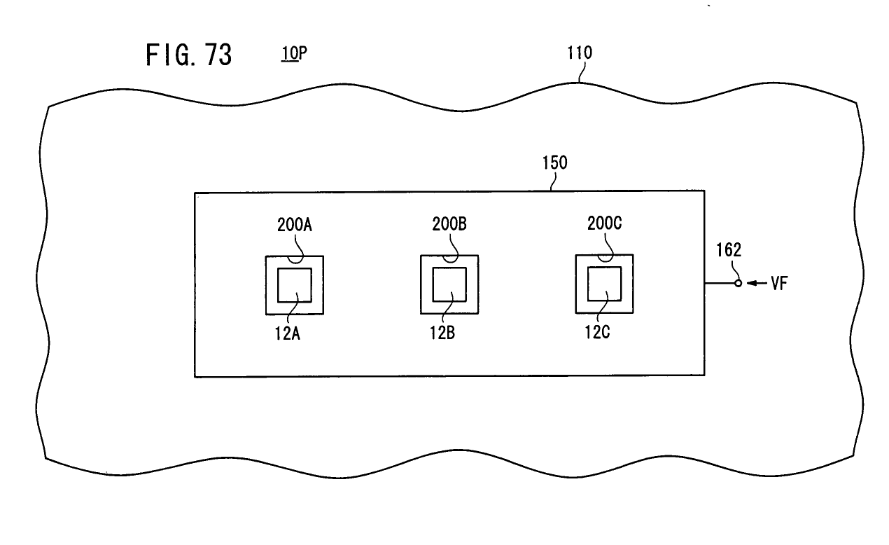

As shown in FIGS. 72 and 73, a light source 10P according to a sixteenth embodiment of the present invention is of essentially the same structure as the light source 10F (see FIG. 41) according to the sixth embodiment described above, except that one spreading electrode 150 is assigned to three electron emitters 12A through 12C. In FIGS. 72 and 73, the spreading electrode 150 is of an elongate rectangular shape having three spaced openings 200A through 200C aligned with and accommodating therein the electron emitters 12A through 12C, respectively, which are arranged in a straight array.

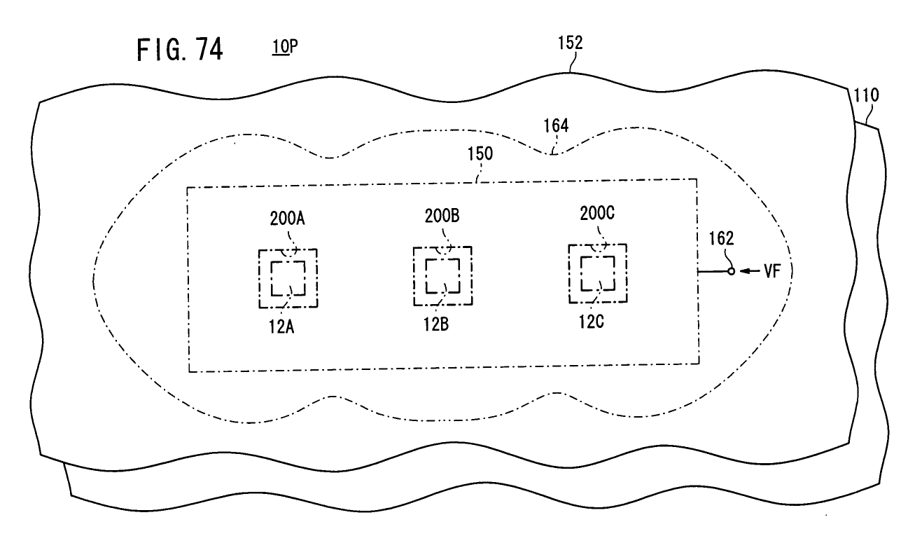

When a positive control voltage Vf is applied to the spreading electrode 150 through a terminal 162 thereof, it generates an electrostatic lens in the emission paths of the electron flows 146 for spreading the electron flows 146 from the electron emitters 12A through 12C. The electron flows 146 emitted from the electron emitters 12A through 12C toward the metal back layer 152 are abruptly spread by the electrostatic lens disposed in the emission paths of the electron flows 146, and then gradually spread as the electron flows 146 approach the metal back layer 152. As a result, as shown in FIG. 74, areas 164 of the metal back layer 152 which are irradiated with the respective electron flows 146 are enlarged in excess of the areas taken up by the electron emitters 12. The enlarged irradiated areas 164 are effective to prevent the phosphor layer 44 from being saturated, and the phosphor layer 44 is capable of emitting phosphorescent light from its irradiated surface highly efficiently through an increased area for a spread uniform surface emission.

An experimental example will be described below. The light source 10P according to the sixteenth embodiment was fabricated under the manufacturing conditions shown below, and the ratio at which the irradiated area 164 of the metal back layer 152 is enlarged was confirmed. A red phosphor P22-RE1 (manufactured by Kasei Optonix, Ltd.), a green phosphor P22-GN4 (manufactured by Kasei Optonix, Ltd.), and a blue phosphor LDP-B3 (manufactured by Kasei Optonix, Ltd.) were mixed at a weight ratio of 1:1:1 into a phosphor layer 44. The phosphor layer 44 had a thickness represented by 6 mg/cm², i.e., a weight per unit area. The metal back layer 152 had a thickness of 150 nm. The distance between the electron emitters 12A through 12C and the metal back layer 152 was 8 mm, and the distance between the electron emitters 12A through 12C and the spreading electrode 150 was 0.8 mm and 1.25 mm.

As a result, as shown in FIG. 74, the irradiated area 164 of the metal back layer 152 was about 30 times the area (2.5 mm×2.5 mm) taken up by the electron emitter 12.

The size of the irradiated area 164 can be changed by controlling the height of the spreading electrode 150, the width of the openings 200A through 200C in the spreading electrode 150, and the value of the control voltage Vf.

With the light source 10P according to the sixteenth embodiment, the electron flow pulses 146 emitted from the electron emitters 12A through 12C can be spread by the electric field that is generated by the spreading electrode 150, to reduce the amount of electrons of each electron flow pulse 146 applied to the phosphor layer 44 to about 0.1 nC/cm² for thereby increasing the emission efficiency of the phosphor layer 44.

Incidentally, the process of driving the light source 10O according to the fifteenth embodiment described above, i.e., the process of increasing the frequency of electron flow pulses 146 emitted from the single electron emitter 12, may be applied to the light sources 10A through 10N according to the first through fourteenth embodiments and the light source 10P according to the sixteenth embodiment. Since the electron emitters 12 are two-dimensionally scanned and the electron flow pulses 146 are emitted at a high frequency from the electron emitters 12, the advantages (the increased emission efficiency of the phosphor layer 44 due to the spreading of the electron flow pulses 146) of the light sources 10A through 10N according to the first through fourteenth embodiments and the light source 10P according to the sixteenth embodiment, and the advantages (the increased emission efficiency of the phosphor layer 44 due to the high-frequency emission of the electron flow pulses 146) of the light source 10O according to the fifteenth embodiment are combined to further increase the emission efficiency of the phosphor layer 44 (synergistic advantages).

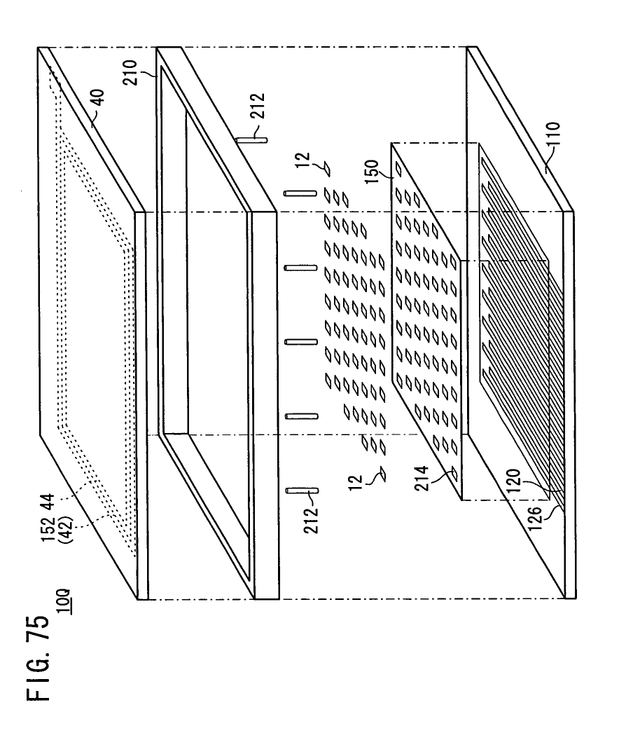

Though in the above embodiments, a plurality of electron emitters 12 are arranged in a matrix, the plurality of electron emitters 12 may be arranged in a staggered pattern, as in a light source 10Q according to a seventeenth embodiment of the present invention shown in FIGS. 75 to 77.

The arrangement of the light source 10Q according to the seventeenth embodiment will be described below with reference to FIGS. 75 to 77.

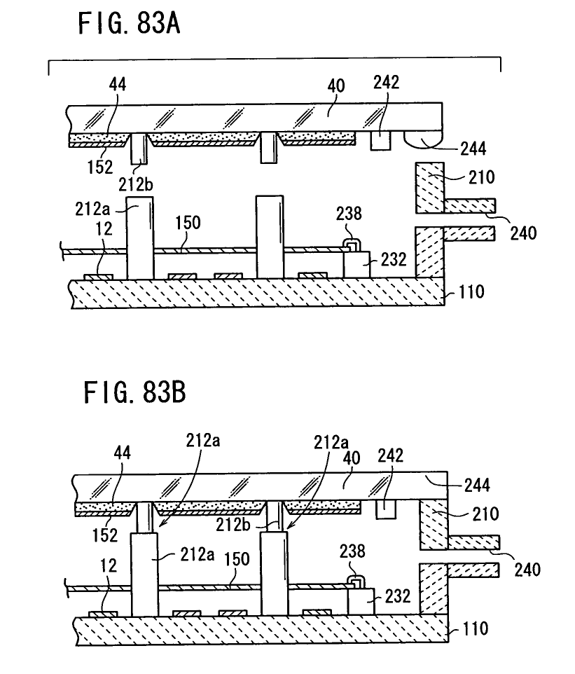

As shown in FIG. 75, the light source 10Q according to the seventeenth embodiment includes: a fixed substrate 110; a number of electron emitters 12 staggered on a principal surface of the fixed substrate 110; a number of upper electrode interconnects 126 formed on the principal surface of the fixed substrate 110; a number of lower electrode interconnects 120 formed on the principal surface of the fixed substrate 110; a spreading electrode 150 spaced apart from the principal surface of the fixed substrate 110 with a certain gap therebbtween; a transparent substrate 40 facing the fixed substrate 110; a circumferential spacer 210 provided between a circumference of the transparent substrate 40 and a circumference of the fixed substrate 110; and a number of internal spacers 212 interposed between the transparent substrate 40 and the fixed substrate 110. Incidentally, as shown in FIG. 83B, the internal spacers 212 include first internal spacers 212a having a larger diameter and provided on the fixed substrate 110 and second internal spacers 212b having a smaller diameter and provided between the transparent substrate 40 and the first internal spacers 212a.

The upper electrode interconnects 126 and the lower electrode interconnects 120 are alternately provided. The upper electrode interconnects 126 are electrically connected to the upper electrodes of the electron emitters 12, while the lower electrode interconnects 120 are electrically connected to the lower electrodes of the electron emitters 12.

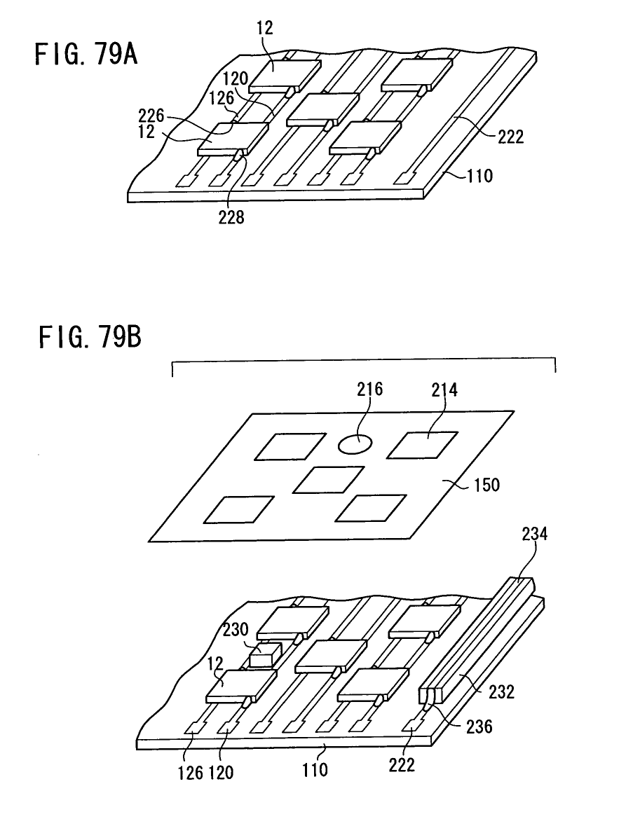

The spreading electrode 150 is made of a single electrode plate, for example. A number of first openings 214 are provided at positions corresponding to the electron emitters 12, while a number of second openings 216 (see FIG. 79B) are provided at positions corresponding to the internal spacers 212.

A phosphor layer 44 and a metal back layer 152 (also as an anode electrode 42) are formed on a surface of the transparent substrate 40 in this order, the surface opposing the fixed substrate 110.

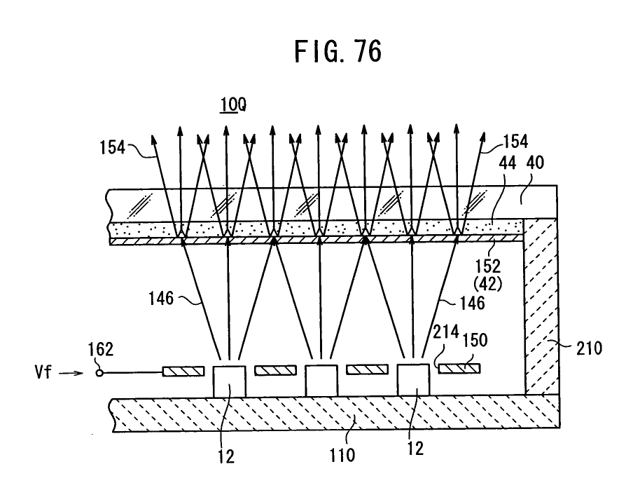

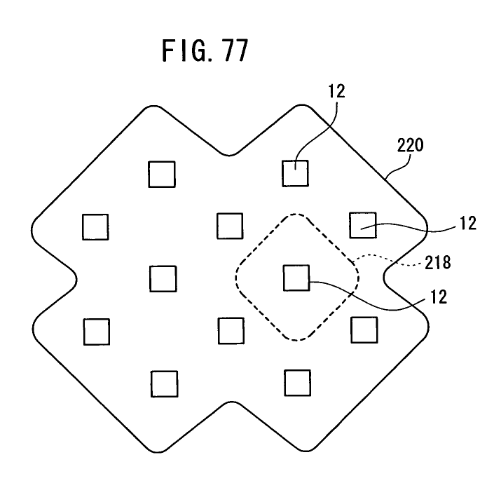

As shown in FIG. 76, by applying a positive control voltage Vf, for example, to the spreading electrode 150 through a terminal 162 thereof, a kind of an electrostatic lens is generated in the emission paths of electron flows 146 for spreading the electron flows 146 from the electron emitters 12. The electron flows 146 emitted from the electron emitters 12 toward the metal back layer 152 are abruptly spread by the electrostatic lens disposed in the emission paths of the electron flows 146, and then gradually spread as the electron flows 146 approach the metal back layer 152. Consequently, as shown in FIG. 77, a light emitting area 218 (shown by a broken line) of a single electron emitter 12 becomes larger than the area occupied by the single electron emitter 12 under the action of spreading by the spreading electrode 150 (see FIG. 76). Therefore, a light emitting region 220 of the light source 10Q according to the seventeenth embodiment is composed of the light emitting areas 218 staggered in accordance with the array of the electron emitters 12, so that the light emitting region 220 can be enlarged over a wide area. By the enlargement of the light emitting region 220, the phosphor layer is prevented from being saturated by an excessive amount of electrons impinging locally thereupon, and is capable of emitting phosphorescent light from its irradiated surface highly efficiently through an increased area for a spread uniform surface emission.

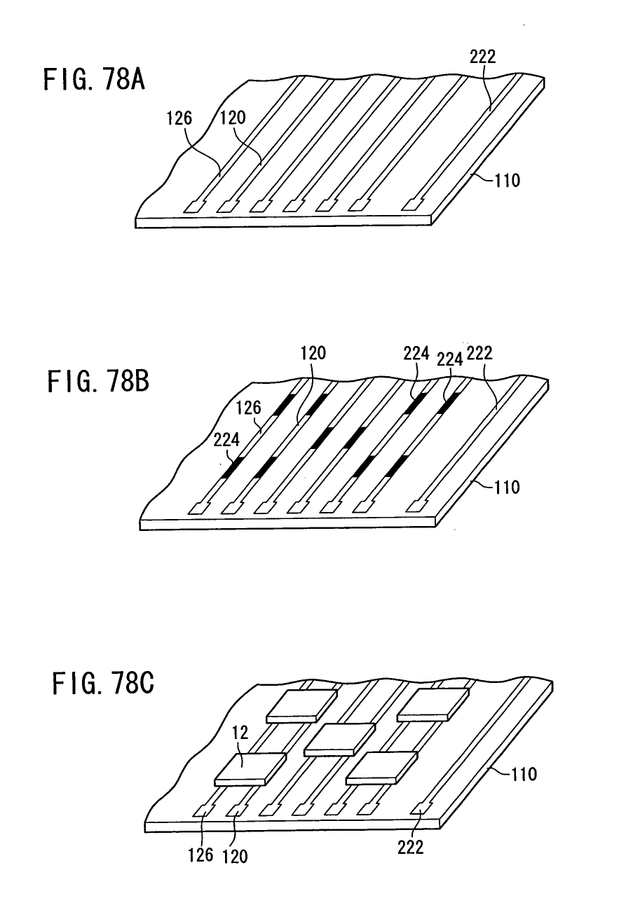

A method of producing the light source 10Q according to the seventeenth embodiment will be described below with reference to FIGS. 78A to 83B.

First, processes on the side of the fixed substrate 110 will be described with reference to FIGS. 78A to 80B.

As shown in FIG. 78A, the upper electrode interconnects 126, the lower electrode interconnects 120 and a spreading electrode interconnect 222 are provided on a principal surface of the fixed substrate 110 having the thickness of 2.8 mm, for example. Specifically, silver electrode patterns are provided on the principal surface of the fixed substrate 110 by screen printing, dried for 5 minutes at 150° C. and sintered for 10 minutes at 600° C., thereby forming the upper electrode interconnects 126, the lower electrode interconnects 120 and the spreading electrode interconnect 222. Alternatively, the upper electrode interconnects 126, the lower electrode interconnects 120 and the spreading electrode interconnect 222 may be formed by photolithography technique (including lift-off) patterning an aluminum film formed by sputtering.

Next, as shown in FIG. 78B, silver paste as bonding paste 224 for fixing the electron emitters 12 is screen-printed on parts of the upper electrode interconnects 126 and the lower electrode interconnects 120 where the electron emitters 12 are to be provided on. By using the silver paste, the electron emitters 12 are prevented from detaching from the fixed substrate 110 (soda glass) due to thermal expansion difference between the electron emitters 12 and the fixed substrate and no crack can be generated in the fixed substrate 110.

By applying the bonding paste 224 (silver paste in this embodiment) to the electrode patterns (the upper electrode interconnects 126 and the lower electrode interconnects 120), the formed metal films (electrode patterns) to which the bonding paste 224 is applied also prevent the electron emitters 12 from detaching from the fixed substrate 110 (soda glass) due to the thermal expansion difference and avoid generation of cracks in the fixed substrate 110.

The formed electrode patterns (the upper electrode interconnects 126 and the lower electrode interconnects 120) generate a gap between the electron emitters 12 and the fixed substrate 110 (soda glass), thereby facilitating volatilization of solvent in the bonding paste 224. Accordingly, unnecessary spreading of the bonding paste 224 can be prevented when the bonding paste 224 is dried.

Then, as shown in FIG. 78C, the electron emitters 12 are mounted on the fixed substrate 110. Specifically, the electron emitters 12 are provided at predetermined positions and dried for 5 minutes at 150° C.

Alignment patterns indicating the predetermined positions for the electron emitters 12 are provided on the electrode patterns (the upper electrode interconnects 126 and the lower electrode interconnects 120). Alternatively, the predetermined positions may be indicated by the position of the bonding paste 224 on the electrode patterns. The intervals between the electron emitters 12 are determined so as to provide the light emitting regions (area) of the electron emitters 12 without any gap therebetween by measuring the light emitting region of one electron emitter 12.

Then, as shown in FIG. 79A, the upper electrodes of the electron emitters 12 are electrically connected to the upper electrode interconnects 126, while the lower electrodes of the electron emitters 12 are electrically connected to the lower electrode interconnects 120. Specifically, connecting paste 226 is applied between the upper electrodes of the electron emitters 12 and the upper electrode interconnects 126, while connecting paste 228 is applied between the lower electrodes of the electron emitters 12 and the lower electrode interconnects 120. Thereafter, drying process is performed for 5 minutes at 150° C. The connecting pastes 226, 228 may be applied by screen-printing, a dispenser or the like.

Then, as shown in FIG. 79B, the spreading electrode 150 is assembled. Specifically, spreading electrode spacers (a glass chip 230 and a glass bar 232) for setting the z-axis distance between the spreading electrode 150 and the electron emitters 12 are provided by glass paste on parts of the principal surface of the fixed substrate 110 where the electron emitters 12 are not provided. Thereafter, drying process is performed for 5 minutes at 150° C. Incidentally, an interconnect pattern 234 for the spreading electrode interconnect 222 is formed on the upper surface of the glass bar 232 and electrically connected to the spreading electrode interconnect 222 on the fixed substrate 110 by connecting paste 236.

Thereafter, the spreading electrode 150 is mounted on the spreading electrode spacers (the glass chip 230 and the glass bar 232) in a manner to cover part of the principal surface of the fixed substrate 110.

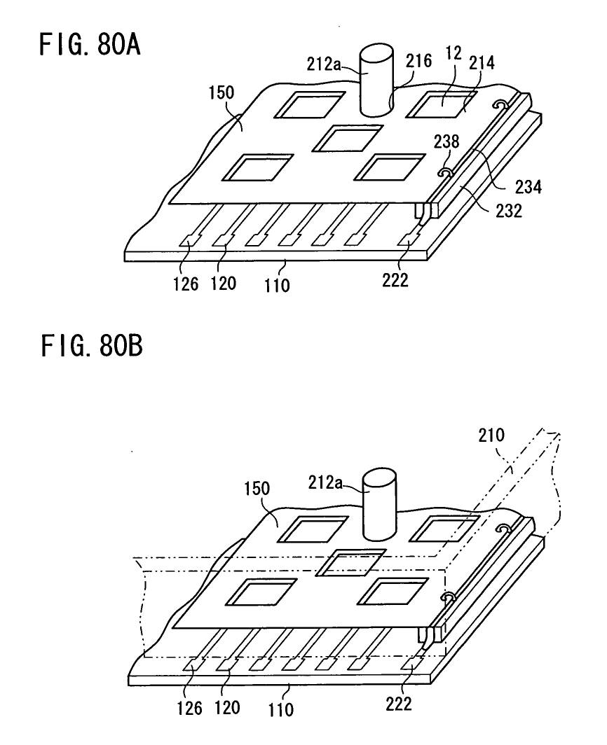

The spreading electrode 150 may be made of a metal plate (having its thickness of about 100 μm) such as SUS and invar 42. The spreading electrode 150 includes the first openings 214 having substantially the same size as the electron emitting surface of the electron emitter 12, the first openings 214 being positioned corresponding to the electron emitters 12 (overlapping the electron emitters 12). The spreading electrode 150 also includes the second opening 216 for supporting the first internal spacer 212a (see FIG. 80A). Further, the spreading electrode 150 includes openings (not shown) for aligning the X-Y position of the spreading electrode 150. Glass bars (not shown) are inserted into and fixed in the openings to align and fix the spreading electrode 150.

Then, as shown in FIG. 80A, the first internal spacer 212a is assembled. Specifically, the first internal spacer 212a includes a glass bar having its diameter of F2 to 3 mm and its length of 8 to 9 mm with antistatic silver paste applied thereto. The first internal spacer 212a is mounted on the fixed substrate 110 by inserting it into the second opening 216 formed in the spreading electrode 150. The first internal spacer 212a is fixed to the fixed substrate 110 by applying glass paste thereto and performing drying process for 5 minutes at 150° C.

The spreading electrode 150 is electrically connected to the interconnect pattern 234 formed on the upper surface of the glass bar 232 of the spreading electrode spacer through connecting wires 238.

Incidentally, the spreading electrode spacer (not shown) and the first internal spacer 212a may be integrated with each other and the bar may be made of metal instead of glass in order to decrease use of silver paste.

Then, as shown in FIG. 80B, the circumferential spacer 210 is assembled. Specifically, frit glass (not shown) is applied to the circumference of the fixed substrate 110, and the circumferential spacer 210 is fixed thereon. Thereafter, drying process is performed for 5 minutes at 150° C. Incidentally, as shown in FIG. 83A, the circumferential spacer 210 includes an exhaust outlet 240 for evacuation.

Comparing the circumferential spacer 210 with the internal spacers 212 (the first internal spacer 212a and the second internal spacer 212b), the internal spacers 212 are designed to be higher than the circumferential spacer 210 by 0.2 mm. When the transparent substrate 40 is attached to the fixed substrate 110, the internal spacer 212 defines the distance between the fixed substrate 110 and the transparent substrate 40. If a gap is generated at the circumference, the frit glass applied thereto compensates for the gap.

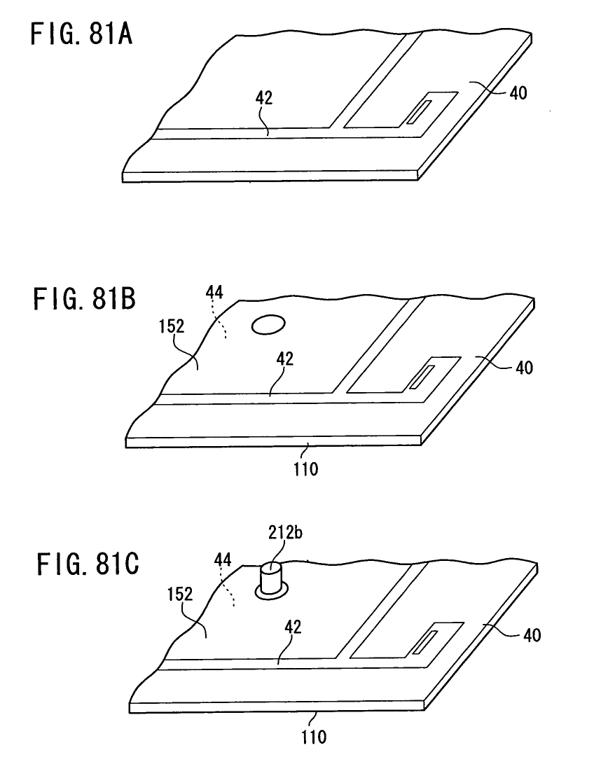

Next, processes on the side of the transparent substrate 40 will be described with reference to FIGS. 81A to 81C.

As shown in FIG. 81A, an anode electrode 42 is formed on one surface (opposing the fixed substrate 110) of the transparent substrate 40 having its thickness of 2.8 mm, for example. The anode electrode 42 may be formed by printing an electrode pattern to the one surface of the transparent substrate 40 or forming a metal film by sputtering and patterning by photolithography technique.

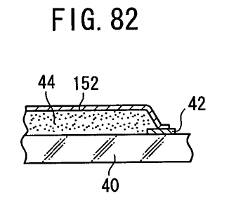

Then, as shown in FIGS. 81B and 82, a phosphor layer 44 and a metal back layer 152 are formed on the one surface of the transparent substrate 40. In this case, the phosphor layer 44 is formed by screen-printing and the metal back layer 152 is formed by sputtering. Incidentally, the phosphor layer 44 and the metal back layer 152 are not formed on portions where the second internal spacer 212b (see FIG. 81C) is to be provided.

Then, as shown in FIG. 81C, the second internal spacer 212b is assembled. Specifically, a glass bar (second internal spacer 212b) having its diameter of F1 mm and its length of 1 to 2 mm is provided by glass paste at a position corresponding to the first internal spacer 212a provided on the fixed substrate 110, i.e., a position where the phosphor layer 44 and the metal back layer 152 are not formed in the process shown in FIG. 81B. The glass paste includes a powder of TiO₂ in order to make the glass paste white. When the fixed substrate 110 and the transparent substrate 40 are attached to each other, the surfaces of the first internal spacer 212a and the second internal spacer 212b contact with each other and the internal spacers 212 function as one internal spacer.

Next, an assembling process of the light source 10Q will be described with reference to FIGS. 83A and 83B.

As shown in FIG. 83A, a getter 242 is fixed to part of the one surface (opposing the fixed substrate 110) of the transparent substrate 40 where the phosphor layer 44 and the metal back layer 152 are not formed. Further, frit glass 244 is applied to the circumference of the transparent substrate 40.

Thereafter, the one surface of the transparent substrate 40 and the principal surface of the fixed substrate 110 are opposed to each other, and the circumferential spacer 210 and the circumference of the transparent substrate 40 are fixed to each other by the frit glass 244. Then, the fixed substrate 110 and the transparent substrate 40 are bonded to each other by heating at 475° C. to contact the surface of the first internal spacer 212a with the surface of the second internal spacer 212b.

Then, as shown in FIG. 83B, a vacuum sealing process is carried out. Specifically, internal air is evacuated from the exhaust outlet 240 of the circumferential spacer 210, and the exhaust outlet 240 is sealed. Thereafter, the getter 242 is heated and activated.

According to the above processes, the light source 10Q according to the seventeenth embodiment can be manufactured.

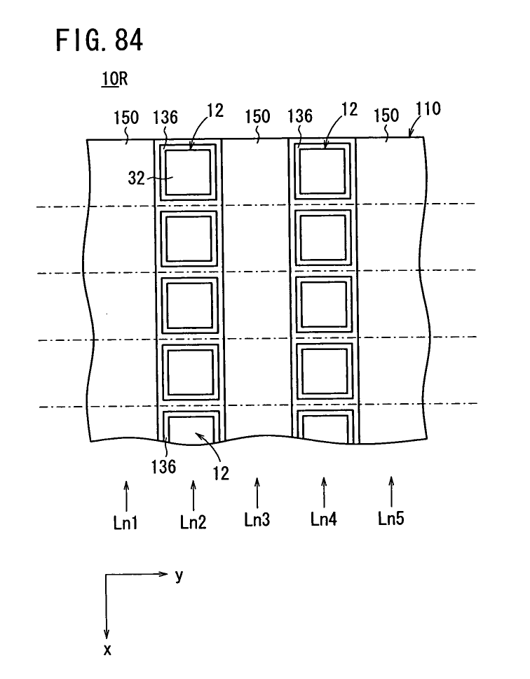

A light source 10R according to an eighteenth embodiment of the present invention will be described below with reference to FIGS. 84 through 86.

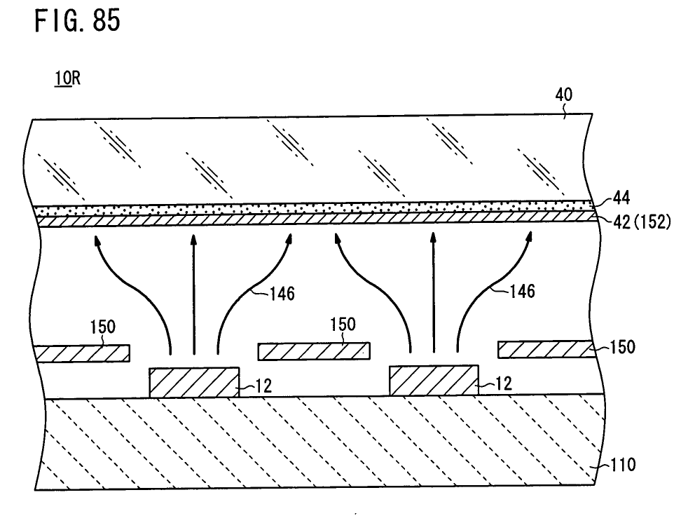

As shown in FIGS. 84 and 85, the light source 10R according to the eighteenth embodiment is substantially the same structure as the light source 10P according to the sixteenth embodiment described above. But there are some differences described below.

First, an upper surface of the fixed substrate 110 is divided into a plurality of regions (e.g., a plurality of columns Ln1, Ln2 . . . ). The direction (x-direction) in which each of columns (Ln1, Ln2, . . . ) extends is referred to as the longitudinal direction and the direction (y-direction) in which the columns (Ln1, Ln2, . . . ) are lined up is referred to as the transverse direction.

In the light source 10R, plate-like spreading electrodes 150 longitudinally extending are disposed above portions of the upper surface of the fixed substrate 110 which correspond to odd-numbered columns (Ln1, Ln3, Ln5, . . . ), for example, and a plurality of electron emitters 12 using ferroelectric chips 136 are longitudinally disposed on portions of the upper surface of the fixed substrate 110 which correspond to even-numbered columns (Ln2, Ln4, . . . ). Though not shown, the spreading electrodes 150 are disposed above portions corresponding to the first column and the last column respectively.

Specifically, there are spreading electrodes 150 above both sides of the column on which the electron emitters 12 are disposed. In FIG. 84, a plurality of the electron emitters 12 are arranged in a matrix so that the electron emitters 12 are transversely disposed on each of rows.

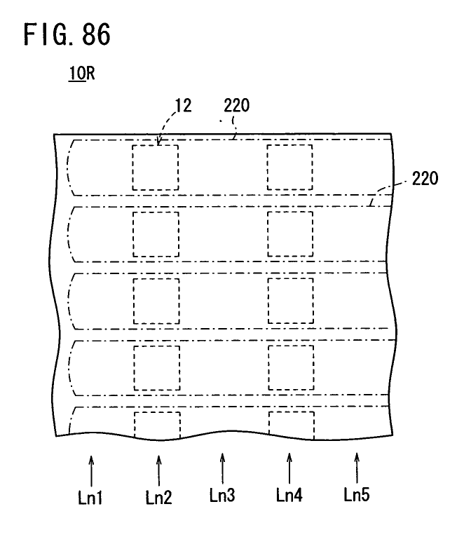

Therefore, electron flows 146 emitted from the electron emitters 12 are transversely spread by an electric field generated by the spreading electrodes 150. As shown in FIG. 86, light emits on the surface of the transparent substrate 40 in the manner where light emitting regions 220 of the electron emitters 12 disposed on each row are transversely linked to each other.

Consequently, when the light source 10R is used for a backlight of a liquid crystal display (LCD), the light emitting region or regions 220 can be longitudinally displaced stepwise in a constant period (e.g., a period of vertical scanning signal of LCD) by controlling the electron emitters 12 by a row or rows at a time.

When moving images are displayed on LCD, a problem called image lag typically occurs. As described above, by longitudinally displacing the light emitting region or regions 220 of the light source 10R as a backlight, the image lag can be reduced and moving images can be displayed by a pseudo impulse display, which can improve the display properties of moving images on LCD.

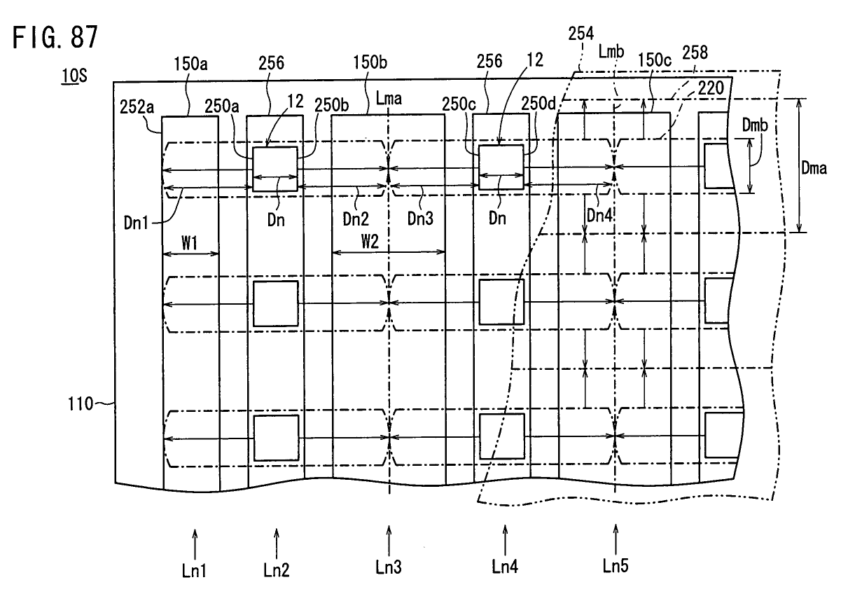

A light source 10S according to a nineteenth embodiment of the present invention will be described below with reference to FIG. 87.

As shown in FIG. 87, the light source 10S according to the nineteenth embodiment is substantially the same structure as the light source 10R according to the eighteenth embodiment described above. But there are some differences described below.

The width W1 of a spreading electrode 150a above a portion corresponding to the first column Ln1 is substantially equal to the width of a spreading electrode (not shown) above a portion corresponding to the last column. The width W2 of respective spreading electrodes 150b, 150c, . . . above each of columns between the columns of electron emitters 12 is substantially twice the width W1 of the spreading electrode 150a above the portion corresponding to the first column Ln1.

In FIG. 87, the distance Dn1 between one end face 250a (the surface close to the first column Ln1) of the electron emitter 12 disposed on the second column Ln2 and one end face 252a of the spreading electrode 150a above the portion corresponding to the first column Ln1 is substantially twice the transverse length Dn of the electron emitter 12. The distance Dn2 between the other end face 250b (the surface close to the third column Ln3) of the electron emitter 12 on the second column Ln2 and the center line Lma of a spreading electrode 150b above a portion corresponding to the third column Ln3 is also substantially twice the transverse length Dn of the electron emitter 12.

Similarly, the distance Dn3 between one end face 250c (the surface close to the third column Ln3) of the electron emitter 12 on the fourth column Ln4 and the center line Lma of the spreading electrode 150b above the portion corresponding to the third column Ln3 is also twice the transverse length Dn of the electron emitter 12. The distance Dn4 between the other end face 250d (the surface close to the fifth column Ln5) of the electron emitter 12 on the fourth column Ln4 and the center line Lmb of a spreading electrode 150c above a portion corresponding to the fifth column Ln5 is also twice the transverse length Dn of the electron emitter 12. Other columns are the same as above.

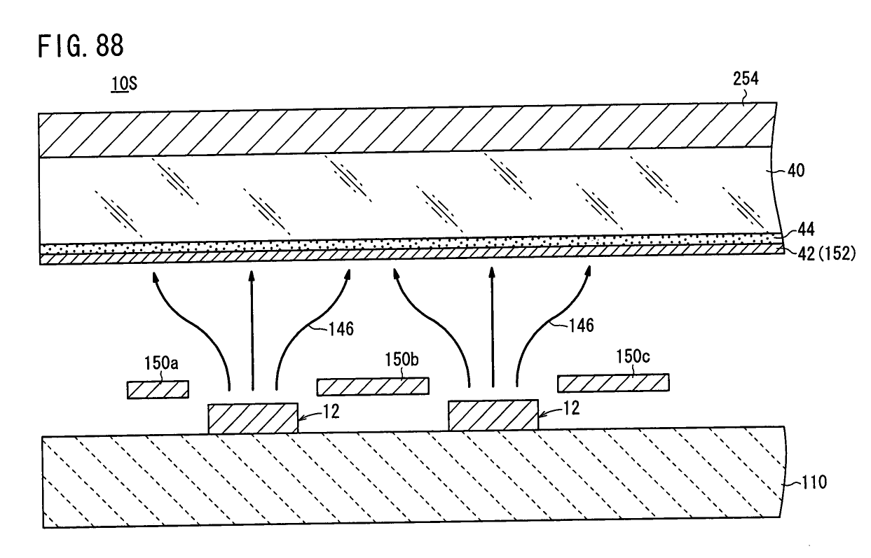

Further, according to the nineteenth embodiment shown in FIG. 88, a light spreading plate 254 is disposed in facing relation to the surface of the transparent substrate 40. The light spreading plate 254 may be in the type where light irradiated on the surface of the transparent substrate 40 is longitudinally spread. For this, the distance between rows (e.g., between the first row and the second row or the second row and the third row, etc.) can be enlarged. As shown in FIG. 87, the longitudinal length Dma of a light emitting region 258 on the light spreading plate 254 can be five times the longitudinal length Dmb of the light emitting region 220 on the surface of the transparent substrate 40. As a result, the number of the disposed electron emitters 12 can be significantly reduced. This is advantageous in expanding the design freedom of interconnects and reducing power consumption. Furthermore, by using elongate ferroelectric chips 256 longitudinally extending shown in FIG. 87, not substantially square-shaped ferroelectric chips 136 according to the eighteenth embodiment, the cost of mounting can be significantly reduced, thereby lowering the cost of manufacturing.

In the above example, the ratio at which the light emitting region is enlarged with the electron flows 146 emitted from the electron emitter 12, i.e., the enlargement ratio, is 5 times in the transverse direction and also 5 times in the longitudinal direction. The enlargement ratio is however not limited to the above example. The enlargement ratio may optionally be selected depending on an applied voltage to the spreading electrodes 150, materials of the light spreading plate 254, the mounting location, etc.

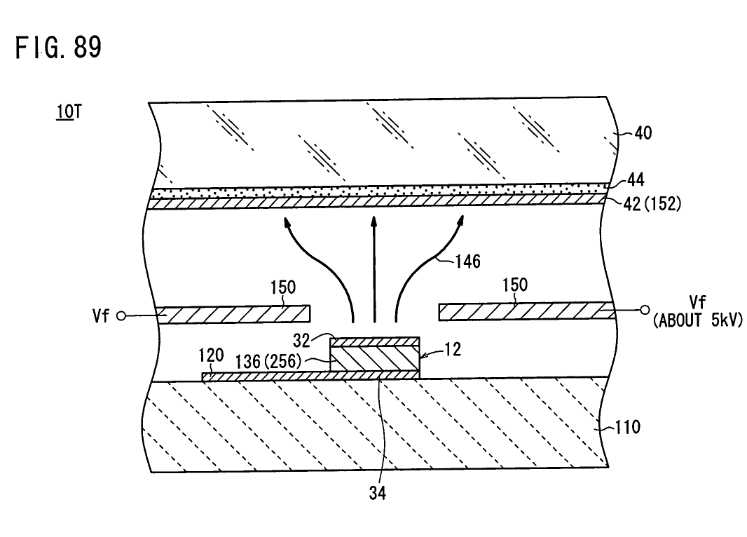

A light source 10T according to a twentieth embodiment of the present invention will be described below with reference to FIG. 89.

As shown in FIG. 89, the light source 10T according to the twentieth embodiment is substantially the same structure as the light source 10E according to the fifth embodiment described above, except that electron emitters 12 mounted on the fixed substrate 110 comprise ferroelectric chips 136 (see FIG. 84) or elongate ferroelectric chips (see FIG. 87). In this case, also, lower electrode interconnects 120 formed on the fixed substrate 110 and lower electrodes 34 of the electron emitters 12 are electrically connected to each other, and upper electrode interconnects (not shown) formed on the fixed substrate 110 and upper electrodes 32 of the electron emitters 12 are electrically connected to each other.

A voltage of 0 V is constantly applied to the upper electrodes 32, and a control voltage Vf of about 5 kV is applied to the spreading electrodes 150. An electrostatic lens is generated in the emission paths of the electron flows 146 for spreading the electron flows 146. The electron flows 146 emitted from the electron emitters 12 toward the metal back layer 152 are abruptly spread by the electrostatic lens disposed in the emission paths of the electron flows 146, and then gradually spread as the electron flows 146 approach the metal back layer 152.

However, since this requires a high voltage power supply separately for applying the control voltage Vf of about 5 kV to the spreading electrodes 150, the cost disadvantageously tends to be high. Further, since this requires the large insulation distances between the lower electrode interconnect 120 and the spreading electrode 150, and the upper electrode 32 and the spreading electrode 150, this cannot allow the height of the light source 10T to be lowered.

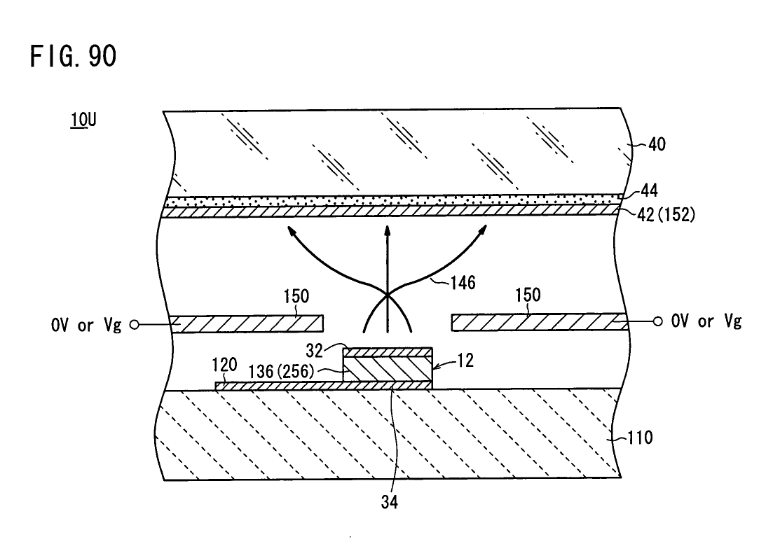

As in a light source 10U according to a twenty-first embodiment of the present invention shown in FIG. 90, a voltage of 0 V or a low voltage Vg of 100 V or the like is preferably applied to the spread electrodes 150.

Namely, in the light source 10U according to the twenty-first embodiment, a voltage of 0 V is constantly applied to the upper electrodes 32, and a voltage of 0 V or a low voltage Vg of 100 V or the like is applied to the spreading electrodes 150. The electron flows 146 emitted from the electron emitters 12 then travel away from the spreading electrodes 150 toward the metal back layer 152. The electron flows 146 toward the metal back layer 152, then, intersect with each other above the center of the upper surface of the electron emitters 12. Thereafter the electron flows 146 are gradually spread as the electron flows 146 approach the metal back layer 152.

Since the voltage of 0 V or the low voltage Vg of 100 V or the like is applied to the spreading electrodes 150, this case does not require a high voltage power supply. If the low voltage Vg of 100 V or the like is applied to the spreading electrodes 150, this requires only installing a low-cost low voltage power supply. If the voltage of 0 V is applied to the spreading electrodes 150, even a low voltage power supply is not required. This is advantageous for reducing the cost. In addition, since this does not require the large insulation distances between the lower electrode interconnect 120 and the spreading electrode 150, and the upper electrode 32 and the spreading electrode 150, it is advantageous for lowering the height of the light source 10T.

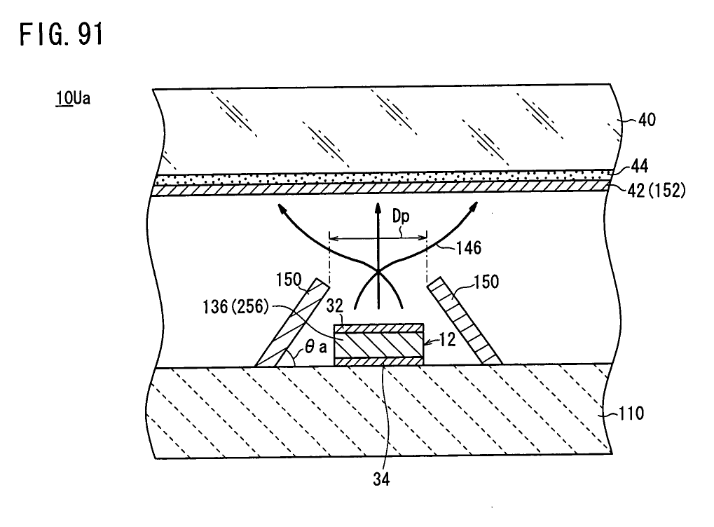

As in a light source 10Ua according to a modification shown in FIG. 91, the spreading electrodes 150 may be disposed obliquely with respect to the upper surface of the fixed substrate 110. In this case, the spreading ratio of the electron flow 146 (=“an area of a light emitting region of one electron emitter 12”/“an area of an electron emission surface of the electron emitter 12”) can arbitrarily be changed depending on a spacing width Dp or a tilt angle θa of the spreading electrodes 150.

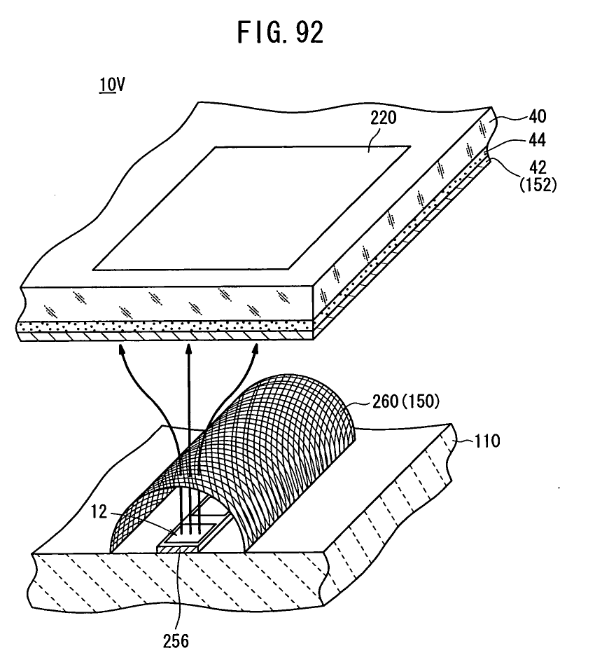

A light source 10V according to a twenty-second embodiment of the present invention will be described below with reference to FIG. 92.

As shown in FIG. 92, the light source 10V according to the twenty-second embodiment has a mesh electrode 260 as a spreading electrode 150 above an elongate ferroelectric chip 256 having a plurality of electron emitters 12 formed thereon.

The mesh electrode 260 comprises a rectangular or square-shaped metal mesh electrode which is rounded into a half-cylindrical shape. Both end faces of the mesh electrode 260 are secured on the upper surface of the fixed substrate 110 to dispose the mesh electrode 260 on the fixed substrate 110. The mesh electrode 260 is so positioned as to position the ferroelectric chip 256 directly below the top portion of the half-cylindrical shaped mesh electrode 260.

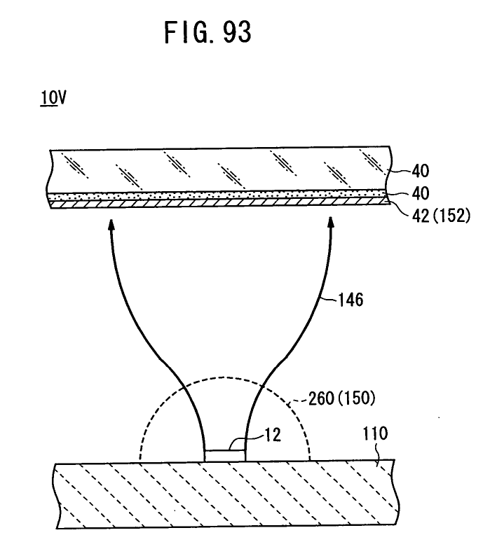

As shown in FIG. 93, a voltage of 0 V or a low voltage of 100 V or the like is applied to the mesh electrode 260, which deforms a equipotential surface between the mesh electrode 260 and the metal back layer 152 (anode electrode 42). The deformed equipotential surface curves the paths of the electron flows 146 which have passed through the openings of the mesh electrode 260. This leads to the transverse spread of the electron flows 146.

The mesh electrode 260 comprises a mesh woven with metal wire having a wire diameter of F40 μm, for example. The mesh has preferably 200 mesh (i.e., 200 openings per inch) and an opening area of about 50%, for example.

The mesh count, opening area, wire diameter, etc. of the mesh electrode 260 may arbitrarily be selected depending on the spreading ratio of the electron flows 146, the size of the electron emitters 12 (an area of the electron emission surface), the gap between the fixed substrate 110 and the transparent substrate 40, the applied voltage to the mesh electrode 260, etc. Incidentally, the spreading ratio of the electron flows 146 can arbitrarily be changed by changing the radius of curvature of the mesh electrode 260.

If the mesh count is too small, the electron flows 146 are sparsely spread to form some light emitting regions separately. This results in deterioration of the display quality. If the mesh count is too large, most of the electron flows 146 emitted from the electron emitters 12 are captured by the mesh electrode 260, which functions as a shield electrode.

In the light source 10V according to the twenty-second embodiment, since the mesh electrode 260 is used as a spreading electrode 150 and both end faces of the mesh electrode 260 are secured on the fixed substrate 110, the spreading electrode 150 can easily be positioned with respect to the electron emitters 12, and the electron flows 146 can substantially symmetrically be spread in the transverse direction. This is advantageous for a spread uniform surface emission.

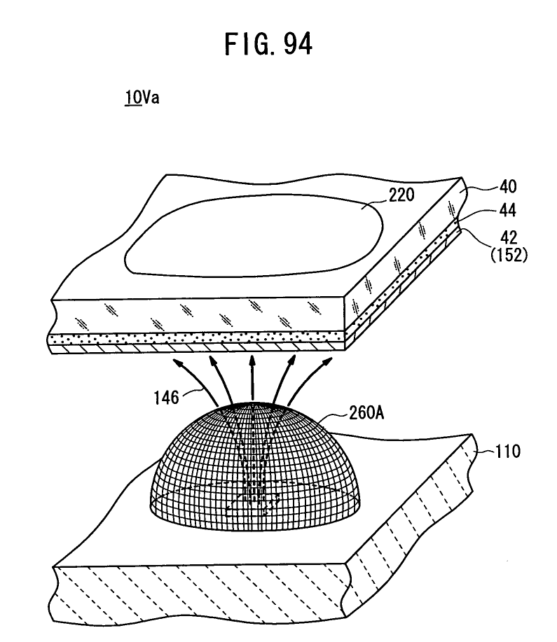

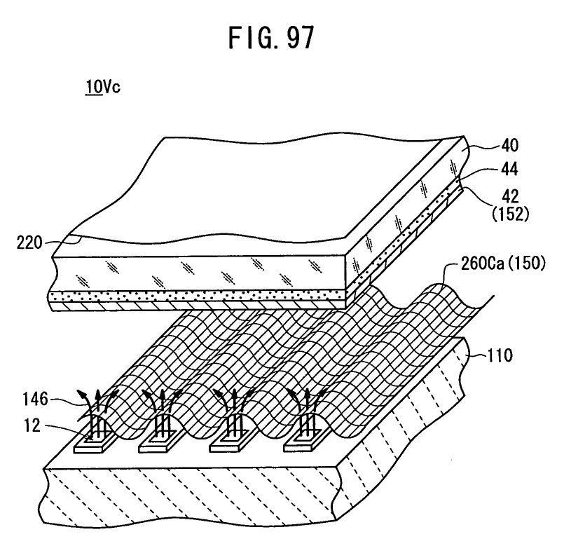

Modifications of the light source 10V according to the twenty-second embodiment will be described below with reference to FIGS. 94 through 99.

As shown in FIG. 94, a light source 10Va according to a first modification differs from the light source 10V in that a first mesh electrode 260A is hemispheric or parabolic in shape and is disposed to cover one electron emitter 12.

In this case, the electron flows 146 emitted from the electron emitter 12 can be spread in all directions.

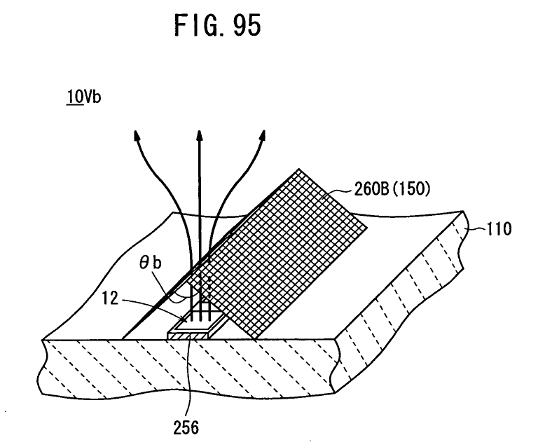

As shown in FIG. 95, a light source 10Vb according to a second modification differs from the light source 10V in that a second mesh electrode 260B (spreading electrode 150) is folded in two and is disposed above an elongate ferroelectric chip 256 having a plurality of electron emitters 12 formed thereon.

In this case as with the twenty-second embodiment, the electron flows 146 passing through openings of the second mesh electrode 260B can be spread in the transverse direction. The spreading ratio of the electron flows 146 can arbitrarily be changed by adjusting a folding angle θb of the second mesh electrode 260B.

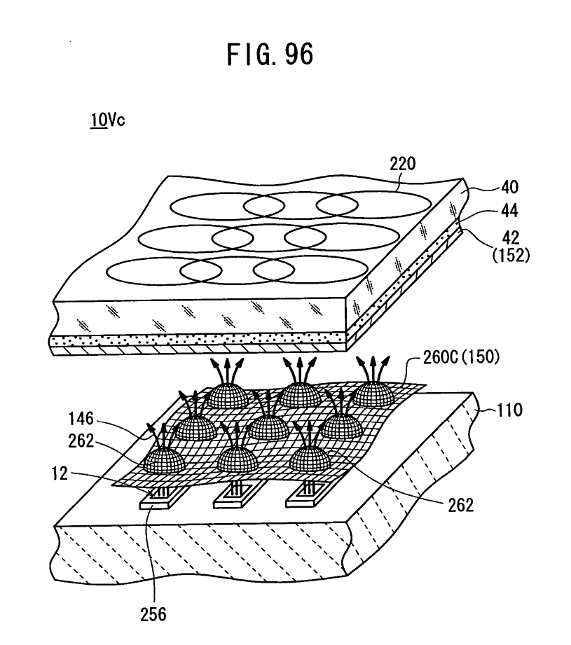

As shown in FIG. 96, a light source 10Vc according to a third modification differs from the light source 10V in that a third mesh electrode 260C has a large number of small and hemispheric or parabolic domes 262 formed thereon and is disposed above elongate ferroelectric chips 256 having a plurality of electron emitters 12 formed thereon. In this arrangement shown in FIG. 96, the third mesh electrode 260C may be disposed so that one dome 262 corresponds to one electron emitter 12 or that positions of the electron emitters 12 and the domes 262 are not associated with each other.

In the light source 10Vc according to the third modification, the electron flows 146 passing through openings of the third mesh electrode 260C are randomly spread. As a result, a spread uniform surface emission can be achieved.

Incidentally, the third mesh electrode 260C for randomly spreading the electron flows 146 may comprise a third mesh electrode 260Ca having a corrugated shape or the like.

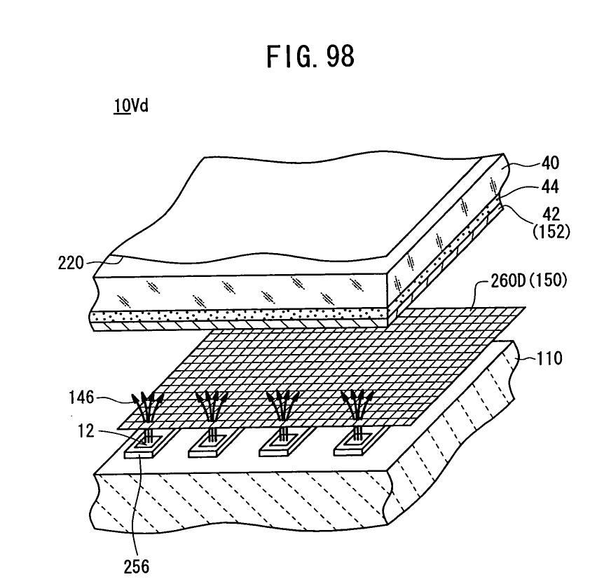

As shown in FIG. 98, a light source 10Vd according to a fourth modification differs from the light source 10V in that a fourth mesh electrode 260D is rectangular in shape and horizontally disposed above elongate ferroelectric chips 256 having a plurality of electron emitters 12 formed thereon. In this arrangement, the fourth mesh electrode 260D has a large number of openings thereon. A voltage of 0 V or a low voltage of 100 V or the like is applied to the fourth mesh electrode 260D, which deforms an equipotential surface near the fourth mesh electrode 260D. The deformed equipotential surface curves the paths of the electron flows 146, which spreads the electron flows 146 in all directions.

When the spreading electrode 150 is mounted above the electron emitter 12, it typically requires the highly accurate positioning of the electron emitters 12 and the openings formed on the spreading electrode 150. As shown in FIG. 92, when the half-cylindrical shaped mesh electrode 260 is mounted, it requires positioning accurately the ferroelectric chips 256 directly below the top of the mesh electrode 260.

However, in the fourth modification, since the fourth mesh electrode 260D has a large number of openings, this requires only mounting the fourth rectangular mesh electrode 260D above the ferroelectric chips 256, not require the highly accurate positioning of each electron emitter 12 and each opening. Further, a particular process is not required on the fourth mesh electrode 260D. Therefore, the fourth modification is advantageous in simplifying the mounting work and reducing the cost of manufacturing.

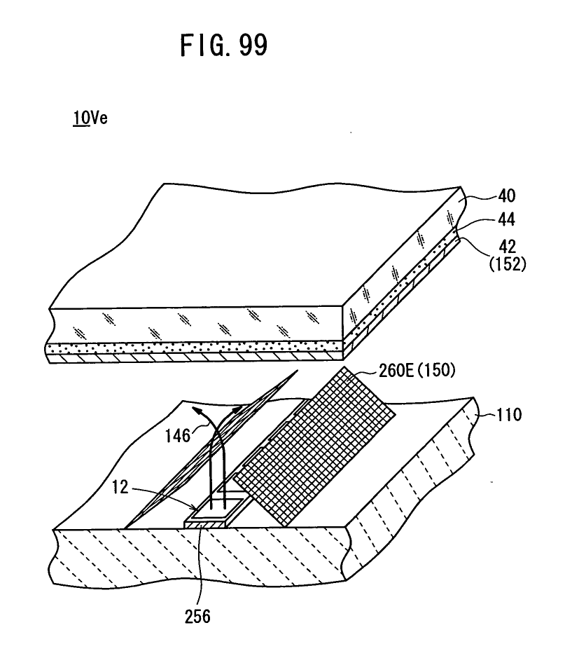

As shown in FIG. 99, a light source 10Ve according to a fifth modification differs from the light source 10V in that a fifth mesh electrode 260E is rectangular in shape and two of the fifth mesh electrodes 260E are disposed obliquely with respect to the upper surface of the fixed substrate 110 above an elongate ferroelectric chip 256 having a plurality of electron emitters 12. This structure is substantially the same as the light source 10Ua (see FIG. 91) according to the modification of the twenty-first embodiment described above.

In this case, the electron flows 146 emitted from the electron emitters 12 also travel away from the fifth mesh electrodes 260E toward the metal back layer 152. The electron flows 146 toward the metal back layer 152 then intersect with each other above the center of the upper surface of the electron emitters 12. Thereafter the electron flows 146 are gradually spread as the electron flows 146 approach the metal back layer 152.

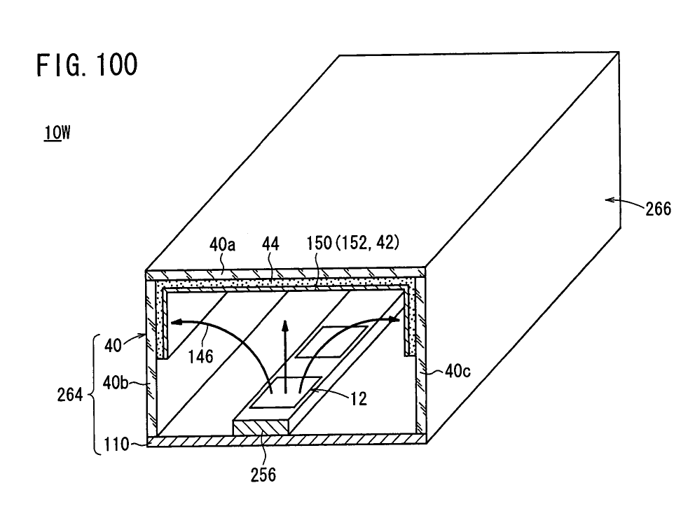

A light source 10W according to a twenty-third embodiment of the present invention will be described below with reference to FIG. 100.

As shown in FIG. 100, the light source 10W according to the twenty-third embodiment comprises an elongate ferroelectric chip 256 and a substantially U-shaped transparent substrate 40. The elongate ferroelectric chip 256 has a plurality of electron emitters 12 formed on a fixed substrate 110. The substantially U-shaped transparent substrate 40 is disposed on the fixed substrate 110 to cover the ferroelectric chip 256. A housing 264 for covering the ferroelectric chip 256 is comprised of the fixed substrate 110 and the transparent substrate 40. The light source low is formed as a light emitting tube 266 having the housing 264.

The transparent substrate 40 comprises an upper plate 40a facing the fixed substrate 110 and two side plates (a first side plate 40b and a second side plate 40c) interposed between the upper plate 40a and the fixed substrate 110.

A phosphor layer 44 is formed on an inner wall of the transparent substrate 40, i.e. an internal surface of the upper plate 40a (the surface facing the fixed substrate 110), an upper portion of an internal surface of the first side plate 40b (the surface facing the second side plate 40c), and an upper portion of an internal surface of the second side plate 40c (the surface facing the first side plate 40b). Further, a metal back layer 152 (anode electrode 42) functioning as a spreading electrode 150 is formed on the phosphor layer 44.

The electron flows 146 emitted from the electron emitters 12 travel toward the metal back layer 152. Then, since the metal back layer 152 is formed on the three surfaces continuously, the electron flows 146 are gradually spread as the electron flows 146 approach the metal back layer 152. Light then emits on the upper plate 40a, the first side plate 40b, and the second side plate 40c of the transparent substrate 40.

This modification shows one light source 10W (a light emitting tube 266). However, in a large planar light source 270 having a large area for emitting light shown in FIG. 101, a plurality of the light emitting tubes 266 are disposed and spaced at predetermined intervals on the upper surface of a large fixed substrate 272. Light reflecting layers 274 are formed on portions of the upper surface of the large fixed substrate 272 which are free of the light emitting tubes 266 and are also formed on lower portions of the first side plate 40b and the second side plate 40c of each light emitting tube 266.

With this arrangement, light 276 emits ahead of the planar light source 270 from the upper plate 40a and the upper portions of the first side plate 40b and the second side plate 40c of each light emitting tube 266. Also, light 278 emits from the upper portions of the first side plate 40b and the second side plate 40c toward the large fixed substrate 272, and the light 278 is reflected by the light reflecting layers 274 to travel ahead of the planar light source 270. As a result, a spread uniform surface emission and a high-luminance light emission can be achieved. Thereby a structure can easily be manufactured for a spread uniform surface emission.

Additionally, since the planar light source 270 does not require mounting a large transparent substrate facing the large fixed substrate 272 and spacers (for supporting the large transparent substrate), reduction in weight, thickness and cost of the planar light source 270 can be achieved. Further, since the anode electrode 42 (the metal back layer 152) also functions as the spreading electrode 150, simplified interconnects can be achieved.

According to the above modification, the phosphor layer 44 is firstly formed on the inner wall of the transparent substrate 40, and then the metal back layer 152 is formed on the phosphor layer 44. Otherwise, in a light source 10Wa according to a modification shown in FIG. 102, a transparent electrode 280 (anode electrode 42) may firstly be formed as the spreading electrode 150 on the inner wall of the transparent substrate 40, and then a phosphor layer 44 may be formed on the transparent electrode 280.

Although certain preferred embodiments of the present invention have been shown and described in detail, it should be understood that various changes and modifications may be made therein without departing from the scope of the appended claims.

What is claimed is:

1. A light source comprising:
a transparent substrate;
a fixed substrate disposed in facing relation to said transparent substrate;
at least one electron emitter disposed on said fixed substrate;
a phosphor layer disposed on a surface of said transparent substrate which confronts said fixed substrate;
a metal back layer disposed on a surface of said phosphor layer which confronts said fixed substrate; and
a spreading electrode disposed on a portion of said fixed substrate which is free of said electron emitter,
wherein an electron flow emitted from said electron emitter is spread by an electric field generated by a voltage signal which is applied to said spreading electrode to reduce a surface density of the electron flow applied to said metal back layer to a peak value of at most 50 μA/cm².

2. A light source according to claim 1, wherein said voltage signal applied to said spreading electrode has a voltage level of 0 V.

3. A light source according to claim 1, wherein said voltage signal applied to said spreading electrode has a voltage level of 100 V or less.

4. A light source according to claim 1, wherein said spreading electrode comprises a mesh electrode having a large number of openings, and
said electron flow emitted from said electron emitter passes through the openings of said mesh electrode and is spread by an electric field generated by a voltage signal which is applied to said mesh electrode.

5. A light source according to claim 4, wherein said mesh electrode is rectangular in shape and is disposed above said electron emitter.

6. A light source according to claim 4, wherein said spreading electrode comprises said rectangular mesh electrode which is rounded into a half-cylindrical shape, and is disposed to cover said electron emitter.

7. A light source according to claim 1, wherein a light spreading plate is disposed on a surface of said transparent substrate opposite to said fixed substrate.

8. A light source comprising:
a transparent substrate;
a fixed substrate disposed in facing relation to said transparent substrate;
at least one electron emitter disposed on said transparent substrate;
a light reflecting film disposed on a surface of said fixed substrate which confronts said transparent substrate;
a phosphor layer disposed on a surface of said light reflecting film which confronts said transparent substrate; and
a spreading electrode disposed on a portion of said transparent substrate which is free of said electron emitter,
wherein an electron flow emitted from said electron emitter is spread by an electric field generated by a voltage signal which is applied to said spreading electrode to reduce a surface density of the electron flow applied to said phosphor layer to a peak value of at most 50 μA/cm².

9. A light source according to claim 8, wherein a light spreading plate is disposed on a surface of said transparent substrate opposite to said fixed substrate.

10. A light source comprising:
a transparent substrate;
a fixed substrate disposed in facing relation to said transparent substrate;
at least one electron emitter disposed on said fixed substrate;
a phosphor layer disposed on a surface of said transparent substrate which confronts said fixed substrate;
a metal back layer disposed on a surface of said phosphor layer which confronts said fixed substrate; and
a spreading electrode disposed on a portion of said fixed substrate which is free of said electron emitter,
wherein said electron emitter emits an electron flow intermittently, and
a pulsed electron flow emitted from said electron emitter is spread by an electric field generated by a voltage signal which is applied to said spreading electrode to reduce a surface density of the pulsed electron flow applied to said metal back layer to a peak value of at most 50 μA/cm².

11. A light source according to claim 10, wherein a light spreading plate is disposed on a surface of said transparent substrate opposite to said fixed substrate.

12. A light source comprising:
a transparent substrate;
a fixed substrate disposed in facing relation to said transparent substrate;
at least one electron emitter disposed on said transparent substrate;
a light reflecting film disposed on a surface of said fixed substrate which confronts said transparent substrate;
a phosphor layer disposed on a surface of said light reflecting film which confronts said transparent substrate; and
a spreading electrode disposed on a portion of said transparent substrate which is free of said electron emitter,
wherein said electron emitter emits an electron flow intermittently, and
a pulsed electron flow emitted from said electron emitter is spread by an electric field generated by a voltage signal which is applied to said spreading electrode to reduce a surface density of the pulsed electron flow applied to said phosphor layer to a peak value of at most 50 μA/cm².

13. A light source according to claim 12, wherein a light spreading plate is disposed on a surface of said transparent substrate opposite to said fixed substrate.

14. A light source comprising:
a transparent substrate;
a fixed substrate disposed in facing relation to said transparent substrate;
at least two electron emitters disposed on said fixed substrate;
a phosphor layer disposed on a surface of said transparent substrate which confronts said fixed substrate;
a metal back layer disposed on a surface of said phosphor layer which confronts said fixed substrate; and
a spreading electrode disposed on a portion of said fixed substrate which is free of said electron emitters,
wherein said electron emitters emit electron flows intermittently,
pulsed electron flows emitted from said electron emitters are spread by an electric field generated by a voltage signal which is applied to said spreading electrode to reduce a surface density of the pulsed electron flow applied to said metal back layer to a peak value of at most 50 μA/cm², and
the pulsed electron flows emitted from said electron emitters irradiate the same area of said metal back layer and are emitted at different times from said electron emitters.

15. A light source according to claim 14, wherein a light spreading plate is disposed on a surface of said transparent substrate opposite to said fixed substrate.

16. A light source comprising:
a transparent substrate;
a fixed substrate disposed in facing relation to said transparent substrate;
at least two electron emitters disposed on said transparent substrate;
a light reflecting film disposed on a surface of said fixed substrate which confronts said transparent substrate;
a phosphor layer disposed on a surface of said light reflecting film which confronts said transparent substrate; and
a spreading electrode disposed on a portion of said transparent substrate which is free of said electron emitters,
wherein said electron emitters emit electron flows intermittently,
pulsed electron flows emitted from said electron emitters are spread by an electric field generated by a voltage signal which is applied to said spreading electrode to reduce a surface density of the pulsed electron flow applied to said phosphor layer to a peak value of at most 50 μA/cm², and
the pulsed electron flows emitted from said electron emitters irradiate the same area of said phosphor layer and are emitted at different times from said electron emitters.

17. A light source according to claim 16, wherein a light spreading plate is disposed on a surface of said transparent substrate opposite to said fixed substrate.

18. A light source comprising:
a transparent substrate;
a fixed substrate disposed in facing relation to said transparent substrate;
at least one electron emitter disposed on said fixed substrate;
a phosphor layer disposed on a surface of said transparent substrate which confronts said fixed substrate;
a metal back layer disposed on a surface of said phosphor layer which confronts said fixed substrate; and
a spreading electrode disposed on a portion of said fixed substrate which is free of said electron emitter,
wherein said electron emitter emits an electron flow intermittently,
electron flow pulses emitted from said electron emitter are spread by an electric field generated by a voltage signal which is applied to said spreading electrode, and
each of the electron flow pulses which are applied to said metal back layer has an amount of electrons of at most 1 nC/cm².

19. A light source according to claim 18, wherein a light spreading plate is disposed on a surface of said transparent substrate opposite to said fixed substrate.

20. A light source comprising:
a transparent substrate;
a fixed substrate disposed in facing relation to said transparent substrate;
at least one electron emitter disposed on said transparent substrate;
a light reflecting film disposed on a surface of said fixed substrate which confronts said transparent substrate;
a phosphor layer disposed on a surface of said light reflecting film which confronts said transparent substrate; and
a spreading electrode disposed on a portion of said transparent substrate which is free of said electron emitter,
wherein said electron emitter emits an electron flow intermittently,
electron flow pulses emitted from said electron emitter are spread by an electric field generated by a voltage signal which is applied to said spreading electrode, and
each of the electron flow pulses which are applied to said phosphor layer has an amount of electrons of at most 1 nC/cm².

21. A light source according to claim 20, wherein a light spreading plate is disposed on a surface of said transparent substrate opposite to said fixed substrate.

22. A light source comprising:
a transparent substrate;
a fixed substrate disposed in facing relation to said transparent substrate;
at least two electron emitters disposed on said fixed substrate;
a phosphor layer disposed on a surface of said transparent substrate which confronts said fixed substrate;
a metal back layer disposed on a surface of said phosphor layer which confronts said fixed substrate; and
a spreading electrode disposed on a portion of said fixed substrate which is free of said electron emitters,
wherein said electron emitter emits an electron flow intermittently,
electron flow pulses emitted from said electron emitter are spread by an electric field generated by a voltage signal which is applied to said spreading electrode,
each of the electron flow pulses which are applied to said metal back layer has an amount of electrons of at most 1 nC/cm², and
the electron flow pulses emitted from said electron emitters irradiate the same area of said metal back layer and are emitted at different times from said electron emitters.

23. A light source according to claim 22, wherein a light spreading plate is disposed on a surface of said transparent substrate opposite to said fixed substrate.

24. A light source comprising:
a transparent substrate;
a fixed substrate disposed in facing relation to said transparent substrate;
at least two electron emitters disposed on said transparent substrate;
a light reflecting film disposed on a surface of said fixed substrate which confronts said transparent substrate;
a phosphor layer disposed on a surface of said light reflecting film which confronts said transparent substrate; and
a spreading electrode disposed on a portion of said transparent substrate which is free of said electron emitters,
wherein said electron emitter emits an electron flow intermittently,
electron flow pulses emitted from said electron emitter are spread by an electric field generated by a voltage signal which is applied to said spreading electrode,
each of the electron flow pulses which are applied to said phosphor layer has an amount of electrons of at most 1 nC/cm², and
the electron flow pulses emitted from said electron emitters irradiate the same area of said phosphor layer and are emitted at different times from said electron emitters.

25. A light source according to claim 24, wherein said voltage signal applied to said spreading electrode has a voltage level of 0 V.

26. A light source according to claim 24, wherein said voltage signal applied to said spreading electrode has a voltage level of 100 V or less.

27. A light source according to claim 24, wherein said spreading electrode comprises a mesh electrode having a large number of openings, and
said electron flow emitted from said electron emitter passes through the openings of said mesh electrode and is spread by an electric field generated by a voltage signal which is applied to said mesh electrode.

28. A light source according to claim 27, wherein said mesh electrode is rectangular in shape and is disposed above said electron emitter.

29. A light source according to claim 27, wherein said spreading electrode comprises said rectangular mesh electrode which is rounded into a half-cylindrical shape, and is disposed to cover said electron emitter.

30. A light source according to claim 24, wherein a light spreading plate is disposed on a surface of said transparent substrate opposite to said fixed substrate.

31. A light source comprising:
a transparent substrate;
a fixed substrate disposed in facing relation to said transparent substrate;
at least one electron emitter disposed on said fixed substrate;
a phosphor layer disposed on a surface of said transparent substrate which confronts said fixed substrate; and
a trajectory deflector for deflecting the trajectory of a pulsed electron flow intermittently emitted from said electron emitter,
wherein the pulsed electron flow is deflected by said trajectory deflector to two-dimensionally scan a position of said phosphor layer which is irradiated with the pulsed electron flow for thereby spreading the pulsed electron flow.

32. A light source according to claim 31, wherein a light spreading plate is disposed on a surface of said transparent substrate opposite to said fixed substrate.

33. A light source according to claim 31, wherein said trajectory deflector comprises a plurality of spreading electrodes disposed around said electron emitter, and wherein the trajectory of the pulsed electron flow emitted from said electron emitter is deflected with an electric field generated by voltage signals which are applied respectively to said spreading electrodes.

34. A light source according to claim 33, wherein said voltage signal applied to said spreading electrode has a voltage level of 0 V.

35. A light source according to claim 33, wherein said voltage signal applied to said spreading electrode has a voltage level of 100 V or less.

36. A light source according to claim 33, wherein said spreading electrode comprises a mesh electrode having a large number of openings, and
said electron flow emitted from said electron emitter passes through the openings of said mesh electrode and is spread by an electric field generated by a voltage signal which is applied to said mesh electrode.

37. A light source according to claim 36, wherein said mesh electrode is rectangular in shape and is disposed above said electron emitter.

38. A light source according to claim 36, wherein said spreading electrode comprises said rectangular mesh electrode which is rounded into a half-cylindrical shape, and is disposed to cover said electron emitter.

39. A light source according to claim 31, wherein said trajectory deflector comprises a magnetic field generator, and wherein the trajectory of the pulsed electron flow emitted from said electron emitter is deflected with a magnetic field generated by said magnetic field generator.

40. A light source according to claim 31, wherein said trajectory deflector comprises a plurality of spreading electrodes disposed around said electron emitter and said magnetic field generator, and wherein the trajectory of the pulsed electron flow emitted from said electron emitter is deflected with an electric field generated by voltage signals which are applied respectively to said spreading electrodes and a magnetic field generated by said magnetic field generator.

41. A light source according to claim 40, wherein said voltage signal applied to said spreading electrode has a voltage level of 0 V.

42. A light source according to claim 40, wherein said voltage signal applied to said spreading electrode has a voltage level of 100 V or less.

43. A light source according to claim 40, wherein said spreading electrode comprises a mesh electrode having a large number of openings, and
said electron flow emitted from said electron emitter passes through the openings of said mesh electrode and is spread by an electric field generated by a voltage signal which is applied to said mesh electrode.

44. A light source according to claim 43, wherein said mesh electrode is rectangular in shape and is disposed above said electron emitter.

45. A light source according to claim 43, wherein said spreading electrode comprises said rectangular mesh electrode which is rounded into a half-cylindrical shape, and is disposed to cover said electron emitter.

46. A light source according to claim 31, wherein the pulsed electron flow emitted from said electron emitter has a level which changes with time in a single electron emission period, and
said trajectory deflector controls a deflecting speed of the pulsed electron flow depending on the level of the pulsed electron flow to make constant an amount of electrons applied to said phosphor layer by the deflected pulsed electron flow when said trajectory deflector deflects the pulsed electron flow emitted from said electron emitter in a single electron emission period.

47. A light source according to claim 31, wherein said trajectory deflector has an electrode film disposed on a substrate on which said electron emitter is mounted, for applying an electric field, and/or a coil pattern disposed on the substrate on which said electron emitter is mounted, for generating a magnetic field.

48. A light source according to claim 31, wherein said trajectory deflector has an electrode film disposed on said fixed substrate for applying an electric field and/or a coil pattern disposed on said fixed substrate for generating a magnetic field.

49. A light source according to claim 31, wherein said trajectory deflector has an electrode film disposed on said fixed substrate for applying an electric field and/or a coil pattern disposed on said fixed substrate for generating a magnetic field, said electron emitter being mounted on said fixed substrate using said electrode film and/or said coil pattern as an alignment mark.

50. A light source comprising:
a transparent substrate;
a fixed substrate disposed in facing relation to said transparent substrate;
a plurality of electron emitters disposed on said fixed substrate in the longitudinal direction along a plurality of columns;
a phosphor layer disposed on a surface of said transparent substrate which confronts said fixed substrate; and
a plurality of spreading electrodes disposed above said fixed substrate in the longitudinal direction along columns adjacent to the columns where said electron emitters are disposed on said fixed substrate,
wherein electron flows emitted from said electron emitters are spread in the transverse direction by an electric field generated by a voltage signal which is applied to said spreading electrodes.

51. A light source according to claim 50, wherein said voltage signal applied to said spreading electrode has a voltage level of 0 V.

52. A light source according to claim 50, wherein said voltage signal applied to said spreading electrode has a voltage level of 100 V or less.

53. A light source according to claim 50, wherein said spreading electrode comprises a mesh electrode having a large number of openings, and
said electron flow emitted from said electron emitter passes through the openings of said mesh electrode and is spread by an electric field generated by a voltage signal which is applied to said mesh electrode.

54. A light source according to claim 53, wherein said mesh electrode is rectangular in shape and is disposed above said electron emitter.

55. A light source according to claim 53, wherein said spreading electrode comprises said rectangular mesh electrode which is rounded into a half-cylindrical shape, and is disposed to cover said electron emitter.

56. A light source according to claim 50, wherein a light spreading plate is disposed on a surface of said transparent substrate opposite to said fixed substrate.

57. A light source comprising:
a transparent substrate;
a fixed substrate disposed in facing relation to said transparent substrate;
at least one electron emitter disposed on said fixed substrate;
a phosphor layer; and
a spreading electrode,
said transparent substrate having said phosphor layer and said spreading electrode,
wherein said transparent substrate comprises an upper plate facing said fixed substrate and at least two side plates interposed between said upper plate and said fixed substrate and is fixedly disposed to cover said electron emitter on said fixed substrate,
said transparent substrate has a laminated assembly of said phosphor layer and said spreading electrode formed on internal surfaces of said upper plate and at least two of said side plates, and
an electron flow emitted from said electron emitter is spread by an electric field generated by a voltage signal applied to said spreading electrode.

58. A light source according to claim 57, wherein said transparent substrate has said phosphor layer formed on internal surfaces of said upper plate and at least two of said side plates, and
said spreading electrode functioning as a metal back layer is formed on said phosphor layer.

59. A light source according to claim 57, wherein said spreading electrode comprises a transparent electrode,
said transparent substrate has said spreading electrode formed on internal surfaces of said upper plate and at least two of said side plates, and
said phosphor layer is formed on said spreading electrode.

60. A light source according to claim 57, wherein a light spreading plate is disposed on a surface of said transparent substrate opposite to said fixed substrate.

61. A light source comprising:
a large fixed substrate;
at least one light emitting tube disposed on said large fixed substrate; and
a light reflecting film formed on a portion of said large fixed substrate which is free of said light emitting tube,
said light emitting tube comprising:
a housing having a transparent substrate and a fixed substrate disposed in facing relation to said transparent substrate;
at least one electron emitter disposed on said fixed substrate in said housing;
a phosphor layer; and
a spreading electrode,
said transparent substrate having said phosphor layer and said spreading electrode,
wherein said transparent substrate comprises an upper plate facing said fixed substrate, and at least two side plates interposed between said upper plate and said fixed substrate,
said transparent substrate is fixedly disposed to cover said electron emitter on said fixed substrate,
said transparent substrate has a laminated assembly of said phosphor layer and said spreading electrode on internal surfaces of said upper plate and at least said two side plates, and
an electron flow emitted from said electron emitter is spread by an electric field generated by a voltage signal applied to said spreading electrode.

62. A light source according to claim 61, wherein said light reflecting film is formed on lower portions of said two side plates of an outer surface of said housing.

63. A light source according to claims 61, wherein said transparent substrate has said phosphor layer formed on internal surfaces of said upper plate and at least two of said side plates, and
said spreading electrode functioning as a metal back layer is formed on said phosphor layer.

64. A light source according to claim 61, wherein said spreading electrode comprises a transparent electrode,
said transparent substrate has said spreading electrode formed on internal surfaces of said upper plate and at least two of said side plates, and
said phosphor layer is formed on said spreading electrode.

65. A light source according to claim 61, wherein a light spreading plate is disposed on a surface of said transparent substrate opposite to said fixed substrate.
